(19) United States
(12) Patent Application Publication
(10) Pub. No.: US 2026/0039427 A1
(43) Pub. Date: Feb. 5, 2026

(54) COMMUNICATION METHOD AND DEVICE

(71) Applicant: GUANGDONG OPPO MOBILE TELECOMMUNICATIONS CORP., LTD., Dongguan (CN)

(72) Inventors: Yapu LI, Dongguan (CN); Lei HUANG, Singapore (SG)

(21) Appl. No.: 18/828,928

(22) Filed: Sep. 9, 2024

Related U.S. Application Data
(63) Continuation of application No. PCT/CN2022/080389, filed on Mar. 11, 2022.

(51) Int. Cl. H04L 5/00

(52) U.S. Cl. CPC H04L 5/0046; H04L 5/0048

(57) ABSTRACT

The communication method includes performing distributed tone mapping on a first resource unit (RU). In the communication method, a frequency diversity gain is improved by performing distributed tone mapping on an RU.

### CROSS-REFERENCE TO RELATED APPLICATION

This application is a continuation application of International Application No. PCT/CN2022/080389, filed on Mar. 11, 2022, the entire disclosure of which is hereby incorporated herein by reference.

### TECHNICAL FIELD

The present disclosure relates to the field of communications, and in particular, to a communication method and device.

### BACKGROUND

The communication standards include a plurality of types of resource units (RUs), and further include a multiple resource unit (MRU) composed of a plurality of RUs. If one RU or MRU is allocated to one station (STA) by using an RU/MRU allocation mode, each STA obtains a limited bandwidth.

### SUMMARY

Embodiments of the present disclosure provide a communication method and a communication device.

Some embodiments of the present disclosure provide a communication method, the method includes performing distributed tone mapping on a first RU.

Some embodiments of the present disclosure provide a communication device, the device includes a processor and a memory configured to store a computer program. The processor, when invoking and running the computer program stored in the memory, is caused to enable the communication device to perform the foregoing communication method.

The embodiments of the present disclosure provide a chip, configured to implement the foregoing communication method. Specifically, the chip includes a processor, configured to invoke and run a computer program in a memory, to enable a device in which the chip is installed to perform the foregoing communication method.

### BRIEF DESCRIPTION OF DRAWINGS

FIG. 1 is a schematic diagram of an application scenario according to some embodiments of the present disclosure;

FIG. 2 is a schematic flowchart of a communication method 200 according to some embodiments of the present disclosure;

FIG. 3 is a schematic diagram of a structure of a communication device 300 according to some embodiments of the present disclosure;

FIG. 4A is a schematic diagram of a format of an EHT MU PPDU according to some embodiments of the present disclosure;

FIG. 4B is a schematic diagram of a format of an EHT TB PPDU according to some embodiments of the present disclosure;

FIG. 5 is a flowchart of transmitting BCC-encoded data field according to some embodiments of the present disclosure;

FIG. 6A is a schematic diagram of a logical 52+26-tone MRU during the 20-MHz OFDMA PPDU transmission according to some embodiments of the present disclosure;

FIG. 6B is a schematic diagram of a logical 106+26-tone MRU during the 20-MHz OFDMA PPDU transmission according to some embodiments of the present disclosure;

FIG. 6C is a schematic diagram of a logical 52+26-tone MRU during the 40-MHz OFDMA PPDU transmission according to some embodiments of the present disclosure;

FIG. 6D is a schematic diagram of a logical 106+26-tone MRU during the 40-MHz OFDMA PPDU transmission according to some embodiments of the present disclosure;

FIG. 7 is a structural schematic diagram of a communication device according to some embodiments of the present disclosure;

FIG. 8 is a structural schematic diagram of a chip according to some embodiments of the present disclosure; and

FIG. 9 is a schematic block diagram of a communication system according to some embodiments of the present disclosure.

### DETAILED DESCRIPTION

The following describes the technical solutions in the embodiments of the present disclosure with reference to the accompanying drawings in the embodiments of the present disclosure.

The technical solutions in the embodiments of the present disclosure are applicable to various communication systems, such as a wireless local area network (WLAN), a wireless fidelity (WiFi) system, or other communication systems.

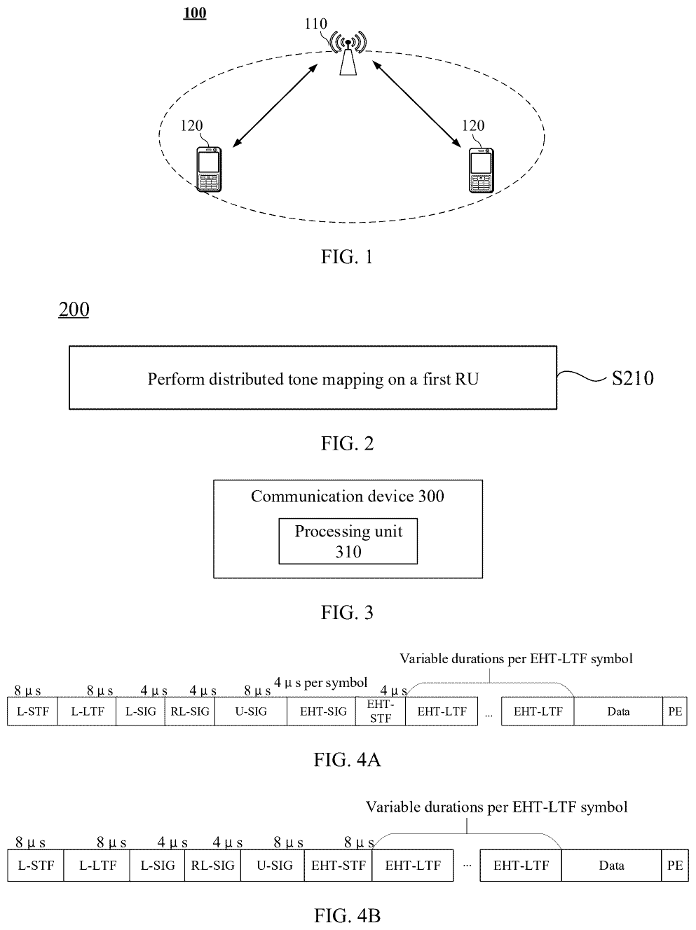

For example, a communication system 100 to which the embodiments of the present disclosure are applicable is shown in FIG. 1. The communication system 100 includes an access point (AP) 110, and a station (STA) 120 that accesses a network by using the access point 110.

In some scenarios, the AP is also referred to as an AP STA. In other words, the AP is also a type of STA in a sense.

In some scenarios, the STA is also referred to as a non-AP STA (non-AP STA).

Communication in the communication system 100 is communication between the AP and the non-AP STA, communication between non-AP STAs, or communication between the STA and a peer STA. The peer STA is a peer-end device communicating with the STA. For example, the peer STA is an AP or a non-AP STA.

The AP is equivalent to a bridge that connects a wired network and a wireless network, and the main function is to connect wireless network clients together and then connect the wireless network to the Ethernet. An AP device is a terminal device (such as a mobile phone) or a network device (such as a router). The terminal device or the network device is provided with a chip that implements the communication function, such as a WLAN or WiFi chip.

It should be understood that the role of the STA in the communication system is not fixed. For example, in some scenarios, when a mobile phone is connected to a router, the mobile phone is a non-AP STA; and when a mobile phone serves as a hotspot for another mobile phone, the mobile phone acts as an AP.

The AP and the non-AP STA are devices in the internet of vehicles, internet of things (IoT) nodes and sensors in the IoT, smart cameras, smart remote controls, and smart water and electricity meters in smart home, sensors in smart city, or the like.

In some embodiments, the non-AP STA supports the 802.11be standard. The non-AP STA also supports a plurality of current and future wireless local area network (WLAN) standards of an 802.11 family, such as 802.11ax, 802.11ac, 802.11n, 802.11 g, 802.11b, and 802.11a.

In some embodiments, the AP is a device supporting the 802.11be standard. The AP is also a device supporting a plurality of current and future WLAN standards of the 802.11 family, such as 802.11ax, 802.11ac, 802.11n, 802.11 g, 802.11b, and 802.11a.

In the embodiments of the present disclosure, the STA is a mobile phone, a pad, a computer, a virtual reality (VR) device, an augmented reality (AR) device, a wireless device in industrial control (industrial control), a set-top box, a wireless device in self-driving, an in-vehicle communication device, a wireless device in remote medical, a wireless device in a smart grid, a wireless device in transportation safety, a wireless device in a smart city or a wireless device in a smart home, a wireless communication chip/ASIC/SOC, or the like that supports the WLAN/WiFi technology.

Frequency bands that can be supported by the WLAN technology include but are not limited to a low-frequency band (for example, 2.4 GHZ, 5 GHZ, and 6 GHZ) and a high-frequency band (for example, 60 GHZ).

FIG. 1 shows one AP STA and two non-AP STAs as an example. Optionally, the communication system 100 includes a plurality of AP STAs and another quantity of non-AP STAs. This is not limited in the embodiments of the present disclosure.

It should be understood that the terms “system” and “network” in the present specification can be exchanged. The term “and/or” in the present specification merely describes an association relationship between associated objects, and indicates that three types of relationships may exist. For example, A and/or B indicates that A exists alone, A and B coexist, or B exists alone. In addition, the character “/” in the present specification generally indicates that the associated objects are in an “or” relationship.

It should be understood that the term “indication” mentioned in the embodiments of the present disclosure is a direct indication, an indirect indication, or an association relationship. In some embodiments, that A indicates B means that A directly indicates B, for example, B is obtained through A. In some embodiments, that A indicates B means that A indirectly indicates B, A indicates C, and B can be obtained through C. In some embodiments, that A indicates B may mean that there is an association relationship between A and B.

In the description of the embodiments of the present disclosure, the term “corresponding” indicates a direct or indirect correspondence between two items, an association relationship between two items, or a relationship such as “indicating and be indicated” or “configure and be configured”.

For case of understanding of the technical solutions of the embodiments of the present disclosure, related technologies of the embodiments of the present disclosure are described below. The following related technologies, as an optional solution, can be combined with the technical solutions of the embodiments of the present disclosure at random, both of which fall within the protection scope of the embodiments of the present disclosure.

Allocation and use of RU/MRU in IEEE 802.11be.

The IEEE 802.11be includes eight types of RUs, and includes an MRU including a plurality of RUs. One RU or MRU is allocated to one STA. Details are as follows.

### (1) RU

RUs used for uplink and downlink orthogonal frequency division multiple access (OFDMA) transmission in an extremely high throughput (EHT) physical layer protocol data unit (PPDU) includes a 26-tone RU, a 52-tone RU, a 106-tone RU, a 242-tone RU, a 484-tone RU, a 996-tone RU, and a 2×996-tone RU.

The RUs are classified into large-sized RUs and small-sized RUs. An example is as follows.

Large-sized RU refers to an RU with a size greater than or equal to 242-tone, including a 242-tone RU, a 484-tone RU, a 996-tone RU, and a 2×996-tone RU.

Small-sized RU refers to an RU with a size less than 242-tone, including a 26-tone RU, a 52-tone RU, and a 106-tone RU.

The small-sized RU is used in a 20-MHz, 40-MHz, 80-MHz, 160-MHz, or 320-MHz OFDMA EHT PPDU. For example, the 242-tone RU is used in a 40-MHz, 80-MHz, 160-MHz, or 320-MHz OFDMA EHT PPDU, the 484-tone RU is used in an 80-MHz, 160-MHz, or 320-MHz OFDMA EHT PPDU, the 996-tone RU is used in a 160-MHz or 320-MHz OFDMA EHT PPDU, and the 2×996-tone RU is used in a 320-MHz OFDMA EHT PPDU.

### (2) MRU

The small-sized RU can only be combined with the small-sized RU to form a small-sized MRU. The large-sized RU can only be combined with the large-sized RU to form a large-sized MRU.

### (a) Small-Sized MRU

The small-sized MRU in the EHT PPDU that is used for uplink and downlink OFDMA transmission includes a 52+26-tone MRU (which represents an MRU composed of a 52-tone RU and a 26-tone RU, and the following similar representations have similar meanings) and a 106+26-tone MRU. A 52-tone RU and a 26-tone RU in any 52+26-tone MRU need to come from the same 20-MHz subchannel. A 106-tone RU and a 26-tone RU in any 106+26-tone MRU need to come from the same 20-MHz subchannel.

### (b) Large-Sized MRU

The large-sized MRU in the EHT PPDU that is used for uplink and downlink OFDMA transmission includes a 484+242-tone MRU, a 996+484-tone MRU, a 2×996+484-tone MRU, a 3×996-tone MRU, and a 3×996+484-tone MRU.

The 484+242-tone MRU is allowed to be used in an 80-MHz, 160-MHz, and 320-MHz OFDMA EHT PPDU, and a 484-tone RU and a 242-tone RU in any 484+242-tone MRU need to come from the same 80-MHz subchannel.

A 996+484-tone MRU is allowed to be used in a 160-MHz OFDMA EHT PPDU and a 320-MHz OFDMA EHT PPDU, and a 996-tone RU and a 484-tone RU in any 996+484-tone MRU need to come from the same 160-MHz subchannel.

The 2×996+484-tone MRU, the 3×996-tone MRU, and the 3×996+484-tone MRU are allowed to be used in a 320-MHz OFDMA EHT PPDU. In addition, a 996-tone RU and a 484-tone RU in any 2×996+484-tone MRU need to come from three contiguous 80-MHz subchannels.

In an RU/MRU allocation mode, each STA can only obtain a limited bandwidth. For example, during the transmission of the 40-MHz OFDMA PPDU, an RU 26 (that is, a 26-tone RU, including 26 tones) is allocated to one STA. The STA can only enjoy the frequency diversity gain of the bandwidth (2 MHz) occupied by the RU 26, and cannot enjoy benefits brought by the entire 40-MHz OFDMA PPDU bandwidth.

In the embodiments of the present disclosure, distributed tone mapping may be performed on physical tone indexes within different PPDU bandwidths. Further, in a distributed tone mapping process, a mapping location of a special tone, such as a DC tone, is considered. In addition, in the embodiments of the present disclosure, how to perform distributed tone mapping in the case of a punctured channel is further considered.

FIG. 2 is a schematic flowchart of a communication method 200 according to some embodiments of the present disclosure. The method is applicable to the system shown in FIG. 1, but is not limited thereto. The method includes at least part of the following content.

In S210, distributed tone mapping is performed on a first RU.

In the embodiments of the present disclosure, a communication device, such as an AP and a STA, performs distributed tone mapping on a physical tone index of the first RU. For example, the communication device performs distributed tone mapping on physical tone indexes of first RUs within bandwidths of different PPDUs, such as OFDMA PPDUs. The OFDMA PPDU includes a plurality of first RUs. The first RU participates in the distributed tone mapping. The first RU is referred to as a reference RU. The communication device performs distributed tone mapping on each reference RU of the OFDMA PPDU.

In the embodiments of the present disclosure, the first RU includes a physical RU and/or a physical MRU. Further, in multi-shot mapping, the first RU is a logical RU and/or a logical MRU that are obtained through previous-shot mapping.

In some embodiments, the method further includes:
constructing a second RU by using tone indexes obtained by the distributed tone mapping.

In the embodiments of the present disclosure, the tone index of the first RU is a physical tone index, and the tone index obtained by the distributed tone mapping is a logical tone index. For example, distributed mapping is performed on non-contiguous physical tone indexes to obtain contiguous logical tone indexes. The communication device constructs the second RU by using a correspondence between the physical tone index of the first RU and the logical tone index obtained by the mapping. In the embodiments of the present disclosure, the second RU includes a logical RU and/or a logical MRU.

In some embodiments, the distributed tone mapping includes a four-step mapping approach.

In some embodiments, the performing the distributed tone mapping on the first RU includes at least one of the following:
mapping first tone indexes of the first RU to second tone indexes in a first pattern;
mapping the second tone indexes to third tone indexes in a second pattern;
mapping the third tone indexes to fourth tone indexes in a third pattern; and
mapping the fourth tone indexes to fifth tone indexes in a fourth pattern.

In some embodiments, the mapping the first tone indexes of the first RU to the second tone indexes in the first pattern includes: mapping the first tone indexes that are non-contiguous to the second tone indexes that are contiguous in the first pattern based on a bandwidth and/or punctured channel information of an orthogonal frequency division multiple access (OFDMA) protocol data unit (PPDU).

In the embodiments of the present disclosure, non-contiguous first tone indexes are mapped to contiguous second tone indexes in the first pattern, for case of subsequent calculation. For example, non-contiguous index values contained in the first tone indexes are marked as contiguous values such as 1, 2, 3, . . . , to obtain the second tone indexes. In this example, an initial value of the second tone index does not start from 1, and may be set based on a requirement of a specific application scenario. In addition, a formula or a formula group used in the first pattern is set based on an expected sequence of second tone indexes. In a mapping process, a corresponding formula is searched for based on the first tone index, to obtain the second tone index through calculation. For example, an index A1 in the first tone indexes is in a value range A, and an index A2 corresponding to the index A1 is obtained through the calculation based on a formula corresponding to the value range A; and an index B1 in the first tone indexes is in a value range B, and an index B2 corresponding to the index B1 is obtained through the calculation based on a formula corresponding to the value range B. After indexes corresponding to all tone indexes in the first RU such as the reference RU are separately calculated based on formulas, the calculated indexes constitute the second tone indexes. Index values contained in the second tone indexes are contiguous. Contiguous index values facilitate subsequent other mapping.

In some embodiment, the punctured channel information includes information indicating whether a punctured channel and/or a puncturing mode is present.

In the embodiments of the present disclosure, if the punctured channel is not present in the OFDMA PPDU, the first tone index of each reference RU in the OFDMA PPDU participates in the distributed tone mapping.

In the embodiments of the present disclosure, if the punctured channel is present in the OFDMA PPDU, the first tone index in the punctured channel does not participate in the distributed tone mapping. The communication device determines, based on the puncturing mode of the punctured channel, first tone indexes in the OFDMA PPDU that do not participate in the distributed tone mapping.

In some embodiments, in the case that the punctured channel is present in the OFDMA PPDU, the first tone indexes in the punctured channel do not participate in the distributed tone mapping. For example, when the OFDMA PPDU bandwidth is 80 MHz and there is a punctured channel, a puncturing mode is “1011”, that is, a second 20-MHz subchannel is punctured, and the physical tone index corresponding to the subchannel is [−253:−12]. An RU 996 actually includes only 754 tones, and consists of tones of 27 groups of RUs 26 and 52 tones that are not contained in any RU 26. The tones of the 27 groups of RUs 26 participate in the distributed tone mapping, and the 52 tones that are not contained in any RU 26 do not participate in the distributed tone mapping.

In some embodiments, first tone indexes that do not participate in the distributed tone mapping are equal to respective fifth tone indexes. For example, indexes of the 52 tones that are not contained in any RU 26 are equal to respective logical tone indexes.

In some embodiments, the method further includes:
in the case that the punctured channel is present in the OFDMA PPDU, removing the first tone indexes in the punctured channel in the OFDMA PPDU based on the puncturing mode.

In the embodiments of the present disclosure, the first tone indexes corresponding to the punctured channel do not participate in the distributed tone mapping. Based on the puncturing mode, the communication device first removes the first tone index from the punctured channel in the first RU, such as the OFDMA PPDU, and then maps the remaining first tone indexes in the first RU to second tone indexes in the first pattern.

In some embodiments, the third pattern is an inverse process of the first pattern. For example, a formula or a formula group used in the second pattern may be obtained through reckoning based on a formula used in the first pattern. In addition, formulas or formula groups used in the first formula and the second formula are saved. In the mapping process, a corresponding formula or formula group is searched for in each step for calculation.

In some embodiments, the first pattern includes: adding a first specified value to the first tone index in the case that the first tone indexes fall into a first range; and
the third pattern includes: subtracting the first specified value from the third tone indexes in the case that the third tone indexes fall into the first range.

In the embodiments of the present disclosure, for a specific first RU, the first specified value is first added to the first tone indexes of the first RU to obtain the second tone indexes, and then the second tone indexes are mapped to the third tone indexes in the second pattern. Then, the first specified value is subtracted from the third tone index in the third pattern to obtain the fourth tone index.

In some embodiments, the first pattern includes: subtracting a second specified value from the first tone indexes in the case that the first tone indexes fall into a second range; and
the third pattern includes: adding the second specified value to the third tone indexes in the case that the third tone indexes fall into the second range.

In the embodiments of the present disclosure, for a specific first RU, the second specified value is first subtracted from the first tone indexes of the first RU to obtain the second tone indexes, and then the second tone indexes are mapped to the third tone indexes in the second pattern. Then, the second specified value is added to the third tone indexes in the third pattern to obtain the fourth tone indexes.

In some embodiments, the second pattern includes a uniform mapping pattern.

In the embodiments of the present disclosure, the second tone indexes are uniformly mapped to obtain the third tone indexes. In the third tone indexes, intervals between every two adjacent indexes are equal. For example, differences between every two adjacent indexes constitute an arithmetic progression. For example, a plurality of contiguous second tone indexes are mapped every several tone indexes, and obtained third tone indexes are non-contiguous and follow an increasing or decreasing pattern. Specifically, for example, second tone indexes 1 to 5 are mapped every two tone indexes to obtain third tone indexes 1, 3, 5, 7, and 9.

In some embodiments, the uniform mapping pattern includes: performing mapping at intervals of tone indexes whose quantity is a mapping distance. In the embodiments of the present disclosure, the mapping distance is preset, and the second tone indexes are uniformly mapped to third tone indexes at intervals of tone indexes whose quantity is the mapping distance. The mapping distance in the foregoing example is 2.

In some embodiments, the mapping distance is related to the tone mapping bandwidth.

In some embodiments, the mapping distance is determined based on the total quantity of tones within the tone mapping bandwidth that constitute the first RU and the size of the first RU. In some embodiments, the mapping distance is equal to the total quantity of tones within the tone mapping bandwidth that constitute the first RU divided by the size of the first RU. For example, if the tone mapping bandwidth is 20 MHz, and a total quantity N of tones in the 20 MHz bandwidth that constitute the reference RU is 234, the size of the first RU is 26, and the mapping distance Dₜₘ is 9. For another example, if the tone mapping bandwidth is 80 MHz, and two 20-MHz subchannels are punctured within the 80-MHz bandwidth, the total quantity N of tones within the tone mapping bandwidth that constitute the reference RU after the punctured channel is removed is 468, the size of the first RU is 26, and the mapping distance Dₜₘ is 18. In addition, the mapping distance is alternatively calculated by using another formula, and this is not limited in the embodiments of the present disclosure.

In some embodiments, the third tone index is determined based on the second tone index, the size of the first RU, the mapping distance, an index interval determination factor, and the total quantity of tones within the tone mapping bandwidth that constitute the first RU.

In some embodiments, the second tone index, the size of the first RU such as the reference RU, the mapping distance, the index interval determination factor, and the total quantity of tones within the tone mapping bandwidth that constitute the reference RU may be substituted into a specified formula to obtain the third tone index through calculation. For example, an example of a formula is as follows:

$${k}_{3} = mod ( {D}_{tm} \times ( {k}_{2} - 1 ) + a , N ) , {k}_{2} ∈ [ {N}_{b a s e} ( a - 1 ) + 1 , {N}_{b a s e} * a ]$$

wherein k₃ is the third tone index; k₂ is the second tone index; the index interval determination factor a is determined based on a value of k₂, and a is a positive integer; N_{base} is a size of the reference RU; N is the total quantity of tones within the tone mapping bandwidth that constitute the reference RU; and Dₜₘ is the mapping distance, and a value of the mapping distance is related to the tone mapping bandwidth.

In some embodiments, the second pattern includes a non-uniform mapping pattern. In the embodiments of the present disclosure, the second tone indexes are mapped to the third tone indexes in the non-uniform mapping pattern. In the third tone indexes, intervals between every two adjacent indexes are not necessarily equal. For example, differences between every two adjacent indexes are irregular.

In some embodiments, the non-uniform mapping pattern includes at least one of the following: table lookup mapping and random mapping. For example, the mapping table is preset to search the table for the third tone index corresponding to the second tone index. For another example, a random number is added to each second tone index to obtain the third tone index. The random mapping uses not only addition, but also other algorithms, such as subtraction, multiplication, and division. This is not limited in the embodiments of the present disclosure.

In some embodiments, the fourth pattern includes sequential mapping. In the embodiments of the present disclosure, after the third tone indexes are mapped to the fourth tone indexes in the third pattern, the fourth tone indexes are mapped to the fifth tone indexes based on a sequence. For example, the fifth tone indexes include contiguous logical tone indexes.

In some embodiments, the distributed tone mapping includes one-shot distributed tone mapping.

In some embodiments, the one-shot distributed tone mapping is configured to map a physical tone within a subchannel where a logical RU allocation mode is located to a logical tone within the OFDMA PPDU bandwidth.

In some embodiments, the first tone is a physical tone within the subchannel where the logical RU allocation mode is located, the second tone is a first intermediate tone, the third tone is a second intermediate tone, the fourth tone is a physical tone obtained by the distributed tone mapping and the fifth tone is the logical tone within the OFDMA PPDU bandwidth.

In the embodiments of the present disclosure, the one-shot distributed tone mapping may use a four-step mapping approach. For example, the physical tone within the subchannel where the logical RU allocation mode is located is mapped in the first pattern to obtain the first intermediate tone; the first intermediate tone is mapped in the second pattern to obtain the second intermediate tone; the second intermediate tone is mapped in the third pattern to obtain the physical tone obtained by the distributed tone mapping; and the physical tone obtained by the distributed tone mapping is mapped in the fourth pattern to obtain the logical tone within the OFDMA PPDU bandwidth.

In some embodiments, the distributed tone mapping includes a two-shot distributed tone mapping.

In some embodiments, the two-shot distributed tone mapping includes shot-1 distributed tone mapping and shot-2 distributed tone mapping; wherein
the shot-1 distributed tone mapping is configured to map a physical tone within a subchannel of each tone mapping bandwidth to an intermediate logical tone within a subchannel of each tone mapping bandwidth; and
the shot-2 distributed tone mapping is configured to map the intermediate logical tone to the logical tone within the OFDMA PPDU bandwidth.

In some embodiments, in the shot-1 distributed tone mapping, the first tone is a physical tone within a subchannel of the tone mapping bandwidth, the second tone is a first intermediate tone, the third tone is a second intermediate tone, the fourth tone is a physical tone obtained by the shot-1 distributed tone mapping, and the fifth tone is the intermediate logical tone.

In the embodiments of the present disclosure, the shot-1 distributed tone mapping uses a four-step mapping approach. For example, a physical tone within the tone mapping bandwidth is mapped in the first pattern to obtain the first intermediate tone, the first intermediate tone is mapped in the second pattern to obtain the second intermediate tone, the second intermediate tone is mapped in the third pattern to obtain the physical tone obtained by the shot-1 distributed tone mapping, and the physical tone obtained by the shot-1 distributed tone mapping is mapped in the fourth pattern to obtain the intermediate logical tone.

In some embodiments, in the shot-1 distributed tone mapping, the tone mapping bandwidth is one of the following: 20 MHz, 40 MHz, 60 MHz, or 80 MHz.

In some embodiments, the first RU includes an RU 26. For example, a reference RU used in the one-shot distributed tone mapping is the RU 26. For another example, in the two-shot distributed tone mapping, a reference RU used in the shot-1 distributed tone mapping is the RU 26.

In some embodiments, in the shot-2 distributed tone mapping, the first tone is an intermediate logical tone obtained based on the shot-1 distributed tone mapping, the second tone is a third intermediate tone, the third tone is a fourth intermediate tone, the fourth tone is a physical tone obtained by the shot-2 distributed tone mapping, and the fifth tone is the logical tone within the OFDMA PPDU bandwidth.

In the embodiments of the present disclosure, the shot-2 distributed tone mapping uses a four-step mapping approach. For example, the intermediate logical tone is mapped in the first pattern to obtain the third intermediate tone, the third intermediate tone is mapped in the second pattern to obtain the fourth intermediate tone, the fourth intermediate tone is mapped in the third pattern to obtain the physical tone obtained by the shot-2 distributed tone mapping, and the physical tone obtained by the shot-2 distributed tone mapping is mapped in the fourth pattern to obtain the logical tone within the OFDMA PPDU bandwidth.

In some embodiments, the first tone includes some or all physical tones that do not participate in the shot-1 distributed tone mapping. For example, first tones that participate in the distributed mapping in the shot-2 distributed tone mapping includes some or all physical tones that do not participate in the shot-1 distributed tone mapping.

In some embodiments, in the shot-2 distributed tone mapping, the tone mapping bandwidth is a sum of bandwidths occupied by the transmission of OFDMA PPDU preambles.

In some embodiments, the first RU includes an RU 242. For example, in the two-shot distributed tone mapping, a reference RU used in the shot-2 distributed tone mapping is the RU 242.

In some embodiments, the second RU includes a logical RU, and the constructing the second RU by using the tone indexes obtained by the distributed tone mapping includes:
constructing a logical RU within the tone mapping bandwidth by using a physical tone index of the first RU and a logical tone index obtained by the distributed tone mapping, and determining at least one of a type, an index, a logical tone index, and a physical tone index of the logical RU within the tone mapping bandwidth.

In the embodiments of the present disclosure, a correspondence between the first tone index and the fifth tone index is obtained through distributed tone mapping. A logical RU within the tone mapping bandwidth is constructed based on the correspondence. For example, a physical tone index of a specific logical RU is equal to a physical tone index of a specific reference RU, and a logical tone index of the logical RU is equal to a fifth tone index obtained by mapping the reference RU. In the embodiments of the present disclosure, index values contained in the fifth tone index are contiguous.

In some embodiments, the physical tone index of the logical RU is the first tone index used in the one-shot distributed tone mapping, and the logical tone index of the logical RU is the fifth tone index obtained by the one-shot distributed tone mapping. For example, in the one-shot distributed tone mapping, a physical tone index of a specific logical RU is equal to a physical tone index of a specific reference RU, and a logical tone index of the logical RU is equal to a fifth tone index obtained by after the one-shot distributed tone mapping.

In some embodiments, the physical tone index of the logical RU is the first tone index used in the shot-1 distributed tone mapping, and the logical tone index of the logical RU is the fifth tone index obtained by the shot-2 distributed tone mapping. For example, in the two-shot distributed tone mapping, a physical tone index of a specific logical RU is equal to a physical tone index of a specific reference RU, and a logical tone index of the logical RU is equal to a fifth tone index obtained by the two-shot distributed tone mapping.

In some embodiments, a relationship between a type of the logical RU and the tone mapping bandwidth includes at least one of the following:
the tone mapping bandwidth is 20 MHz, and the type of the logical RU includes at least one of a 26-tone RU (26-tone RU), a 52-tone RU (52-tone RU), or a 106-tone RU (106-tone RU);
the tone mapping bandwidth is 40 MHz, and the type of the logical RU includes at least one of a 26-tone RU, a 52-tone RU, a 106-tone RU, or a 242-tone RU (242-tone RU);
the tone mapping bandwidth is 80 MHz, and the type of the logical RU includes at least one of a 26-tone RU, a 52-tone RU, a 106-tone RU, a 242-tone RU, or a 484-tone RU (484-tone RU); or
the tone mapping bandwidth is 160 MHz, and the type of the logical RU comprises at least one of a 26-tone RU, a 52-tone RU, a 106-tone RU, a 242-tone RU, a 484-tone RU, a 996-tone RU (996-tone RU), or a 2×996-tone RU (2×996-tone RU).

In the embodiments of the present disclosure, the type of the logical RU is related to the tone mapping bandwidth. For a specific example, reference may be made to the foregoing description about the relationship between the type of the logical RU and the tone mapping bandwidth. Within the same bandwidth, different quantities of logical RUs can be constructed based on different types, and different types of logical RUs include different quantities of tones. For example, nine logical RUs of a 26-tone RU type, four logical RUs of a 52-tone RU type, or two logical RUs of a 106-tone RU type are constructed within 20-MHz bandwidth. For another example, 18 logical RUs of a 26-tone RU type, eight logical RUs of a 52-tone RU type, four logical RUs of a 106-tone type, or two logical RUs of a 242-tone RU type are constructed within 40-MHz bandwidth.

In the embodiments of the present disclosure, indexes of logical RUs are contiguously numbered. For example, within the 20-MHz bandwidth, numbers of the nine logical RUs of the 26-tone RU type that can be constructed are RU1 to RU9, or numbers of the four logical RUs of the 52-tone RU type are RU1 to RU49, or numbers of the two logical RUs of the 106-tone RU type are RU1 and RU2.

In some embodiments, the second RU includes a logical MRU, and the constructing the second RU by using the tone index obtained by the distributed tone mapping includes:
constructing the logical MRU based on a logical RU in the one-shot distributed tone mapping or a logical RU in the two-shot distributed tone mapping.

In the embodiments of the present disclosure, for construction of the logical MRU based on the tone mapping bandwidth, a type of the logical RU, or the like, reference may be made to a manner of constructing the physical MRU within the same bandwidth. For example, during 20-MHz OFDMA PPDU transmission, allowed logical 52+26-tone MRUs include: a logical 52+26-tone MRU 1 includes a logical 26-tone RU 2 and a logical 52-tone RU 2; a logical 52+26-tone MRU 2 includes a logical 26-tone RU 5 and a logical 52-tone RU 2; and a logical 52+26-tone MRU 3 includes a logical 26-tone RU 8 and a logical 52-tone RU 3. For another example, during 40-MHz OFDMA PPDU transmission, allowed logical 106+26-tone MRUs include: a logical 106+26-tone MRU 1 including a logical 26-tone RU 5 and a logical 106-tone RU 1.

In some embodiments, the method further includes: allocating the RU in at least one of the following manners:
allocating the logical RU and/or the logical MRU in a logical RU allocation mode, wherein the logical MRU is constructed by using the logical RU in a manner of constructing the physical MRU; and
allocating the logical RU in the logical RU allocation mode, and allocating the physical RU and the physical MRU in a physical RU allocation mode.

For example, before the RU is allocated, the distributed tone mapping are performed on a physical tone by using a four-step mapping approach, and then a logical RU and a logical MRU are constructed based on a mapping result. In the logical RU allocation mode, an AP may allocate, for a STA, a logical RU and a logical MRU that are constructed by the RU. For another example, in the logical RU allocation mode, the AP allocates the constructed logical RU to the STA, and in the physical RU allocation mode, the AP allocates a physical RU and a physical MRU to the STA. In this way, after the distributed tone mapping, a non-edge logical tone is not mapped to an edge physical tone of the bandwidth, so that a tone that constitutes the logical MRU is not located on an edge of the bandwidth either, and therefore no interference is caused to an adjacent punctured 20-MHz channel.

In some embodiments, the first RU includes a physical RU and/or an MRU.

In some embodiments, the method further includes:
performing channel estimation by using a four-fold extremely high throughput long training field (4×EHT LTF). For example, the EHT PPDU supports three types of EHT-LTFs: 1× EHT-LTF, 2×EHT-LTF, and 4×EHT-LTF. Channel estimation is performed by using the 4×EHT-LTF.

FIG. 3 is a schematic block diagram of a communication device 300 according to some embodiments of the present disclosure. The communication device 300 includes:
a processing unit 310, configured to perform distributed tone mapping on a first RU.

In some embodiments, the processing unit 310 is further configured to construct a second RU by using tone indexes obtained by the distributed tone mapping.

In some embodiments, the distributed tone mapping includes a four-step mapping approach.

In some embodiments, the processing unit 310 is further configured to perform at least one of the following:
mapping first tone indexes of the first RU to second tone indexes in a first pattern;
mapping the second tone indexes to third tone indexes in a second pattern;
mapping the third tone indexes to fourth tone indexes in a third pattern; and
mapping the fourth tone indexes to fifth tone indexes in a fourth pattern.

In some embodiments, that the processing unit 310 is further configured to: map the first tone indexes that are non-contiguous to the second tone indexes that are contiguous in the first pattern based on a bandwidth and/or punctured channel information of an orthogonal frequency division multiple access (OFDMA) protocol data unit (PPDU).

In some embodiments, the punctured channel information includes information indicating whether a punctured channel and/or a puncturing mode is present.

In some embodiments, the processing unit 310 is further configured to: in the case that the punctured channel is present in the OFDMA PPDU, remove the first tone indexes in the punctured channel in the OFDMA PPDU based on the puncturing mode.

In some embodiments, in the case that the punctured channel is present in the OFDMA PPDU, the first tone indexes in the punctured channel do not participate in the distributed tone mapping.

In some embodiments, the first tone indexes that do not participate in the distributed tone mapping are equal to respective fifth tone indexes.

In some embodiments, the third pattern is an inverse process of the first pattern.

In some embodiments, the first pattern includes: adding a first set value to the first tone indexes in the case that the first tone indexes fall into a first range; and
the third pattern includes: subtracting the first specified value from the third tone indexes in the case that the third tone indexes fall into the first range.

In some embodiments, the first pattern includes: subtracting a second specified value from the first tone indexes in the case that the first tone indexes fall into a second range; and
the third pattern includes: adding the second specified value to the third tone indexes in the case that the third tone indexes fall into the second range.

In some embodiments, the second pattern includes a uniform mapping pattern.

In some embodiments, the uniform mapping pattern includes: performing mapping at intervals of tone indexes whose quantity is a mapping distance.

In some embodiments, the mapping distance is related to the tone mapping bandwidth.

In some embodiments, the mapping distance is determined based on a total quantity of tones within the tone mapping bandwidth that constitute the first RU and a size of the first RU.

In some embodiments, the third tone index is determined based on the second tone index, the size of the first RU, the mapping distance, an index interval determination factor, and the total quantity of tones within the tone mapping bandwidth that constitute the first RU.

In some embodiments, the second pattern includes a non-uniform mapping pattern.

In some embodiments, the non-uniform mapping pattern includes at least one of the following: table lookup mapping or random mapping.

In some embodiments, the fourth pattern includes sequential mapping.

In some embodiments, the distributed tone mapping includes one-shot distributed tone mapping.

In some embodiments, the one-shot distributed tone mapping is configured to map a physical tone within a subchannel where a logical RU allocation mode is located to a logical tone within the OFDMA PPDU bandwidth.

In some embodiments, the first tone is a physical tone within the subchannel where the logical RU allocation mode is located, the second tone is a first intermediate tone, the third tone is a second intermediate tone, the fourth tone is a physical tone obtained by the distributed tone mapping and the fifth tone is the logical tone within the OFDMA PPDU bandwidth.

In some embodiments, the distributed tone mapping includes two-shot distributed tone mapping.

In some embodiments, the two-shot distributed tone mapping includes shot-1 distributed tone mapping and shot-2 distributed tone mapping; wherein
the shot-1 distributed tone mapping is configured to map a physical tone within a subchannel of each tone mapping bandwidth to an intermediate logical tone within a subchannel of each tone mapping bandwidth; and
the shot-2 distributed tone mapping is configured to map the intermediate logical tone to the logical tone within the OFDMA PPDU bandwidth.

In some embodiments, in the shot-1 distributed tone mapping, the first tone is the physical tone within a subchannel of the tone mapping bandwidth, the second tone is a first intermediate tone, the third tone is a second intermediate tone, the fourth tone is a physical tone obtained by the shot-1 distributed tone mapping, and the fifth tone is the intermediate logical tone.

In some embodiments, in the shot-1 distributed tone mapping, the tone mapping bandwidth is one of the following: 20 MHz, 40 MHz, 60 MHz, or 80 MHz.

In some embodiments, the first RU includes an RU 26.

In some embodiments, in the shot-2 distributed tone mapping, the first tone is an intermediate logical tone obtained by the shot-1 distributed tone mapping, the second tone is a third intermediate tone, the third tone is a fourth intermediate tone, the fourth tone is a physical tone obtained by the shot-2 distributed tone mapping, and the fifth tone is the logical tone within the OFDMA PPDU bandwidth.

In some embodiments, the first tone includes some or all physical tones that do not participate in the shot-1 distributed tone mapping.

In some embodiments, in the shot-2 distributed tone mapping, the tone mapping bandwidth is a sum of bandwidths occupied by the transmission of OFDMA PPDU preambles.

In some embodiments, the first RU includes an RU 242.

In some embodiments, the second RU includes a logical RU, and the processing unit 310 is further configured to construct a logical RU within the tone mapping bandwidth by using a physical tone index of the first RU and a logical tone index obtained by the distributed tone mapping, and determine at least one of a type, an index, a logical tone index, and a physical tone index of the logical RU within the tone mapping bandwidth.

In some embodiments, the physical tone index of the logical RU is the first tone index used in the one-shot distributed tone mapping, and the logical tone index of the logical RU is the fifth tone index obtained by the one-shot distributed tone mapping.

In some embodiments, the physical tone index of the logical RU is the first tone index used in the shot-1 distributed tone mapping, and the logical tone index of the logical RU is the fifth tone index obtained by the shot-2 distributed tone mapping.

In some embodiments, a relationship between a type of the logical RU and a tone mapping bandwidth includes at least one of the following:
the tone mapping bandwidth is 20 MHz, and the type of the logical RU comprises at least one of a 26-tone RU, a 52-tone RU, or a 106-tone RU;
the tone mapping bandwidth is 40 MHz, and the type of the logical RU comprises at least one of a 26-tone RU, a 52-tone RU, a 106-tone RU, or a 242-tone RU;
the tone mapping bandwidth is 80 MHz, and the type of the logical RU comprises at least one of a 26-tone RU, a 52-tone RU, a 106-tone RU, a 242-tone RU, or a 484-tone RU; or
the tone mapping bandwidth is 160 MHz, and the type of the logical RU comprises at least one of a 26-tone RU, a 52-tone RU, a 106-tone RU, a 242-tone RU, a 484-tone RU, a 996-tone RU, or a 2×996-tone RU.

In some embodiments, the second RU includes a logical multiple resource unit (MRU), and the processing unit 310 is further configured to construct the logical MRU based on a logical RU in the one-shot distributed tone mapping or a logical RU in the two-shot distributed tone mapping.

In some embodiments, the processing unit 310 is further configured to allocate the resource units in at least one of the following manners:
allocating the logical RU and/or the logical MRU in a logical RU allocation mode, wherein the logical MRU is constructed by using the logical RU in a manner of constructing the physical MRU; or
allocating the logical RU in the logical RU allocation mode, and allocating the physical RU and the physical MRU in a physical RU allocation mode.

In some embodiments, the first RU includes a physical RU and/or a physical MRU.

In some embodiments, the processing unit 310 is further configured to perform channel estimation by using a four-fold extremely high throughput long training field (4×EHT LTF).

The communication device 300 in the embodiments of the present disclosure implements corresponding functions of the communication device in the foregoing embodiment of the method 200. For procedures, functions, implementations, and beneficial effects corresponding to the modules (submodules, units, or components) in the communication device 300, reference is made to corresponding descriptions in the foregoing method embodiments. Details are not described herein again. It should be noted that functions described by the modules (submodules, units, or components) in the communication device 300 in the embodiments of the present disclosure are implemented by different modules (submodules, units, or components), or are implemented by the same module (submodule, unit, or component).

Examples of specific application scenarios of the embodiments of the present disclosure are described below.

### 1. EHT PPDU

First, two types of EHT PPDUs are introduced: EHT MU PPDU and EHT TB PPDU.

### (1) EHT MU PPDU

A format of the EHT MU PPDU is shown in FIG. 4A, and is used to transmit the EHT MU PPDU to one or more users. In the EHT MU PPDU, L-STF, L-LTF, L-SIG, U-SIG, and EHT-SIG are referred to as pre-EHT (pre-EHT or forward EHT) modulation fields, and EHT-STF, EHT-LTF, Data, and PE are referred to as EHT modulation fields.

### (2) EHT TB PPDU

A format of the EHT TB PPDU is shown in FIG. 4B, and is used to transmit a response trigger frame from an AP. In the EHT TB PPDU, L-STF, L-LTF, L-SIG, and U-SIG are referred to as pre-EHT modulation fields, and EHT-STF, EHT-LTF, Data, and PE are referred to as EHT modulation fields. Duration of the EHT-STF field in the EHT TB PPDU is twice the length of duration of the EHT-STF field in the EHT MU PPDU.

One OFDMA PPDU (e.g., an OFDMA EHT PPDU or an OFDMA PPDU defined in next-generation IEEE 802.11 technologies) has two possible RU allocation modes: a physical RU allocation mode and a logical RU allocation mode. When an OFDMA PPDU uses the physical RU allocation mode, the AP may allocate one physical RU or MRU to each intended STA. When an OFDMA PPDU uses the logical RU allocation mode, the AP allocates one logical RU or MRU to each intended STA. A non-OFDMA PPDU (e.g., non-OFDMA EHT PPDU or non-OFDMA PPDU defined in next-generation IEEE 802.11 technologies) can use only the physical RU allocation mode.

An RU allocation mode and RU allocation information need to be indicated for an OFDMA PPDU by using signaling. An OFDMA EHT PPDU is used as an example. During the downlink OFDMA transmission, the RU allocation mode is indicated by an RU allocation mode field of a U-SIG or EHT-SIG field in an EHT MU PPDU, and RU allocation information of the STA is indicated by an RU allocation subfield of the EHT-SIG field in the EHT MU PPDU. During the uplink transmission, the RU allocation mode is indicated by an RU allocation mode subfield of an EHT variant Common Info field in a trigger frame that requests the uplink EHT TB PPDU transmission, and RU allocation information of the STA is indicated by an RU allocation subfield and a PS160 subfield of an EHT variant user information field (EHT variant User Info field) in a user information list field in the trigger frame that requests the uplink EHT TB PPDU transmission.

### 2. EHT Punctured Channel

Bandwidths specified in the IEEE 802.11be draft standard include only 20 MHz, 40 MHz, 80 MHz, 160 MHz, and 320 MHz. However, if the bandwidth is greater than or equal to 80 MHz, a channel may be punctured. According to the 11be draft standard, the minimum unit of the punctured channel is 20 MHz. During OFDMA PPDU transmission, the puncturing mode of each 80-MHz frequency domain sub-block is “0111, 1011, 1101, 1110, 0011, 1100, 1001”, wherein 0 represents a punctured 20-MHz subchannel, and 1 represents a non-punctured 20-MHz subchannel.

Specifically, the punctured 20-MHz subchannel does not include a physical tone index. For example, within an 80-MHz bandwidth, four 20-MHz physical tone indexes are respectively [−500: −259] [−253: −12] [12: 253] [259: 500], and if the puncturing mode is “1011” and the second 20-MHz subchannel is punctured, the index [−253: −12] does not exist.

Based on the foregoing puncturing mode, within the 80-Mhz bandwidth, one or two 20-MHz subchannels are punctured; within a 160-MHz subchannel, one, two, three, or four 20-MHz subchannels are punctured; within a 320-MHz subchannel, one, two, three, four, five, six, seven, or eight 20-MHz subchannels are punctured.

### 3. OFDMA PPDU Transmission and Reception Based on a Logical RU Allocation Mode

The logical RU allocation mode is based on distributed tone mapping. Specifically, contiguous logical tones within an OFDMA PPDU bandwidth are mapped to non-contiguous physical tones, and the OFDMA PPDU transmits data by using these non-contiguous physical tones.

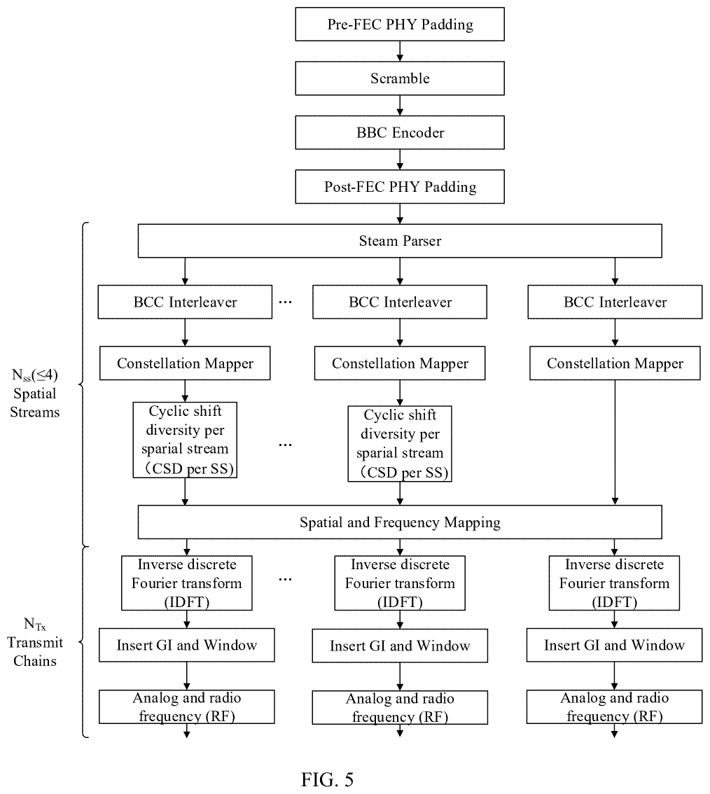

When the OFDMA PPDU is generated, distributed tone mapping occurs in a spatial and frequency mapping phase. Spatial mapping means to map a spatial stream onto a corresponding RF link. Frequency domain mapping means to map a modulation symbol to a corresponding physical tone for each RF link. Specifically, for each RF link, frequency domain mapping includes two steps: first, the modulation symbol is mapped to a logical tone, and then the logical tone is mapped to a physical tone. BCC-encoded data field transmission is used as an example. The location of the distributed tone mapping in a transmission procedure is shown in a spatial and frequency mapping part in FIG. 5.

FIG. 5 indicates a UL or DL non-MU-MIMO transmission flowchart of a data field encoded by using a BCC when an RU/MRU is less than or equal to a 242-tone RU.

In FIG. 5, when the RU or the MRU is less than or equal to the 242-tone and UL or DL non-MU-MIMO transmission of the BCC-encoded data field is used, the location of the distributed tone mapping is spatial and frequency mapping.

When one EHT MU PPDU is received, a receiving end determines, based on an RU allocation mode indicated in a U-SIG or EHT-SIG field, whether an EHT modulation field of the EHT MU PPDU uses the logical RU allocation mode. The logical RU allocation mode is based on distributed tone mapping. If the logical RU allocation mode is used in the EHT modulation field of the EHT MU PPDU, the receiving end determines, based on the PPDU bandwidth, punctured channel information, and RU allocation information of the receiving end that are indicated in the U-SIG and/or EHT-SIG field, the physical tone corresponding to the logical RU (or MRU) allocated by the receiving end.

### 4. Distributed Tone Mapping

The present disclosure proposes a distributed tone mapping approach based on a “four-step mapping approach”, and designs a detailed procedure of distributed tone mapping in the case of a non-punctured channel and a punctured channel. The following features are specifically contained.
(1) Specific steps of the “four-step mapping approach” include: mapping a first tone index to a second tone index through calculation by using a formula (an example of the first pattern); mapping the second tone index to a third tone index by using a pre-specified rule (an example of the second pattern); mapping the third tone index to a fourth tone index by using a formula (an example of the third pattern); and mapping a fourth tone index to a fifth tone index through sequential mapping (an example of the fourth pattern). Definitions of the first, second, third, fourth, and fifth tones depend on solutions of the distributed tone mapping.
(2) In the “four-step mapping approach”, the mapping is performed based on a reference RU. For example, only tones constituting the reference RU participate in the distributed tone mapping, a tone that is not contained in any reference RU does not participate in the distributed tone mapping, and first tone indexes in these tones are equal to respective fifth tone indexes.
(3) When a PPDU is used for OFDMA transmission, distributed tone mapping is performed. If there is a punctured channel, a physical tone index in the punctured channel is first removed, and then the distributed tone mapping is performed by using the “four-step mapping approach”.
(4) There are two options for distributed tone mapping: (a) one-shot distributed tone mapping; (b) two-shot distributed tone mapping.
a) In the one-shot distributed tone mapping, a physical tone within a subchannel on which the logical RU allocation mode is located is mapped to a logical tone within an OFDMA PPDU bandwidth. A reference RU for the one-shot distributed tone mapping is an RU 26.
b) The two-shot distributed tone mapping includes shot-1 distributed tone mapping and shot-2 distributed tone mapping. For example, in the shot-1 distributed tone mapping, physical tones within every 20-MHz subchannel are mapped to intermediate logical tones within every 20-MHz subchannel. A reference RU for the shot-1 distributed tone mapping is an RU 26. In the shot-2 distributed tone mapping, the intermediate logical tone obtained by the shot-1 distributed tone mapping is mapped again to the logical tone within the OFDMA PPDU bandwidth. A reference RU for the shot-2 distributed tone mapping is an RU 242. In addition, a tone that does not participate in the shot-1 distributed tone mapping participates in the shot-2 distributed tone mapping. The bandwidth 20 MHz of the shot-1 distributed tone mapping bandwidth is merely an example but not a limitation, and the bandwidth of the shot-1 distributed tone mapping is alternatively another value, such as 40 MHz, 60 MHz, or 80 MHz. The bandwidth of the shot-1 distributed tone mapping is less than the OFDMA PPDU bandwidth of the shot-2 distributed tone mapping.
(5) In the logical RU allocation mode, a 4×LTF is used for channel estimation.
(6) The embodiments of the present disclosure further propose a solution for constructing a logical RU/MRU by using a logical tone.

The embodiments of the present disclosure propose a “four-step mapping approach” for distributed tone mapping in a case of a non-punctured channel and a case of a punctured channel. Basic steps are: first tone index-second tone index-third tone index-fourth tone index-fifth tone index.

Based on the “four-step mapping approach”, the embodiments of the present disclosure propose an implementation procedure of one-shot distributed tone mapping and two-shot distributed tone mapping. When a PPDU is used for OFDMA transmission, distributed tone mapping is performed. For example, the distributed tone mapping mainly occurs on a subchannel on which the logical RU allocation mode is located. If there is a punctured channel, all tone indexes in the punctured channel are removed first, and then the distributed tone mapping is performed.

Further, the embodiments of the present disclosure provide a requirement for an EHT-LTF in the distributed tone mapping.

Further, the embodiments of the present disclosure propose a solution for constructing a logical RU/MRU by using a logical tone.

### 4.1 Four-Step Mapping Approach

Basic steps of the “four-step mapping approach” include: first tone index-second tone index-third tone index-fourth tone index-fifth tone index. Specific meanings of the first, second, third, fourth, and fifth tones depend on a specific solution of the distributed tone mapping.

The “four-step mapping approach” is performed based on the reference RU. Tones within a subchannel where the logical RU allocation mode is located include a tone that constitutes the reference RU and a tone that is not contained in any reference RU. For example, the tone that constitutes the reference RU participates in the distributed tone mapping, the tone that is not contained in any reference RU does not participate in the distributed tone mapping, and the first tone indexes in these tones are equal to respective fifth tone indexes.

The steps of the “four-step mapping approach” specifically include the following examples.
(1) Map a first tone index to a second tone index.

First tone indexes are sequentially marked as 1, 2, 3, . . . , and converted into second tone indexes. The first tone index is converted into the second tone index through calculation by using a formula.
(2) Map the second tone index to a third tone index.

The second tone indexes are mapped to third tone indexes according to a pre-specified rule. For example, in a uniform mapping pattern, mapping is performed every Dₜₘ tones. For another example, mapping is performed in a non-uniform pattern. This may be implemented in a mapping table lookup or formula calculation manner. An example formula of uniform mapping proposed in the embodiments of the present disclosure is as follows:

$${k}_{3} = mod ( {D}_{tm} \times ( {k}_{2} - 1 ) + a , N ) , \qquad ( 1 )$$

$${k}_{2} ∈ [ {N}_{base} ( a - 1 ) + 1 , {N}_{b a s e} * a ]$$

wherein k₂ is the second tone index; a is determined based on a value of k₂, and a is a positive integer; k₃ is the third tone index; N_{base} is the size of a reference RU; N is the total quantity of tones that constitute the reference RU within a tone mapping bandwidth; and Dₜₘ is the mapping distance, and a value thereof is related to the tone mapping bandwidth.
(3) Map the third tone index to a fourth tone index.

Step (3) is an inverse process of step (1), and the third tone index is converted into the fourth tone index through formula calculation.
(4) Map the fourth tone index to a fifth tone index.

For example, the fourth tone indexes are sequentially mapped to the fifth tone indexes.

### 4.2 One-Shot Distributed Tone Mapping

In an implementation, the “four-step mapping approach” is used in a one-shot distributed tone mapping process, that is, steps (1) to (4) in 4.1 are contained. A first tone is a physical tone, and an index of the first tone is kₚ; a second tone is a first intermediate tone, and an index of the second tone is kᵢ₁; a third tone is a second intermediate tone, and an index of the third tone is kᵢ₂; a fourth tone is a physical tone obtained by distributed mapping, and an index of the fourth tone is [symbol] and a fifth tone is a logical tone, and an index of the fifth tone is kₗ. A tone mapping bandwidth is a sum of bandwidths occupied by PPDU preamble transmission. The reference RU is an RU 26.

For example, when an OFDMA PPDU bandwidth is 80 MHz and there is a punctured channel, a puncturing mode is “1011”, that is, the second 20-MHz subchannel is punctured, and a physical tone index corresponding to the second 20-MHz subchannel is [−253: −12]. An RU 996 actually includes only 754 tones, and consists of tones of 27 groups of RUs 26 and 52 tones that are not contained in any RU 26. 27 groups of tones of the RU 26 participate in the distributed tone mapping, and 52 tones that are not contained in any RU 26 do not participate in the distributed tone mapping. Physical tone indexes of the 52 tones [−500, −447, −446, −393, −366, −313, −312, −259, −258, −257, −256, −255, −254, −11, −10, −9, −8, −7, −6, −5, −4, −3, 3, 4, 5, 6, 7, 8, 9, 10, 11, 12, 65, 66, 119, 146, 199, 200, 253, 254, 255, 256, 257, 258, 259, 312, 313, 366, 393, 446, 447, 500] are equal to respective logical tone indexes.
Example 1: A calculation formula for mapping the physical tone index kₚ to the first intermediate tone index kᵢ₁ in the one-shot distributed tone mapping step (1) is shown.

For example, when the OFDMA PPDU bandwidth is 80 MHz and there is no punctured channel, an example of the calculation formula for mapping the physical tone index kₚ to the first intermediate tone index kᵢ₁ is as follows:

$${k}_{i 1} = \{ \begin{matrix}{k}_{p} + 500 , {k}_{p} ∈ [ - 499 , - 448 ] \\ {k}_{p} + 498 , {k}_{p} ∈ [ - 445 , - 394 ] \\ {k}_{p} + 497 , {k}_{p} ∈ [ - 392 , - 367 ] \\ {k}_{p} + 496 , {k}_{p} ∈ [ - 365 , - 314 ] \\ {k}_{p} + 494 , {k}_{p} ∈ [ - 311 , - 260 ] \\ {k}_{p} + 487 , {k}_{p} ∈ [ - 252 , - 201 ] \\ {k}_{p} + 485 , {k}_{p} ∈ [ - 198 , - 147 ] \\ {k}_{p} + 484 , {k}_{p} ∈ [ - 145 , - 120 ] \\ {k}_{p} + 483 , {k}_{p} ∈ [ - 118 , - 67 ] \\ {k}_{p} + 481 , {k}_{p} ∈ [ - 64 , - 13 ]\end{matrix} {k}_{i 1} = \{ \begin{matrix}{k}_{p} + 456 , {k}_{p} ∈ [ 13 , 64 ] \\ {k}_{p} + 454 , {k}_{p} ∈ [ 67 , 118 ] \\ {k}_{p} + 453 , {k}_{p} ∈ [ 120 , 145 ] \\ {k}_{p} + 452 , {k}_{p} ∈ [ 147 , 198 ] \\ {k}_{p} + 450 , {k}_{p} ∈ [ 201 , 252 ] \\ {k}_{p} + 443 , {k}_{p} ∈ [ 260 , 311 ] \\ {k}_{p} + 441 , {k}_{p} ∈ [ 314 , 365 ] \\ {k}_{p} + 440 , {k}_{p} ∈ [ 367 , 392 ] \\ {k}_{p} + 439 , {k}_{p} ∈ [ 394 , 392 ] \\ {k}_{p} + 437 , {k}_{p} ∈ [ 448 , 499 ]\end{matrix}$$

For example, when the OFDMA PPDU bandwidth is 80 MHz and there is a punctured channel, the puncturing mode is “1011”, that is, the second 20-MHz subchannel is punctured, and the calculation formula for mapping the physical tone index kₚ to the first intermediate tone index kᵢ₁ is as follows:

$${k}_{i 1} = \{ \begin{matrix}{k}_{p} + 500 , {k}_{p} ∈ [ - 499 , - 448 ] \\ {k}_{p} + 498 , {k}_{p} ∈ [ - 445 , - 394 ] \\ {k}_{p} + 497 , {k}_{p} ∈ [ - 392 , - 367 ] \\ {k}_{p} + 496 , {k}_{p} ∈ [ - 365 , - 314 ] \\ {k}_{p} + 494 , {k}_{p} ∈ [ - 311 , - 260 ]\end{matrix} ,$$

$${k}_{i 1} = \{ \begin{matrix}{k}_{p} + 222 , {k}_{p} ∈ [ 13 , 64 ] \\ {k}_{p} + 220 , {k}_{p} ∈ [ 67 , 118 ] \\ {k}_{p} + 219 , {k}_{p} ∈ [ 120 , 145 ] \\ {k}_{p} + 218 , {k}_{p} ∈ [ 147 , 198 ] \\ {k}_{p} + 216 , {k}_{p} ∈ [ 201 , 252 ] \\ {k}_{p} + 209 , {k}_{p} ∈ [ 260 , 311 ] \\ {k}_{p} + 207 , {k}_{p} ∈ [ 314 , 365 ] \\ {k}_{p} + 206 , {k}_{p} ∈ [ 367 , 392 ] \\ {k}_{p} + 205 , {k}_{p} ∈ [ 394 , 445 ] \\ {k}_{p} + 203 , {k}_{p} ∈ [ 448 , 499 ]\end{matrix}$$

Non-contiguous physical tone indexes are mapped to contiguous first intermediate tone indexes whose initial value is 1 by using the formulas in Example 1. A specific value to be added to kₚ in the formulas may also be changed, to change an initial value of the first intermediate tone index. In addition, if the OFDMA PPDU bandwidth changes, the specific value to be added to kₚ in the formulas may also be changed. Further, another calculation method besides adding to kₚ may also be used, for example, being subtracted from kₚ.
Example 2: Each parameter value of Formula (1) in step (2) of the one-shot distributed tone mapping is shown.

For example, in Formula (1), N_{base}=26, and values of N and Dₜₘ are shown in Table 1.

TABLE 1
Values of N and Dₜₘ within different tone mapping bandwidths

| Tone mapping bandwidth | N | Dₜₘ |
|---|---|---|
| 20 MHz | 9 × 26 = 234 | 9 |
| 40 MHz, or 80-MHz bandwidth punctured with two 20-MHz subchannels | 18 × 26 = 468 | 18 |
| 60 MHz (80-MHz bandwidth punctured with one 20-MHz subchannel) | 27 × 26 = 702 | 27 |
| 80 MHz, or 160-MHz bandwidth punctured with four 20-MHz subchannels | 36 × 26 = 936 | 36 |
| 100 MHz (160-MHz bandwidth punctured with three 20-MHz subchannels) | 45 × 26 = 1170 | 45 |
| 120 MHz (160-MHz bandwidth punctured with two 20-MHz subchannels) | 54 × 26 = 1404 | 54 |
| 140 MHz (160-MHz bandwidth punctured with one 20-MHz subchannels) | 63 × 26 = 1638 | 63 |
| 160 MHz, or 320-MHz bandwidth punctured with eight 20-MHz subchannels | 72 × 26 = 1872 | 72 |
| 180 MHz (320-MHz bandwidth punctured with seven 20-MHz subchannels) | 81 × 26 = 2106 | 81 |
| 200 MHz (320-MHz bandwidth punctured with six 20-MHz subchannels) | 90 × 26 = 2340 | 90 |
| 220 MHz (320-MHz bandwidth punctured with five 20-MHz subchannels) | 99 × 26 = 2574 | 99 |
| 240 MHz (320-MHz bandwidth punctured with four 20-MHz subchannels) | 108 × 26 = 2808 | 108 |
| 260 MHz (320-MHz bandwidth punctured with three 20-MHz subchannels) | 117 × 26 = 3042 | 117 |
| 280 MHz (320-MHz bandwidth punctured with two 20-MHz subchannels) | 126 × 26 = 3276 | 126 |
| 300 MHz (320-MHz bandwidth punctured with one 20-MHz subchannel) | 135 × 26 = 3510 | 135 |
| 320 MHz | 144 × 26 = 3744 | 144 |

Example 3: A mapping formula for mapping, in step (3) of the one-shot distributed tone mapping, the second intermediate tone index kᵢ₂ to the physical tone index kₚ′ obtained by the distributed mapping is shown. The formula used in step (3) is an inverse process of the formula used in step (1) in Example 1.

For example, when the OFDMA PPDU bandwidth is 80 MHz and there is no punctured channel, a calculation formula of mapping the second intermediate tone index kᵢ₂ to the physical tone index

$${k}_{p}^{′}$$

obtained by the distributed mapping is as follows:

$${k}_{p}^{′} = \{ \begin{matrix}{k}_{i 2} - 500 , {k}_{i 2} ∈ [ 1 , 52 ] \\ {k}_{i 2} - 498 , {k}_{i 2} ∈ [ 53 , 104 ] \\ {k}_{i 2} - 497 , {k}_{i 2} ∈ [ 105 , 130 ] \\ {k}_{i 2} - 496 , {k}_{i 2} ∈ [ 131 , 182 ] \\ {k}_{i 2} - 494 , {k}_{i 2} ∈ [ 183 , 234 ] \\ {k}_{i 2} - 487 , {k}_{i 2} ∈ [ 235 , 286 ] \\ {k}_{i 2} - 485 , {k}_{i 2} ∈ [ 287 , 338 ] \\ {k}_{i 2} - 484 , {k}_{i 2} ∈ [ 339 , 364 ] \\ {k}_{i 2} - 483 , {k}_{i 2} ∈ [ 365 , 416 ] \\ {k}_{i 2} - 481 , {k}_{i 2} ∈ [ 417 , 468 ]\end{matrix} ,$$

$${k}_{p}^{′} = \{ \begin{matrix}{k}_{i 2} - 456 , {k}_{i 2} ∈ [ 469 , 520 ] \\ {k}_{i 2} - 454 , {k}_{i 2} ∈ [ 521 , 572 ] \\ {k}_{i 2} - 453 , {k}_{i 2} ∈ [ 573 , 598 ] \\ {k}_{i 2} - 452 , {k}_{i 2} ∈ [ 599 , 650 ] \\ {k}_{i 2} - 450 , {k}_{i 2} ∈ [ 651 , 702 ] \\ {k}_{i 2} - 443 , {k}_{i 2} ∈ [ 703 , 754 ] \\ {k}_{i 2} - 441 , {k}_{i 2} ∈ [ 755 , 806 ] \\ {k}_{i 2} - 440 , {k}_{i 2} ∈ [ 807 , 832 ] \\ {k}_{i 2} - 439 , {k}_{i 2} ∈ [ 833 , 884 ] \\ {k}_{i 2} - 437 , {k}_{i 2} ∈ [ 885 , 936 ]\end{matrix}$$

For example, when the OFDMA PPDU bandwidth is 80 MHz and there is a punctured channel, the puncturing mode is “1011”, that is, the second 20-MHz subchannel is punctured, and the calculation formula of mapping the second intermediate tone index kᵢ₂ to the physical tone index

$${k}_{p}^{′}$$

obtained by the distributed mapping is as follows:

$${k}_{i 1} = \{ \begin{matrix}{k}_{i 2} - 500 , {k}_{i 2} ∈ [ 1 , 52 ] \\ {k}_{i 2} - 498 , {k}_{i 2} ∈ [ 53 , 104 ] \\ {k}_{i 2} - 497 , {k}_{i 2} ∈ [ 105 , 130 ] \\ {k}_{i 2} - 496 , {k}_{i 2} ∈ [ 131 , 182 ] \\ {k}_{i 2} - 494 , {k}_{i 2} ∈ [ 183 , 234 ]\end{matrix} ,$$

$${k}_{i 1} = \{ \begin{matrix}{k}_{i 2} - 222 , {k}_{i 2} ∈ [ 235 , 286 ] \\ {k}_{i 2} - 220 , {k}_{i 2} ∈ [ 287 , 338 ] \\ {k}_{i 2} - 219 , {k}_{i 2} ∈ [ 339 , 364 ] \\ {k}_{i 2} - 218 , {k}_{i 2} ∈ [ 365 , 416 ] \\ {k}_{i 2} - 216 , {k}_{i 2} ∈ [ 417 , 468 ] \\ {k}_{i 2} - 209 , {k}_{i 2} ∈ [ 469 , 520 ] \\ {k}_{i 2} - 207 , {k}_{i 2} ∈ [ 521 , 572 ] \\ {k}_{i 2} - 206 , {k}_{i 2} ∈ [ 573 , 598 ] \\ {k}_{i 2} - 205 , {k}_{i 2} ∈ [ 599 , 650 ] \\ {k}_{i 2} - 203 , {k}_{i 2} ∈ [ 651 , 702 ]\end{matrix}$$

Example 4: A sequence mapping process of step (4) of the one-shot distributed tone mapping is shown.

For example, within the 20-MHz bandwidth, when physical tone indexes obtained by the distributed mapping are [−121, −112, −103, 94, −85, −76, −66, −57, −48, −39, −30, −21, −12, 4, 13, 22, 31, 40, 49, 58, 67, 77, 86, 95, 104, 113], and corresponding logical tone indexes are [−121: −96], that is, from −121 to −96.

### 4.3 Two-Shot Distributed Tone Mapping

In an implementation, the two-shot distributed tone mapping specifically includes shot-1 distributed tone mapping and shot-2 distributed tone mapping.

### 4.3.1 Shot-1 Distributed Tone Mapping

In an implementation, the “four-step mapping approach” is used in a shot-1 distributed tone mapping process, that is, steps (1) to (4) in 4.1 are contained. A first tone is a physical tone, and an index of the first tone is k_{p,1}; a second tone is a first intermediate tone, and an index of the second tone is k_{i1,1}; a third tone is a second intermediate tone, and an index of the third tone is k_{i2,1}; a fourth tone is a physical tone obtained by the shot-1 distributed tone mapping, and an index of the fourth tone is

$${k}_{p , 1}^{′} ;$$

and a fifth tone is an intermediate logical tone, and an index of the fifth tone is k_{l,1}. For example, in the shot-1 distributed tone mapping, a tone mapping bandwidth is 20 MHz. The reference RU is an RU 26.

In the shot-1 distributed tone mapping, physical tones within every 20-MHz subchannel may be mapped to intermediate logical tones within every 20-MHz subchannel.

For example, if the OFDMA PPDU bandwidth is 40 MHz, distributed tone mapping is separately performed on two 20-MHz subchannels. Within each 20 MHz bandwidth, an RU 242 consists of nine groups of tones of the RU 26 and eight tones that are not contained in any RU 26. The nine groups of tones of the RU 26 participate in the distributed tone mapping, and the eight tones that are not contained in any RU 26 do not participate in the distributed tone mapping, and physical tone indexes of the eight tones are equal to respective intermediate logical tone indexes.
Example 5: A calculation formula for mapping the physical tone index k_{p,1} to the first intermediate tone index k_{i1,1} in step (1) of the shot-1 distributed tone mapping is shown.

For example, when the OFDMA PPDU bandwidth is 40 MHz, calculation formulas for mapping physical tone indexes k_{p,1} of the first and second 20-MHz subchannels to the first intermediate tone index k_{i1,1} are separately as follows:

$${k}_{i 1 , 1} = \{ \begin{matrix}{k}_{p , 1} + 244 , {k}_{p , 1} ∈ [ - 234 , - 192 ] \\ {k}_{p , 1} + 242 , {k}_{p , 1} ∈ [ - 189 , - 138 ] \\ {k}_{p , 1} + 241 , {k}_{p , 1} ∈ [ - 136 , - 111 ] \\ {k}_{p , 1} + 240 , {k}_{p , 1} ∈ [ - 109 , - 58 ] \\ {k}_{p , 1} + 238 , {k}_{p , 1} ∈ [ - 55 , - 4 ]\end{matrix} ,$$

$${k}_{i 1 , 1} = \{ \begin{matrix}{k}_{p , 1} - 3 , {k}_{p , 1} ∈ [ 4 , 55 ] \\ {k}_{p , 1} - 5 , {k}_{p , 1} ∈ [ 58 , 109 ] \\ {k}_{p , 1} - 6 , {k}_{p , 1} ∈ [ 111 , 136 ] \\ {k}_{p , 1} - 7 , {k}_{p , 1} ∈ [ 138 , 189 ] \\ {k}_{p , 1} - 9 , {k}_{p , 1} ∈ [ 192 , 243 ]\end{matrix}$$

Non-contiguous physical tone indexes are mapped to contiguous first intermediate tone indexes whose initial value is 1 by using the formulas in Example 5. A specific value to be added to k_{p,1} in the formulas may also be changed, to change an initial value of the first intermediate tone index. In addition, if the OFDMA PPDU bandwidth changes, the specific value to be added to k_{p,1} in the formulas may also be changed. Further, another calculation method besides adding to k_{p,1} may also be used, for example, being subtracted from k_{p,1}.
Example 6: Each parameter value of Formula (1) in step (2) of the shot-1 distributed tone mapping is shown.

For example, in Formula (1), N_{base}=26, N=234, and Dₜₘ=9.
Example 7: A mapping formula for mapping the second intermediate tone index k_{i2,1} in step (3) of the shot-1 distributed tone mapping to the physical tone

$${k}_{p , 1}^{′}$$

obtained by the shot-1 distributed tone mapping is shown. The formula used in step (3) is an inverse process of the formula used in step (1) in Example 5.

For example, when the OFDMA PPDU bandwidth is 40 MHz, calculation formulas for mapping second intermediate tone indexes k_{i2,1} of the first 20-MHz subchannel and the second 20-MHz subchannel to the physical tone

$${k}_{p , 1}^{′}$$

obtained by the shot-1 distributed tone mapping are respectively as follows:

$${k}_{p , 1}^{′} = \{ \begin{matrix}{k}_{i 2 , 1} - 244 , {k}_{i 2 , 1} ∈ [ 1 , 52 ] \\ {k}_{i 2 , 1} - 242 , {k}_{i 2 , 1} ∈ [ 53 , 104 ] \\ {k}_{i 2 , 1} - 241 , {k}_{i 2 , 1} ∈ [ 105 , 130 ] \\ {k}_{i 2 , 1} - 240 , {k}_{i 2 , 1} ∈ [ 131 , 182 ] \\ {k}_{i 2 , 1} - 238 , {k}_{i 2 , 1} ∈ [ 183 , 234 ]\end{matrix} ,$$

$${k}_{p , 1}^{′} = \{ \begin{matrix}{k}_{i 2 , 1} + 3 , {k}_{i , 2 , 1} ∈ [ 1 , 52 ] \\ {k}_{i 2 , 1} + 5 , {k}_{i , 2 , 1} ∈ [ 53 , 104 ] \\ {k}_{i 2 , 1} + 6 , {k}_{i , 2 , 1} ∈ [ 105 , 130 ] \\ {k}_{i 2 , 1} + 7 , {k}_{i , 2 , 1} ∈ [ 131 , 182 ] \\ {k}_{i 2 , 1} + 9 , {k}_{i , 2 , 1} ∈ [ 183 , 234 ]\end{matrix}$$

Example 8: A sequential mapping process of step (4) of the shot-1 distributed tone mapping is shown.

For example, within the 40-MHz bandwidth, when physical tone indexes obtained by the shot-1 distributed tone mapping are [−243, −234, −225, −216, −207, −198, −187, −178, −169, −160, −151, −142, −132, −123, −114, −104, −95, −86, −77, −68, −59, −48, −39, −30, −21, −12], and corresponding logical tone indexes are [−243: −218], that is, from −243 to −218.

### 4.3.2 Shot-2 Distributed Tone Mapping

In an implementation, the “four-step mapping approach” is used in a shot-2 distributed tone mapping process, that is, steps (1) to (4) in 4.1 are contained. A first tone is an intermediate logical tone, and an index of the first tone is k_{l,1}; a second tone is a first intermediate tone, and an index of the second tone is k_{i1,2}; a third tone is a second intermediate tone, and an index of the third tone is k_{i2,2}; a fourth tone is a physical tone obtained by the shot-2 distributed tone mapping, and an index of the fourth tone is

$${k}_{p , 2}^{′} ;$$

and a fifth tone is a logical tone, and an index of the fifth tone is k_{l,2}. In the shot-2 distributed tone mapping, a tone mapping bandwidth is a sum of bandwidths occupied by PPDU preamble transmission. The reference RU is an RU 242.

In the shot-2 distributed tone mapping, the intermediate logical tone obtained by the shot-1 distributed tone mapping is mapped to the logical tone within the entire OFDMA PPDU bandwidth. A tone that does not participate in the shot-1 distributed tone mapping may also participate in the shot-2 distributed tone mapping. For example, when the OFDMA PPDU bandwidth is 80 MHz and there is no punctured channel, an RU 996 includes four groups of tones of the RU 242 and 28 tones that are not contained in any RU 242. The four groups of tones of the RU 242 participate in the shot-2 distributed tone mapping, and the 28 tones that are not contained in any RU 242 do not participate in the shot-2 distributed tone mapping. Intermediate logical tone indexes [−258, −257, −256, −255, −254, −11, −10, −9, −8, −7, −6, −5, −4, 4, 5, 6, 7, 8, 9, 10, 11, 254, 255, 256, 257, 258] of the 28 tones are equal to respective logical tone indexes.
Example 9: A mapping formula for mapping every 20-MHz intermediate logical tone index k_{l,1} to the first intermediate tone index k_{i1,2} in step (1) of the shot-2 distributed tone mapping is shown.

For example, when the OFDMA PPDU bandwidth is 40 MHz, a calculation formula for mapping an intermediate logical tone index k_{l,1} to the first intermediate tone index k_{i1,2} is as follows:

$${k}_{i 1 , 2} = \{ \begin{matrix}{k}_{l , 1} + 245 , {k}_{l , 1} ∈ [ - 244 , - 3 ] \\ {k}_{l , 1} + 240 , {k}_{l , 1} ∈ [ 3 , 244 ]\end{matrix}$$

Non-contiguous physical tone indexes are mapped to contiguous first intermediate tone indexes whose initial value is 1 by using the formulas in Example 9. A specific value to be added to k_{l,1} in the formulas may also be changed, to change an initial value of the first intermediate tone index. In addition, if the OFDMA PPDU bandwidth changes, the specific value to be added to k_{l,1} in the formulas may also be changed. Further, another calculation method besides adding to k_{l,1} may also be used, for example, being subtracted from k_{l,1}.
Example 10: Each parameter value of Formula (1) in step (2) of the shot-2 distributed tone mapping is shown.

For example, in Formula (1), N_{base}=242, and values of N and Dₜₘ are shown in Table 2.

TABLE 2
Values of N and Dₜₘ of the shot-2 distributed tone
mapping within different tone mapping bandwidth

| Tone mapping bandwidth | N | Dₜₘ |
|---|---|---|
| 40 MHz, or 80-MHz bandwidth punctured with two 20-MHz subchannels | 2 × 242 = 484 | 18 |
| 60 MHz (80-MHz bandwidth punctured with one 20-MHz subchannel) | 3 × 242 = 726 | 15 |
| 80 MHz, or 160-MHz bandwidth punctured with four 20-MHz subchannels | 4 × 242 = 968 | 12 |
| 100 MHz (160-MHz bandwidth punctured with three 20-MHz subchannels) | 5 × 242 = 1210 | 5 |
| 120 MHz (160-MHz bandwidth punctured with two 20-MHz subchannels) | 6 × 242 = 1452 | 6 |
| 140 MHz (160-MHz bandwidth punctured with one 20-MHz subchannels) | 7 × 242 = 1694 | 7 |
| 160 MHz, or 320-MHz bandwidth punctured with eight 20-MHz subchannels | 8 × 242 = 1936 | 13 |
| 180 MHz (320-MHz bandwidth punctured with seven 20-MHz subchannels) | 9 × 242 = 2178 | 9 |
| 200 MHz (320-MHz bandwidth punctured with six 20-MHz subchannels) | 10 × 242 = 2420 | 10 |
| 220 MHz (320-MHz bandwidth punctured with five 20-MHz subchannels) | 11 × 242 = 2662 | 11 |
| 240 MHz (320-MHz bandwidth punctured with four 20-MHz subchannels) | 12 × 242 = 2904 | 12 |
| 260 MHz (320-MHz bandwidth punctured with three 20-MHz subchannels) | 13 × 242 = 3146 | 13 |
| 280 MHz (320-MHz bandwidth punctured with two 20-MHz subchannels) | 14 × 242 = 3388 | 14 |
| 300 MHz (320-MHz bandwidth punctured with one 20-MHz subchannel) | 15 × 242 = 3630 | 15 |
| 320 MHz | 16 × 242 = 3872 | 16 |

Example 11: A mapping formula for mapping the second intermediate tone index k_{i2,2} to the physical tone index

$${k}_{p , 2}^{′}$$

obtained by the shot-2 distributed tone mapping in step (3) of the shot-2 distributed tone mapping is shown. The formula used in step (3) is an inverse process of the formula used in step (1) in Example 9.

For example, when the OFDMA PPDU bandwidth is 40 MHz, a calculation formula for mapping the second intermediate tone index k_{i2,2} to the physical tone index

$${k}_{p , 2}^{′}$$

obtained by the shot-2 distributed tone mapping is as follows:

$${k}_{p , 2}^{′} = \{ \begin{matrix}{k}_{i 2 , 2} - 245 , {k}_{i 2 , 2} ∈ [ 1 , 242 ] \\ {k}_{i 2 , 2} - 240 , {k}_{i 2 , 2} ∈ [ 243 , 484 ]\end{matrix}$$

Example 12: A sequential mapping process of step (4) of the shot-2 distributed tone mapping is shown.

For example, within the 40-MHz bandwidth, when physical tone indexes obtained by the shot-2 distributed tone mapping are [−86, −159, −190, −84, −157, −239, −73, −155, −228, −62, −153, −226, −60, 87, 14, 180, 89, 16, 182, 100, 18, 184, 112, 20, 186, 114], and the corresponding logical tone indexes are [−243:−218].
4.4 Requirements for EHT-LTF in Distributed Tone Mapping

The EHT-LTF field is used by a receiver to estimate a MIMP channel from an output of constellation mapping to a receive link. For example, the draft IEEE 802.11be standard specifies that the EHT PPDU supports three types of EHT-LTFs: 1×EHT-LTF, 2×EHT-LTF, and 4×EHT-LTF. Respective OFDM symbol duration is 2 us, 6.4 us, and 12.8 us, and therefore, respective tone spacings are 312.5 kHz, 156.25 kHz, and 78.125 kHz. 1×EHT-LTF is equivalent to performing modulation on every four tones in one OFDM symbol. 2×EHT-LTF is equivalent to performing modulation on every two tones in one OFDM symbol. 4×EHT-LTF is equivalent to performing modulation on each tone in one OFDM symbol. In addition, it is specified that a tone spacing of a data field (Data field) is 78.125 kHz, that is, data is modulated on each tone in one OFDM symbol.

If 2×EHT-LTF is used for channel estimation, an example of an expression of the sequence part is EHT-LTF-122:122={−1, 0, −1, 0, −1, 0, +1, 0, . . . }. A channel state of a zero tone needs to be estimated by using the correlation between adjacent non-zero tones.

After the distributed tone mapping, data is modulated on non-contiguous physical tones. In a logical RU allocation mode, if non-zero tones before and after the zero tone are non-adjacent when 2×EHT-LTF is used for channel estimation, the channel state of the zero tone cannot be estimated by using the correlation.

Therefore, in the logical RU allocation mode, 4×EHT-LTF is used, because 4×EHT-LTF estimates a channel state on each tone.

### 5. Construction of a Logical RU/MRU by Using a Logical Tone

A logical RU/MRU is constructed by using a logical tone obtained by the distributed tone mapping, which is the same as a method for constructing a physical RU/MRU of the same size by using a physical tone defined in the draft IEEE 802.11be standard.

### 5.1 Construction of a Logical RU in One-Shot Distributed Tone Mapping

Example 13: Construction of different types of logical RUs by using logical tones obtained by the one-shot distributed tone mapping is separately shown. For a logical RU type within a tone mapping bandwidth, a correspondence between a logical tone index of each logical RU and a physical tone index of the logical RU is obtained according to the foregoing four-step mapping approach. A specific logical RU is constructed based on the tone mapping bandwidth, the logical RU type, a logical tone index of a logical RU, a physical tone index of a logical RU, punctured channel information, and the like.

In Example 13, Table 3 to Table 7 respectively indicate the construction of a logical RU within bandwidths of 20 MHz, 40 MHz, 80 MHz, 160 MHz, and 320 MHz.

TABLE 3
Construction of a logical RU within a bandwidth of 20 MHz

| | | Logical tone | |
|---|---|---|---|
| Logical | Logical | index of a | |
| RU type | RU index | logical RU | Physical tone index of a logical RU |
| 26-tone | RU 1 | [−121:−96] | [−121, −112, −103, 94, −85, −76, −66, −57, −48, −39, −30, |
| RU | | | −21, −12, 4, 13, 22, 31, 40, 49, 58, 67, 77, 86, 95, 104, 113] |
| | RU 2 | [−95:−70] | [−120, −111, −102, −93, −84, −75, −65, −56, −47, −38, −29, |
| | | | −20, −11, 5, 14, 23, 32, 41, 50, 59, 68, 78, 87, 96, 105, 114] |
| | RU 3 | [−68:−43] | [−119, −110, −101, −92, −83, −74, −64, −55, −46, −37, −28, |
| | | | −19, −10, 6, 15, 24, 33, 42, 51, 60, 70, 79, 88, 97, 106, 115] |
| | RU 4 | [−42:−17] | [−118, −109, −100, −91, −82, −73, −63, −54, −45, −36, −27, |
| | | | −18, −9, 7, 16, 25, 34, 43, 52, 61, 71, 80, 89, 98, 107, 116] |
| | RU 5 | [−16:−4, 4:16] | [−117, −108, −99, −90, −81, −72, −62, −53, −44, −35, −26, |
| | | | −17, −8, 8, 17, 26, 35, 44, 53, 62, 72, 81, 90, 99, 108, 117] |
| | RU 6 | [17:42] | [−116, −107, −98, −89, −80, −71, −61, −52, −43, −34, −25, |
| | | | −16, −7, 9, 18, 27, 36, 45, 54, 63, 73, 82, 91, 100, 109, 118] |
| | RU 7 | [43:68] | [−115, −106, −97, −88, −79, −70, −60, −51, −42, −33, −24, |
| | | | −15, −6, 10, 19, 28, 37, 46, 55, 64, 74, 83, 92, 101, 110, 119] |
| | RU 8 | [70:95] | [−114, −105, −96, −87, −78, −68, −59, −50, −41, −32, −23, |
| | | | −14, −5, 11, 20, 29, 38, 47, 56, 65, 75, 84, 93, 102, 111, 120] |
| | RU 9 | [96:121] | [−113, −104, −95, −86, −77, −67, −58, −49, −40, −31, −22, |
| | | | −13, −4, 12, 21, 30, 39, 48, 57, 66, 76, 85, 94, 103, 112, 121] |
| 52-tone | RU 1 | [−121:−70] | [26-tone RU1, 26-tone RU2] |
| RU | RU 2 | [−68:−17] | [26-tone RU3, 26-tone RU4] |
| | RU 3 | [17:68] | [26-tone RU6, 26-tone RU7] |
| | RU 4 | [70:121] | [26-tone RU8, 26-tone RU9] |
| 106-tone | RU 1 | [−122:−17] | [−122, 26-tone RU1, 26-tone RU2, −69, 26-tone RU3, 26-tone RU4] |
| RU | RU 2 | [17:122] | [26-tone RU6, 26-tone RU7, 69, 26-tone RU8, 26-tone RU9, 122] |

Note:
An undermarked tone index indicates a tone that does not participate in the one-shot distributed tone mapping. Generally, in the examples of the present disclosure, if a logical RU type and index are referenced in a physical tone index of another logical RU in a table, a physical tone index of the logical RU referenced in the table is usually represented. For example, a physical tone index of a logical 52-tone RU 1 in Table 3 includes a 26-tone RU 1, and the 26-tone RU 1 represents physical tone indexes [−121, −112, −103, 94, −85, −76, −66, −57, −48, −39, −30, −21, −12, 4, 13, 22, 31, 40, 49, 58, 67, 77, 86, 95, 104, 113] of the 26-tone RU 1 in Table 3.

TABLE 4
Construction of a logical RU within a bandwidth of 40 MHz

| | | Logical tone | |
|---|---|---|---|
| Logical | Logical | index of a | |
| RU type | RU index | logical RU | Physical tone index of a logical RU |
| 26-tone | RU 1 | [−243:−218] | [−243, −225, −207, −187, −169, −151, −132, −114, −95, −77, −59, −39, −21, 4, |
| RU | | | 22, 40, 60, 78, 96, 115, 133, 152, 170, 188, 208, 226] |
| | RU 2 | [−217:−192] | [−242, −224, −206, −186, −168, −150, −131, −113, −94, −76, −58, −38, −20, 5, |
| | | | 23, 41, 61, 79, 97, 116, 134, 153, 171, 189, 209, 227] |
| | RU 3 | [−189:−164] | [−241, −223, −205, −185, −167, −149, −130, −112, −93, −75, −55, −37, −19, 6, |
| | | | 24, 42, 62, 80, 98, 117, 135, 154, 172, 192, 210, 228] |
| | RU 4 | [−163:−138] | [−240, −222, −204, −184, −166, −148, −129, −111, −92, −74, −54, −36, −18, 7, |
| | | | 25, 43, 63, 81, 99, 118, 136, 155, 173, 193, 211, 229] |
| | RU 5 | [−136:−111] | [−239, −221, −203, −183, −165, −147, −128, −109, −91, −73, −53, −35, −17, 8, |
| | | | 26, 44, 64, 82, 100, 119, 138, 156, 174, 194, 212, 230] |
| | RU 6 | [−109:−84] | [−238, −220, −202, −182, −164, −146, −127, −108, −90, −72, −52, −34, −16, 9, |
| | | | 27, 45, 65, 83, 101, 120, 139, 157, 175, 195, 213, 231] |
| | RU 7 | [−83:−58] | [−237, −219, −201, −181, −163, −145, −126, −107, −89, −71, −51, −33, −15, |
| | | | 10, 28, 46, 66, 84, 102, 121, 140, 158, 176, 196, 214, 232] |
| | RU 8 | [−55:−30] | [−236, −218, −200, −180, −162, −144, −125, −106, −88, −70, −50, −32, −14, |
| | | | 11, 29, 47, 67, 85, 103, 122, 141, 159, 177, 197, 215, 233] |
| | RU 9 | [−29:−4] | [−235, −217, −199, −179, −161, −143, −124, −105, −87, −69, −49, −31, −13, |
| | | | 12, 30, 48, 68, 86, 104, 123, 142, 160, 178, 198, 216, 234] |
| | RU 10 | [4:29] | [−234, −216, −198, −178, −160, −142, −123, −104, −86, −68, −48, −30, −12, |
| | | | 13, 31, 49, 69, 87, 105, 124, 143, 161, 179, 199, 217, 235] |
| | RU 11 | [30:55] | [−233, −215, −197, −177, −159, −141, −122, −103, −85, −67, −47, −29, −11, |
| | | | 14, 32, 50, 70, 88, 106, 125, 144, 162, 180, 200, 218, 236] |
| | RU 12 | [58:83] | [−232, −214, −196, −176, −158, −140, −121, −102, −84, −66, −46, −28, −10, |
| | | | 15, 33, 51, 71, 89, 107, 126, 145, 163, 181, 201, 219, 237] |
| | RU 13 | [84:109] | [−231, −213, −195, −175, −157, −139, −120, −101, −83, −65, −45, −27, −9, 16, |
| | | | 34, 52, 72, 90, 108, 127, 146, 164, 182, 202, 220, 238] |
| | RU 14 | [111:136] | [−230, −212, −194, −174, −156, −138, −119, −100, −82, −64, −44, −26, −8, 17, |
| | | | 35, 53, 73, 91, 109, 128, 147, 165, 183, 203, 221, 239] |
| | RU 15 | [138:163] | [−229, −211, −193, −173, −155, −136, −118, −99, −81, −63, −43, −25, −7, 18, |
| | | | 36, 54, 74, 92, 111, 129, 148, 166, 184, 204, 222, 240] |
| | RU 16 | [164:189] | [−228, −210, −192, −172, −154, −135, −117, −98, −80, −62, −42, −24, −6, 19, |
| | | | 37, 55, 75, 93, 112, 130, 149, 167, 185, 205, 223, 241] |
| | RU 17 | [192:217] | [−227, −209, −189, −171, −153, −134, −116, −97, −79, −61, −41, −23, −5, 20, |
| | | | 38, 58, 76, 94, 113, 131, 150, 168, 186, 206, 224, 242] |
| | RU 18 | [218:243 | [−226, −208, −188, −170, −152, −133, −115, −96, −78, −60, −40, −22, −4, 21, |
| | | | 39, 59, 77, 95, 114, 132, 151, 169, 187, 207, 225, 243] |
| 52-tone | RU 1 | [−243:−192] | [26-tone RU1, 26-tone RU2] |
| RU | RU 2 | [−189:−138] | [26-tone RU3, 26-tone RU4] |
| | RU 3 | [−109:−58] | [26-tone RU6, 26-tone RU7] |
| | RU 4 | [−55:−4] | [26-tone RU8, 26-tone RU9] |
| | RU 5 | [4:55] | [26-tone RU10, 26-tone RU11] |
| | RU 6 | [58:109] | [26-tone RU12, 26-tone RU13] |
| | RU 7 | [138:189] | [26-tone RU15, 26-tone RU16] |
| | RU 8 | [192:243] | [26-tone RU17, 26-tone RU18] |
| 106-tone | RU 1 | [−243:−138] | [26-tone RU1, 26-tone RU2, −191, −190, 26-tone RU3, 26-tone RU4] |
| RU | RU 2 | [−109:−4] | [26-tone RU6, 26-tone RU7, −57, −56, 26-tone RU8, 26-tone RU9] |
| | RU 3 | [4:109] | [26-tone RU10, 26-tone RU11, 56, 57, 26-tone RU12, 26-tone RU13] |
| | RU 4 | [138:243] | [26-tone RU15, 26-tone RU16, 190, 191, 26-tone RU17, 26-tone RU18] |
| 242-tone | RU 1 | [−244:−3] | [−244, 26-tone RU1, 26-tone RU2, −191, −190, 26-tone RU3, 26-tone |
| RU | | | RU4, −137, 26-tone RU 5, −110, 26-tone RU6, 26-tone RU7, −57, −56, |
| | | | 26-tone RU8, 26-tone RU9, −3] |
| | RU 2 | [3:244] | [3, 26-tone RU10, 26-tone RU11, 56, 57, 26-tone RU12, 26-tone RU13, |
| | | | 110, 26-tone RU 14, 137, 26-tone RU15, 26-tone RU16, 190, 191, |
| | | | 26-tone RU17, 26-tone RU18, 244] |

Note:
An undermarked tone index indicates a tone that does not participate in the one-shot distributed tone mapping.

TABLE 5
Construction of a logical RU within a bandwidth of 80 MHz

| | | Logical tone | |
|---|---|---|---|
| Logical | Logical | index of a | |
| RU type | RU index | logical RU | Physical tone index of a logical RU |
| 26-tone | RU 1 | [−499:−474] | [−499, −463, −425, −388, −351, −315, −277, −234, −196, −160, −123, |
| RU | | | −86, −48, 13, 49, 87, 124, 161, 197, 235, 278, 316, 352, 389, 426, 464] |
| | RU 2 | [−473:−448] | [−498, −462, −424, −387, −350, −314, −276, −233, −195, −159, −122, |
| | | | −85, −47, 14, 50, 88, 125, 162, 198, 236, 279, 317, 353, 390, 427, 465] |
| | RU 3 | [−445:−420] | [−497, −461, −423, −386, −349, −311, −275, −232, −194, −158, −121, |
| | | | −84, −46, 15, 51, 89, 126, 163, 201, 237, 280, 318, 354, 391, 428, 466] |
| | RU 4 | [−419:−394] | [−496, −460, −422, −385, −348, −310, −274, −231, −193, −157, −120, |
| | | | −83, −45, 16, 52, 90, 127, 164, 202, 238, 281, 319, 355, 392, 429, 467] |
| | RU 5 | [−392:−367] | [−495, −459, −421, −384, −347, −309, −273, −230, −192, −156, −118, |
| | | | −82, −44, 17, 53, 91, 128, 165, 203, 239, 282, 320, 356, 394, 430, 468] |
| | RU 6 | [−365:−340] | [−494, −458, −420, −383, −346, −308, −272, −229, −191, −155, −117, |
| | | | −81, −43, 18, 54, 92, 129, 166, 204, 240, 283, 321, 357, 395, 431, 469] |
| | RU 7 | [−339:−314] | [−493, −457, −419, −382, −345, −307, −271, −228, −190, −154, −116, |
| | | | −80, −42, 19, 55, 93, 130, 167, 205, 241, 284, 322, 358, 396, 432, 470] |
| | RU 8 | [−311:−286] | [−492, −456, −418, −381, −344, −306, −270, −227, −189, −153, −115, |
| | | | −79, −41, 20, 56, 94, 131, 168, 206, 242, 285, 323, 359, 397, 433, 471] |
| | RU 9 | [−285:−260] | [−491, −455, −417, −380, −343, −305, −269, −226, −188, −152, −114, |
| | | | −78, −40, 21, 57, 95, 132, 169, 207, 243, 286, 324, 360, 398, 434, 472] |
| | RU 10 | [−252:−227] | [−490, −454, −416, −379, −342, −304, −268, −225, −187, −151, −113, |
| | | | −77, −39, 22, 58, 96, 133, 170, 208, 244, 287, 325, 361, 399, 435, 473] |
| | RU 11 | [−226:−201] | [−489, −453, −415, −378, −341, −303, −267, −224, −186, −150, −112, |
| | | | −76, −38, 23, 59, 97, 134, 171, 209, 245, 288, 326, 362, 400, 436, 474] |
| | RU 12 | [−198:−173] | [−488, −452, −414, −377, −340, −302, −266, −223, −185, −149, −111, |
| | | | −75, −37, 24, 60, 98, 135, 172, 210, 246, 289, 327, 363, 401, 437, 475] |
| | RU 13 | [−172:−147] | [−487, −451, −413, −376, −339, −301, −265, −222, −184, −148, −110, |
| | | | −74, −36, 25, 61, 99, 136, 173, 211, 247, 290, 328, 364, 402, 438, 476] |
| | RU 14 | [−145:−120] | [−486, −450, −412, −375, −338, −300, −264, −221, −183, −147, −109, |
| | | | −73, −35, 26, 62, 100, 137, 174, 212, 248, 291, 329, 365, 403, 439, 477] |
| | RU 15 | [−118:−93] | [−485, −449, −411, −374, −337, −299, −263, −220, −182, −145, −108, |
| | | | −72, −34, 27, 63, 101, 138, 175, 213, 249, 292, 330, 367, 404, 440, 478] |
| | RU 16 | [−92:−67] | [−484, −448, −410, −373, −336, −298, −262, −219, −181, −144, −107, |
| | | | −71, −33, 28, 64, 102, 139, 176, 214, 250, 293, 331, 368, 405, 441, 479] |
| | RU 17 | [−64:−39] | [−483, −445, −409, −372, −335, −297, −261, −218, −180, −143, −106, |
| | | | −70, −32, 29, 67, 103, 140, 177, 215, 251, 294, 332, 369, 406, 442, 480] |
| | RU 18 | [−38:−13] | [−482, −444, −408, −371, −334, −296, −260, −217, −179, −142, −105, |
| | | | −69, −31, 30, 68, 104, 141, 178, 216, 252, 295, 333, 370, 407, 443, 481] |
| | RU 19 | [not defined] | |
| | RU 20 | [13:38] | [−481, −443, −407, −370, −333, −295, −252, −216, −178, −141, −104, |
| | | | −68, −30, 31, 69, 105, 142, 179, 217, 260, 296, 334, 371, 408, 444, 482] |
| | RU 21 | [39:64] | [−480, −442, −406, −369, −332, −294, −251, −215, −177, −140, −103, |
| | | | −67, −29, 32, 70, 106, 143, 180, 218, 261, 297, 335, 372, 409, 445, 483] |
| | RU 22 | [67:92] | [−479, −441, −405, −368, −331, −293, −250, −214, −176, −139, −102, |
| | | | −64, −28, 33, 71, 107, 144, 181, 219, 262, 298, 336, 373, 410, 448, 484] |
| | RU 23 | [93:118] | [−478, −440, −404, −367, −330, −292, −249, −213, −175, −138, −101, |
| | | | −63, −27, 34, 72, 108, 145, 182, 220, 263, 299, 337, 374, 411, 449, 485] |
| | RU 24 | [120:145] | [−477, −439, −403, −365, −329, −291, −248, −212, −174, −137, −100, |
| | | | −62, −26, 35, 73, 109, 147, 183, 221, 264, 300, 338, 375, 412, 450, 486] |
| | RU 25 | [147:172] | [−476, −438, −402, −364, −328, −290, −247, −211, −173, −136, −99, −61, |
| | | | −25, 36, 74, 110, 148, 184, 222, 265, 301, 339, 376, 413, 451, 487] |
| | RU 26 | [173:198] | [−475, −437, −401, −363, −327, −289, −246, −210, −172, −135, −98, −60, |
| | | | −24, 37, 75, 111, 149, 185, 223, 266, 302, 340, 377, 414, 452, 488] |
| | RU 27 | [201:226] | [−474, −436, −400, −362, −326, −288, −245, −209, −171, −134, −97, −59, |
| | | | −23, 38, 76, 112, 150, 186, 224, 267, 303, 341, 378, 415, 453, 489] |
| | RU 28 | [227:252] | [−473, −435, −399, −361, −325, −287, −244, −208, −170, −133, −96, −58, |
| | | | −22, 39, 77, 113, 151, 187, 225, 268, 304, 342, 379, 416, 454, 490] |
| | RU 29 | [260:285] | [−472, −434, −398, −360, −324, −286, −243, −207, −169, −132, −95, −57, |
| | | | −21, 40, 78, 114, 152, 188, 226, 269, 305, 343, 380, 417, 455, 491] |
| | RU 30 | [286:311] | [−471, −433, −397, −359, −323, −285, −242, −206, −168, −131, −94, −56, |
| | | | −20, 41, 79, 115, 153, 189, 227, 270, 306, 344, 381, 418, 456, 492] |
| | RU 31 | [314:339] | [−470, −432, −396, −358, −322, −284, −241, −205, −167, −130, −93, −55, |
| | | | −19, 42, 80, 116, 154, 190, 228, 271, 307, 345, 382, 419, 457, 493] |
| | RU 32 | [340:365] | [−469, −431, −395, −357, −321, −283, −240, −204, −166, −129, −92, −54, |
| | | | −18, 43, 81, 117, 155, 191, 229, 272, 308, 346, 383, 420, 458, 494] |
| | RU 33 | [367:392] | [−468, −430, −394, −356, −320, −282, −239, −203, −165, −128, −91, −53, |
| | | | −17, 44, 82, 118, 156, 192, 230, 273, 309, 347, 384, 421, 459, 495] |
| | RU 34 | [394:419] | [−467, −429, −392, −355, −319, −281, −238, −202, −164, −127, −90, −52, |
| | | | −16, 45, 83, 120, 157, 193, 231, 274, 310, 348, 385, 422, 460, 496] |
| | RU 35 | [420:445] | [−466, −428, −391, −354, −318, −280, −237, −201, −163, −126, −89, −51, |
| | | | −15, 46, 84, 121, 158, 194, 232, 275, 311, 349, 386, 423, 461, 497] |
| | RU 36 | [448:473] | [−465, −427, −390, −353, −317, −279, −236, −198, −162, −125, −88, −50, |
| | | | −14, 47, 85, 122, 159, 195, 233, 276, 314, 350, 387, 424, 462, 498] |
| | RU 37 | [474:499] | [−464, −426, −389, −352, −316, −278, −235, −197, −161, −124, −87, −49, |
| | | | −13, 48, 86, 123, 160, 196, 234, 277, 315, 351, 388, 425, 463, 499] |
| 52-tone | RU 1 | [−499:−448] | [26-tone RU1, 26-tone RU2] |
| RU | RU 2 | [−445:−394] | [26-tone RU3, 26-tone RU4] |
| | RU 3 | [−365:−314] | [26-tone RU6, 26-tone RU7] |
| | RU 4 | [−311:−260] | [26-tone RU8, 26-tone RU9] |
| | RU 5 | [−252:−201] | [26-tone RU10, 26-tone RU11] |
| | RU 6 | [−198:−147] | [26-tone RU12, 26-tone RU13] |
| | RU 7 | [−118:−67] | [26-tone RU15, 26-tone RU16] |
| | RU 8 | [−64:−13] | [26-tone RU17, 26-tone RU18] |
| | RU 9 | [13:64] | [26-tone RU20, 26-tone RU21] |
| | RU 10 | [67:118] | [26-tone RU22, 26-tone RU23] |
| | RU 11 | [147:198] | [26-tone RU25, 26-tone RU26] |
| | RU 12 | [201:252] | [26-tone RU27, 26-tone RU28] |
| | RU 13 | [260:311] | [26-tone RU29, 26-tone RU30] |
| | RU 14 | [314:365] | [26-tone RU31, 26-tone RU32] |
| | RU 15 | [394:445] | [26-tone RU34, 26-tone RU35] |
| | RU 16 | [448:499] | [26-tone RU36, 26-tone RU37] |
| 106-tone | RU 1 | [−499:−394] | [26-tone RU1, 26-tone RU2, −447, −446, 26-tone RU3, 26-tone RU4] |
| RU | RU 2 | [−365:−260] | [26-tone RU6, 26-tone RU7, −313, −312, 26-tone RU8, 26-tone RU9] |
| | RU 3 | [−252:−147] | [26-tone RU10, 26-tone RU11, −200, −199, 26-tone RU12, 26-tone RU13] |
| | RU 4 | [−118:−13] | [26-tone RU15, 26-tone RU16, −66, −65, 26-tone RU17, 26-tone RU18] |
| | RU 5 | [13:118] | [26-tone RU20, 26-tone RU21, 65, 66, 26-tone RU22, 26-tone RU23] |
| | RU 6 | [147:252] | [26-tone RU25, 26-tone RU26, 199, 200, 26-tone RU27, 26-tone RU28] |
| | RU 7 | [260:365] | [26-tone RU29, 26-tone RU30, 312, 313, 26-tone RU31, 26-tone RU32] |
| | RU 8 | [394:499] | [26-tone RU34, 26-tone RU35, 446, 447, 26-tone RU36, 26-tone RU37] |
| 242-tone | RU 1 | [−500:−259] | [−500, 26-tone RU1, 26-tone RU2, −447, −446, 26-tone RU3, 26-tone RU4, |
| RU | | | −393, 26-tone RU 5, −366, 26-tone RU6, 26-tone RU7, −313, −312, 26-tone |
| | | | RU8, 26-tone RU9, −259] |
| | RU 2 | [−253:−12] | [−253, 26-tone RU10, 26-tone RU11, −200, −199, 26-tone RU12, 26-tone |
| | | | RU13, −146, 26-tone RU14, −119, 26-tone RU15, 26-tone RU16, −66, −65, |
| | | | 26-tone RU17, 26-tone RU18, −12] |
| | RU 3 | [12:253] | [12, 26-tone RU20, 26-tone RU21, 65, 66, 26-tone RU22, 26-tone RU23, |
| | | | 119, 26-tone RU24, 146, 26-tone RU25, 26-tone RU26, 199, 200, 26-tone |
| | | | RU27, 26-tone RU28, 253] |
| | RU 4 | [259:500] | [259, 26-tone RU29, 26-tone RU30, 312, 313, 26-tone RU31, 26-tone |
| | | | RU32, 366, 26-tone RU 33, 393, 26-tone RU34, 26-tone RU35, 446, 447, |
| | | | 26-tone RU36, 26-tone RU37, 500] |
| 484-tone | RU 1 | [−500:−259, | [−500, 26-tone RU1, 26-tone RU2, −447, −446, 26-tone RU3, 26-tone RU4, |
| RU | | −253:−12] | −393, 26-tone RU 5, −366, 26-tone RU6, 26-tone RU7, −313, −312, 26-tone |
| | | | RU8, 26-tone RU9, −259, −253, 26-tone RU10, 26-tone RU11, −200, −199, |
| | | | 26-tone RU12, 26-tone RU13, −146, 26-tone RU14, −119, 26-tone RU15, |
| | | | 26-tone RU16, −66, −65, 26-tone RU17, 26-tone RU18, −12] |
| | RU 2 | [12:253, | [12, 26-tone RU20, 26-tone RU21, 65, 66, 26-tone RU22, 26-tone RU23, |
| | | 259:500] | 119, 26-tone RU24, 146, 26-tone RU25, 26-tone RU26, 199, 200, 26-tone |
| | | | RU27, 26-tone RU28, 253, 259, 26-tone RU29, 26-tone RU30, 312, 313, |
| | | | 26-tone RU31, 26-tone RU32, 366, 26-tone RU 33, 393, 26-tone RU34, |
| | | | 26-tone RU35, 446, 447, 26-tone RU36, 26-tone RU37, 500] |

Note:
An undermarked tone index indicates a tone that does not participate in the one-shot distributed tone mapping.

TABLE 6
Construction of a logical RU within a bandwidth of 160 MHz

| | | Logical tone | |
|---|---|---|---|
| Logical | Logical | index of a | |
| RU type | RU index | logical RU | Physical tone index of a logical RU |
| 26-tone | RU 1 | [−1011:−986] | [−1011, −937, −863, −789, −708, −635, −560, −463, −388, −315, −234, −160, |
| RU | | | −86, 13, 87, 161, 235, 316, 389, 464, 561, 636, 709, 790, 864, 938] |
| | RU 2 | [−985:−960] | [−1010, −936, −862, −788, −707, −634, −559, −462, −387, −314, −233, −159, |
| | | | −85, 14, 88, 162, 236, 317, 390, 465, 562, 637, 710, 791, 865, 939] |
| | RU 3 | [−957:−932] | [−1009, −935, −861, −787, −706, −633, −558, −461, −386, −311, −232, −158, |
| | | | −84, 15, 89, 163, 237, 318, 391, 466, 563, 638, 713, 792, 866, 940] |
| | RU 4 | [−931:−906] | [−1008, −934, −860, −786, −705, −632, −557, −460, −385, −310, −231, −157, |
| | | | −83, 16, 90, 164, 238, 319, 392, 467, 564, 639, 714, 793, 867, 941] |
| | RU 5 | [−904:−879] | [−1007, −933, −859, −785, −704, −630, −556, −459, −384, −309, −230, −156, |
| | | | −82, 17, 91, 165, 239, 320, 394, 468, 565, 640, 715, 794, 868, 942] |
| | RU 6 | [−877:−852] | [−1006, −932, −858, −784, −703, −629, −555, −458, −383, −308, −229, −155, |
| | | | −81, 18, 92, 166, 240, 321, 395, 469, 566, 641, 716, 795, 869, 943] |
| | RU 7 | [−851:−826] | [−1005, −931, −857, −783, −702, −628, −554, −457, −382, −307, −228, −154, |
| | | | −80, 19, 93, 167, 241, 322, 396, 470, 567, 642, 717, 796, 870, 944] |
| | RU 8 | [−823:−798] | [−1004, −930, −856, −782, −701, −627, −553, −456, −381, −306, −227, −153, |
| | | | −79, 20, 94, 168, 242, 323, 397, 471, 568, 643, 718, 797, 871, 945] |
| | RU 9 | [−797:−772] | [−1003, −929, −855, −781, −700, −626, −552, −455, −380, −305, −226, −152, |
| | | | −78, 21, 95, 169, 243, 324, 398, 472, 569, 644, 719, 798, 872, 946] |
| | RU 10 | [−764:−739] | [−1002, −928, −854, −780, −699, −625, −551, −454, −379, −304, −225, −151, |
| | | | −77, 22, 96, 170, 244, 325, 399, 473, 570, 645, 720, 799, 873, 947] |
| | RU 11 | [−738:−713] | [−1001, −927, −853, −779, −698, −624, −550, −453, −378, −303, −224, −150, |
| | | | −76, 23, 97, 171, 245, 326, 400, 474, 571, 646, 721, 800, 874, 948] |
| | RU 12 | [−710:−685] | [−1000, −926, −852, −778, −697, −623, −549, −452, −377, −302, −223, −149, |
| | | | −75, 24, 98, 172, 246, 327, 401, 475, 572, 647, 722, 801, 875, 949] |
| | RU 13 | [−684:−659] | [−999, −925, −851, −777, −696, −622, −548, −451, −376, −301, −222, −148, |
| | | | −74, 25, 99, 173, 247, 328, 402, 476, 573, 648, 723, 802, 876, 950] |
| | RU 14 | [−657:−632] | [−998, −924, −850, −776, −695, −621, −547, −450, −375, −300, −221, −147, |
| | | | −73, 26, 100, 174, 248, 329, 403, 477, 574, 649, 724, 803, 877, 951] |
| | RU 15 | [−630:−605] | [−997, −923, −849, −775, −694, −620, −546, −449, −374, −299, −220, −145, |
| | | | −72, 27, 101, 175, 249, 330, 404, 478, 575, 650, 725, 804, 879, 952] |
| | RU 16 | [−604:−579] | [−996, −922, −848, −774, −693, −619, −545, −448, −373, −298, −219, −144, |
| | | | −71, 28, 102, 176, 250, 331, 405, 479, 576, 651, 726, 805, 880, 953] |
| | RU 17 | [−576:−551] | [−995, −921, −847, −773, −692, −618, −544, −445, −372, −297, −218, −143, |
| | | | −70, 29, 103, 177, 251, 332, 406, 480, 579, 652, 727, 806, 881, 954] |
| | RU 18 | [−550:−525] | [−994, −920, −846, −772, −691, −617, −543, −444, −371, −296, −217, −142, |
| | | | −69, 30, 104, 178, 252, 333, 407, 481, 580, 653, 728, 807, 882, 955] |
| | RU 19 | [not defined] | |
| | RU 20 | [−499:−474] | [−993, −919, −845, −764, −690, −616, −542, −443, −370, −295, −216, −141, |
| | | | −68, 31, 105, 179, 260, 334, 408, 482, 581, 654, 729, 808, 883, 956] |
| | RU 21 | [−473:−448] | [−992, −918, −844, −763, −689, −615, −541, −442, −369, −294, −215, −140, |
| | | | −67, 32, 106, 180, 261, 335, 409, 483, 582, 655, 730, 809, 884, 957] |
| | RU 22 | [−445:−420] | [−991, −917, −843, −762, −688, −614, −540, −441, −368, −293, −214, −139, |
| | | | −64, 33, 107, 181, 262, 336, 410, 484, 583, 656, 731, 810, 885, 960] |
| | RU 23 | [−419:−394] | [−990, −916, −842, −761, −687, −613, −539, −440, −367, −292, −213, −138, |
| | | | −63, 34, 108, 182, 263, 337, 411, 485, 584, 657, 732, 811, 886, 961] |
| | RU 24 | [−392:−367] | [−989, −915, −841, −760, −686, −612, −538, −439, −365, −291, −212, −137, |
| | | | −62, 35, 109, 183, 264, 338, 412, 486, 585, 659, 733, 812, 887, 962] |
| | RU 25 | [−365:−340] | [−988, −914, −840, −759, −685, −611, −537, −438, −364, −290, −211, −136, |
| | | | −61, 36, 110, 184, 265, 339, 413, 487, 586, 660, 734, 813, 888, 963] |
| | RU 26 | [−339:−314] | [−987, −913, −839, −758, −684, −610, −536, −437, −363, −289, −210, −135, |
| | | | −60, 37, 111, 185, 266, 340, 414, 488, 587, 661, 735, 814, 889, 964] |
| | RU 27 | [−311:−286] | [−986, −912, −838, −757, −683, −609, −535, −436, −362, −288, −209, −134, |
| | | | −59, 38, 112, 186, 267, 341, 415, 489, 588, 662, 736, 815, 890, 965] |
| | RU 28 | [−285:−260] | [−985, −911, −837, −756, −682, −608, −534, −435, −361, −287, −208, −133, |
| | | | −58, 39, 113, 187, 268, 342, 416, 490, 589, 663, 737, 816, 891, 966] |
| | RU 29 | [−252:−227] | [−984, −910, −836, −755, −681, −607, −533, −434, −360, −286, −207, −132, |
| | | | −57, 40, 114, 188, 269, 343, 417, 491, 590, 664, 738, 817, 892, 967] |
| | RU 30 | [−226:−201] | [−983, −909, −835, −754, −680, −606, −532, −433, −359, −285, −206, −131, |
| | | | −56, 41, 115, 189, 270, 344, 418, 492, 591, 665, 739, 818, 893, 968] |
| | RU 31 | [−198:−173] | [−982, −908, −834, −753, −679, −605, −531, −432, −358, −284, −205, −130, |
| | | | −55, 42, 116, 190, 271, 345, 419, 493, 592, 666, 740, 819, 894, 969] |
| | RU 32 | [−172:−147] | [−981, −907, −833, −752, −678, −604, −530, −431, −357, −283, −204, −129, |
| | | | −54, 43, 117, 191, 272, 346, 420, 494, 593, 667, 741, 820, 895, 970] |
| | RU 33 | [−145:−120] | [−980, −906, −832, −751, −677, −603, −529, −430, −356, −282, −203, −128, |
| | | | −53, 44, 118, 192, 273, 347, 421, 495, 594, 668, 742, 821, 896, 971] |
| | RU 34 | [−118:−93] | [−979, −904, −831, −750, −676, −602, −528, −429, −355, −281, −202, −127, |
| | | | −52, 45, 120, 193, 274, 348, 422, 496, 595, 669, 743, 822, 897, 972] |
| | RU 35 | [−92:−67] | [−978, −903, −830, −749, −675, −601, −527, −428, −354, −280, −201, −126, |
| | | | −51, 46, 121, 194, 275, 349, 423, 497, 596, 670, 744, 823, 898, 973] |
| | RU 36 | [−64:−39] | [−977, −902, −829, −748, −674, −600, −526, −427, −353, −279, −198, −125, |
| | | | −50, 47, 122, 195, 276, 350, 424, 498, 597, 671, 745, 826, 899, 974] |
| | RU 37 | [−38:−13] | [−976, −901, −828, −747, −673, −599, −525, −426, −352, −278, −197, −124, |
| | | | −49, 48, 123, 196, 277, 351, 425, 499, 598, 672, 746, 827, 900, 975] |
| | RU 38 | [13:38] | [−975, −900, −827, −746, −672, −598, −499, −425, −351, −277, −196, −123, |
| | | | −48, 49, 124, 197, 278, 352, 426, 525, 599, 673, 747, 828, 901, 976] |
| | RU 39 | [39:64] | [−974, −899, −826, −745, −671, −597, −498, −424, −350, −276, −195, −122, |
| | | | −47, 50, 125, 198, 279, 353, 427, 526, 600, 674, 748, 829, 902, 977] |
| | RU 40 | [67:92] | [−973, −898, −823, −744, −670, −596, −497, −423, −349, −275, −194, −121, |
| | | | −46, 51, 126, 201, 280, 354, 428, 527, 601, 675, 749, 830, 903, 978] |
| | RU 41 | [93:118] | [−972, −897, −822, −743, −669, −595, −496, −422, −348, −274, −193, −120, |
| | | | −45, 52, 127, 202, 281, 355, 429, 528, 602, 676, 750, 831, 904, 979] |
| | RU 42 | [120:145] | [−971, −896, −821, −742, −668, −594, −495, −421, −347, −273, −192, −118, |
| | | | −44, 53, 128, 203, 282, 356, 430, 529, 603, 677, 751, 832, 906, 980] |
| | RU 43 | [147:172] | [−970, −895, −820, −741, −667, −593, −494, −420, −346, −272, −191, −117, |
| | | | −43, 54, 129, 204, 283, 357, 431, 530, 604, 678, 752, 833, 907, 981] |
| | RU 44 | [173:198] | [−969, −894, −819, −740, −666, −592, −493, −419, −345, −271, −190, −116, |
| | | | −42, 55, 130, 205, 284, 358, 432, 531, 605, 679, 753, 834, 908, 982] |
| | RU 45 | [201:226] | [−968, −893, −818, −739, −665, −591, −492, −418, −344, −270, −189, −115, |
| | | | −41, 56, 131, 206, 285, 359, 433, 532, 606, 680, 754, 835, 909, 983] |
| | RU 46 | [227:252] | [−967, −892, −817, −738, −664, −590, −491, −417, −343, −269, −188, −114, |
| | | | −40, 57, 132, 207, 286, 360, 434, 533, 607, 681, 755, 836, 910, 984] |
| | RU 47 | [260:285] | [−966, −891, −816, −737, −663, −589, −490, −416, −342, −268, −187, −113, |
| | | | −39, 58, 133, 208, 287, 361, 435, 534, 608, 682, 756, 837, 911, 985] |
| | RU 48 | [286:311] | [−965, −890, −815, −736, −662, −588, −489, −415, −341, −267, −186, −112, |
| | | | −38, 59, 134, 209, 288, 362, 436, 535, 609, 683, 757, 838, 912, 986] |
| | RU 49 | [314:339] | [−964, −889, −814, −735, −661, −587, −488, −414, −340, −266, −185, −111, |
| | | | −37, 60, 135, 210, 289, 363, 437, 536, 610, 684, 758, 839, 913, 987] |
| | RU 50 | [340:365] | [−963, −888, −813, −734, −660, −586, −487, −413, −339, −265, −184, −110, |
| | | | −36, 61, 136, 211, 290, 364, 438, 537, 611, 685, 759, 840, 914, 988] |
| | RU 51 | [367:392] | [−962, −887, −812, −733, −659, −585, −486, −412, −338, −264, −183, −109, |
| | | | −35, 62, 137, 212, 291, 365, 439, 538, 612, 686, 760, 841, 915, 989] |
| | RU 52 | [394:419] | [−961, −886, −811, −732, −657, −584, −485, −411, −337, −263, −182, −108, |
| | | | −34, 63, 138, 213, 292, 367, 440, 539, 613, 687, 761, 842, 916, 990] |
| | RU 53 | [420:445] | [−960, −885, −810, −731, −656, −583, −484, −410, −336, −262, −181, −107, |
| | | | −33, 64, 139, 214, 293, 368, 441, 540, 614, 688, 762, 843, 917, 991] |
| | RU 54 | [448:473] | [−957, −884, −809, −730, −655, −582, −483, −409, −335, −261, −180, −106, |
| | | | −32, 67, 140, 215, 294, 369, 442, 541, 615, 689, 763, 844, 918, 992] |
| | RU 55 | [474:499] | [−956, −883, −808, −729, −654, −581, −482, −408, −334, −260, −179, −105, |
| | | | −31, 68, 141, 216, 295, 370, 443, 542, 616, 690, 764, 845, 919, 993] |
| | RU 56 | [not defined] | |
| | RU 57 | [525:550] | [−955, −882, −807, −728, −653, −580, −481, −407, −333, −252, −178, −104, |
| | | | −30, 69, 142, 217, 296, 371, 444, 543, 617, 691, 772, 846, 920, 994] |
| | RU 58 | [551:576] | [−954, −881, −806, −727, −652, −579, −480, −406, −332, −251, −177, −103, |
| | | | −29, 70, 143, 218, 297, 372, 445, 544, 618, 692, 773, 847, 921, 995] |
| | RU 59 | [579:604] | [−953, −880, −805, −726, −651, −576, −479, −405, −331, −250, −176, −102, |
| | | | −28, 71, 144, 219, 298, 373, 448, 545, 619, 693, 774, 848, 922, 996] |
| | RU 60 | [605:630] | [−952, −879, −804, −725, −650, −575, −478, −404, −330, −249, −175, −101, |
| | | | −27, 72, 145, 220, 299, 374, 449, 546, 620, 694, 775, 849, 923, 997] |
| | RU 61 | [632:657] | [−951, −877, −803, −724, −649, −574, −477, −403, −329, −248, −174, −100, |
| | | | −26, 73, 147, 221, 300, 375, 450, 547, 621, 695, 776, 850, 924, 998] |
| | RU 62 | [659:684] | [−950, −876, −802, −723, −648, −573, −476, −402, −328, −247, −173, −99, |
| | | | −25, 74, 148, 222, 301, 376, 451, 548, 622, 696, 777, 851, 925, 999] |
| | RU 63 | [685:710] | [−949, −875, −801, −722, −647, −572, −475, −401, −327, −246, −172, −98, |
| | | | −24, 75, 149, 223, 302, 377, 452, 549, 623, 697, 778, 852, 926, 1000] |
| | RU 64 | [713:738] | [−948, −874, −800, −721, −646, −571, −474, −400, −326, −245, −171, −97, |
| | | | −23, 76, 150, 224, 303, 378, 453, 550, 624, 698, 779, 853, 927, 1001] |
| | RU 65 | [739:764] | [−947, −873, −799, −720, −645, −570, −473, −399, −325, −244, −170, −96, |
| | | | −22, 77, 151, 225, 304, 379, 454, 551, 625, 699, 780, 854, 928, 1002] |
| | RU 66 | [772:797] | [−946, −872, −798, −719, −644, −569, −472, −398, −324, −243, −169, −95, |
| | | | −21, 78, 152, 226, 305, 380, 455, 552, 626, 700, 781, 855, 929, 1003] |
| | RU 67 | [798:823] | [−945, −871, −797, −718, −643, −568, −471, −397, −323, −242, −168, −94, |
| | | | −20, 79, 153, 227, 306, 381, 456, 553, 627, 701, 782, 856, 930, 1004] |
| | RU 68 | [826:851] | [−944, −870, −796, −717, −642, −567, −470, −396, −322, −241, −167, −93, |
| | | | −19, 80, 154, 228, 307, 382, 457, 554, 628, 702, 783, 857, 931, 1005] |
| | RU 69 | [852:877] | [−943, −869, −795, −716, −641, −566, −469, −395, −321, −240, −166, −92, |
| | | | −18, 81, 155, 229, 308, 383, 458, 555, 629, 703, 784, 858, 932, 1006] |
| | RU 70 | [879:904] | [−942, −868, −794, −715, −640, −565, −468, −394, −320, −239, −165, −91, |
| | | | −17, 82, 156, 230, 309, 384, 459, 556, 630, 704, 785, 859, 933, 1007] |
| | RU 71 | [906:931] | [−941, −867, −793, −714, −639, −564, −467, −392, −319, −238, −164, −90, |
| | | | −16, 83, 157, 231, 310, 385, 460, 557, 632, 705, 786, 860, 934, 1008] |
| | RU 72 | [932:957] | [−940, −866, −792, −713, −638, −563, −466, −391, −318, −237, −163, −89, |
| | | | −15, 84, 158, 232, 311, 386, 461, 558, 633, 706, 787, 861, 935, 1009] |
| | RU 73 | [960:985] | [−939, −865, −791, −710, −637, −562, −465, −390, −317, −236, −162, −88, |
| | | | −14, 85, 159, 233, 314, 387, 462, 559, 634, 707, 788, 862, 936, 1010] |
| | RU 74 | [986:1011] | [−938, −864, −790, −709, −636, −561, −464, −389, −316, −235, −161, −87, |
| | | | −13, 86, 160, 234, 315, 388, 463, 560, 635, 708, 789, 863, 937, 1011] |
| 52-tone | RU 1 | [−1011:−960] | [26-tone RU1, 26-tone RU2] |
| RU | RU 2 | [−957:−906] | [26-tone RU3, 26-tone RU4] |
| | RU 3 | [−877:−826] | [26-tone RU6, 26-tone RU7] |
| | RU 4 | [−823:−772] | [26-tone RU8, 26-tone RU9] |
| | RU 5 | [−764:−713] | [26-tone RU10, 26-tone RU11] |
| | RU 6 | [−710:−659] | [26-tone RU12, 26-tone RU13] |
| | RU 7 | [−630:−579] | [26-tone RU15, 26-tone RU16] |
| | RU 8 | [−576:−525] | [26-tone RU17, 26-tone RU18] |
| | RU 9 | [−499:−448] | [26-tone RU20, 26-tone RU21] |
| | RU 10 | [−445:−394] | [26-tone RU22, 26-tone RU23] |
| | RU 11 | [−365:−314] | [26-tone RU25, 26-tone RU26] |
| | RU 12 | [−311:−260] | [26-tone RU27, 26-tone RU28] |
| | RU 13 | [−252:−201] | [26-tone RU29, 26-tone RU30] |
| | RU 14 | [−198:−147] | [26-tone RU31, 26-tone RU32] |
| | RU 15 | [−118:−67] | [26-tone RU34, 26-tone RU35] |
| | RU 16 | [−64:−13] | [26-tone RU36, 26-tone RU37] |
| | RU 17 | [13:64] | [26-tone RU38, 26-tone RU39] |
| | RU 18 | [67:118] | [26-tone RU40, 26-tone RU41] |
| | RU 19 | [147:198] | [26-tone RU43, 26-tone RU44] |
| | RU 20 | [201:252] | [26-tone RU45, 26-tone RU46] |
| | RU 21 | [260:311] | [26-tone RU47, 26-tone RU48] |
| | RU 22 | [314:365] | [26-tone RU49, 26-tone RU50] |
| | RU 23 | [394:445] | [26-tone RU52, 26-tone RU53] |
| | RU 24 | [448:499] | [26-tone RU54, 26-tone RU55] |
| | RU 25 | [525:576] | [26-tone RU57, 26-tone RU58] |
| | RU 26 | [579:630] | [26-tone RU59, 26-tone RU60] |
| | RU 27 | [659:710] | [26-tone RU62, 26-tone RU63] |
| | RU 28 | [713:764] | [26-tone RU64, 26-tone RU65] |
| | RU 29 | [772:823] | [26-tone RU66, 26-tone RU67] |
| | RU 30 | [826:877] | [26-tone RU68, 26-tone RU69] |
| | RU 31 | [906:957] | [26-tone RU71, 26-tone RU72] |
| | RU 32 | [960:1011] | [26-tone RU73, 26-tone RU74] |
| 106-tone | RU 1 | [−1011:−906] | [26-tone RU1, 26-tone RU2, −959, −958, 26-tone RU3, 26-tone RU4] |
| RU | RU 2 | [−877:−772] | [26-tone RU6, 26-tone RU7, −825, −824, 26-tone RU8, 26-tone RU9] |
| | RU 3 | [−764:−659] | [26-tone RU10, 26-tone RU11, −712, −711, 26-tone RU12, 26-tone RU13] |
| | RU 4 | [−630:−525] | [26-tone RU15, 26-tone RU16, −578, −577, 26-tone RU17, 26-tone RU18] |
| | RU 5 | [−499:−394] | [26-tone RU20, 26-tone RU21, −447, −446, 26-tone RU22, 26-tone RU23] |
| | RU 6 | [−365:−260] | [26-tone RU25, 26-tone RU26, −313, −312, 26-tone RU27, 26-tone RU28] |
| | RU 7 | [−252:−147] | [26-tone RU29, 26-tone RU30, −200, −199, 26-tone RU31, 26-tone RU32] |
| | RU 8 | [−118:−13] | [26-tone RU34, 26-tone RU35, −66, −65, 26-tone RU36, 26-tone RU37] |
| | RU 9 | [13:118] | [26-tone RU38, 26-tone RU39, 65, 66, 26-tone RU40, 26-tone RU41] |
| | RU 10 | [147:252] | [26-tone RU43, 26-tone RU44, 199, 200, 26-tone RU45, 26-tone RU46] |
| | RU 11 | [260:365] | [26-tone RU47, 26-tone RU48, 312, 313, 26-tone RU49, 26-tone RU50] |
| | RU 12 | [394:499] | [26-tone RU52, 26-tone RU53, 446, 667, 26-tone RU54, 26-tone RU55] |
| | RU 13 | [525:630] | [26-tone RU57, 26-tone RU58, 577, 578, 26-tone RU59, 26-tone RU60] |
| | RU 14 | [659:764] | [26-tone RU62, 26-tone RU63, 711, 712, 26-tone RU64, 26-tone RU65] |
| | RU 15 | [772:877] | [26-tone RU66, 26-tone RU67, 824, 825, 26-tone RU68, 26-tone RU69] |
| | RU 16 | [906:1011] | [26-tone RU71, 26-tone RU72, 958, 959, 26-tone RU73, 26-tone RU74] |
| 242-tone | RU 1 | [−1012:−771] | [−1012, 26-tone RU1, 26-tone RU2, −959, −958, 26-tone RU3, 26-tone RU4, |
| RU | | | −905, 26-tone RU5, −878, 26-tone RU6, 26-tone RU7, −825, −824, 26-tone |
| | | | RU8, 26-tone RU9, −771] |
| | RU 2 | [−765:−524] | [−765, 26-tone RU10, 26-tone RU11, −712, −711, 26-tone RU12, 26-tone |
| | | | RU13, −658, 26-tone RU14, −631, 26-tone RU15, 26-tone RU16, −578, |
| | | | −577, 26-tone RU17, 26-tone RU18, −524] |
| | RU 3 | [−500:−259] | [−500, 26-tone RU20, 26-tone RU21, −447, −446, 26-tone RU22, 26-tone |
| | | | RU23, −393, 26-tone RU24, −366, 26-tone RU25, 26-tone RU26, −313, |
| | | | −312, 26-tone RU27, 26-tone RU28, −259] |
| | RU 4 | [−253:−12] | [−253, 26-tone RU29, 26-tone RU30, −200, −199, 26-tone RU31, 26-tone |
| | | | RU32, −146, 26-tone RU33, −119, 26-tone RU34, 26-tone RU35, −66, −65, |
| | | | 26-tone RU36, 26-tone RU37, −12] |
| | RU 5 | [12:253] | [12, 26-tone RU38, 26-tone RU39, 65, 66, 26-tone RU40, 26-tone RU41, |
| | | | 119, 26-tone RU42, 146, 26-tone RU43, 26-tone RU44, 199, 200, 26-tone |
| | | | RU45, 26-tone RU46, 253] |
| | RU 6 | [259:500] | [259, 26-tone RU47, 26-tone RU48, 312, 313, 26-tone RU49, 26-tone |
| | | | RU50, 366, 26-tone RU51, 393, 26-tone RU52, 26-tone RU53, 446, 447, |
| | | | 26-tone RU54, 26-tone RU55, 500] |
| | RU 7 | [524:765] | [524, 26-tone RU57, 26-tone RU58, 577, 578, 26-tone RU59, 26-tone |
| | | | RU60, 631, 26-tone RU61, 658, 26-tone RU62, 26-tone RU63, 711, 712, |
| | | | 26-tone RU64, 26-tone RU65, 765] |
| | RU 8 | [771:1012] | [771, 26-tone RU66, 26-tone RU67, 824, 825, 26-tone RU68, 26-tone |
| | | | RU69, 878, 26-tone RU70, 905, 26-tone RU71, 26-tone RU72, 958, 959, |
| | | | 26-tone RU73, 26-tone RU74, 1012] |
| 484-tone | RU 1 | [−1012:−771, | [−1012, 26-tone RU1, 26-tone RU2, −959, −958, 26-tone RU3, 26-tone RU4, |
| RU | | −765:−524] | −905, 26-tone RU5, −878, 26-tone RU6, 26-tone RU7, −825, −824, 26-tone |
| | | | RU8, 26-tone RU9, −771, −765, 26-tone RU10, 26-tone RU11, −712, −711, |
| | | | 26-tone RU12, 26-tone RU13, −658, 26-tone RU14, −631, 26-tone |
| | | | RU15, 26-tone RU16, −578, −577, 26-tone RU17, 26-tone RU18, −524] |
| | RU 2 | [−500:−259, | [−500, 26-tone RU20, 26-tone RU21, −447, −446, 26-tone RU22, 26-tone |
| | | −253:−12] | RU23, −393, 26-tone RU24, −366, 26-tone RU25, 26-tone RU26, −313, |
| | | | −312, 26-tone RU27, 26-tone RU28, −259, −253, 26-tone RU29, 26-tone |
| | | | RU30, −200, −199, 26-tone RU31, 26-tone RU32, −146, 26-tone RU33, −119, |
| | | | 26-tone RU34, 26-tone RU35, −66, −65, 26-tone RU36, 26-tone RU37, −12] |
| | RU 3 | [12:253, | [12, 26-tone RU38, 26-tone RU39, 65, 66, 26-tone RU40, 26-tone RU41, |
| | | 259:500] | 119, 26-tone RU42, 146, 26-tone RU43, 26-tone RU44, 199, 200, 26-tone |
| | | | RU45, 26-tone RU46, 253, 259, 26-tone RU47, 26-tone RU48, 312, 313, |
| | | | 26-tone RU49, 26-tone RU50, 366, 26-tone RU51, 393, 26-tone RU52, |
| | | | 26-tone RU53, 446, 447, 26-tone RU54, 26-tone RU55, 500] |
| | RU 4 | [524:765, | [524, 26-tone RU57, 26-tone RU58, 577, 578, 26-tone RU59, 26-tone |
| | | 771:1012] | RU60, 631, 26-tone RU61, 658, 26-tone RU62, 26-tone RU63, 711, 712, |
| | | | 26-tone RU64, 26-tone RU65, 765, 771, 26-tone RU66, 26-tone RU67, |
| | | | 824, 825, 26-tone RU68, 26-tone RU69, 878, 26-tone RU70, 905, 26-tone |
| | | | RU71, 26-tone RU72, 958, 959, 26-tone RU73, 26-tone RU74, 1012] |
| 996-tone | RU 1 | [−1012:−515, | [−1012, 26-tone RU1, 26-tone RU2, −959, −958, 26-tone RU3, 26-tone RU4, |
| RU | | −509:−12] | −905, 26-tone RU5, −878, 26-tone RU6, 26-tone RU7, −825, −824, 26-tone |
| | | | RU8, 26-tone RU9, −771, −770, −769, −768, −767, −766, −765, 26-tone RU10, |
| | | | 26-tone RU11, −712, −711, 26-tone RU12, 26-tone RU13, −658, 26-tone |
| | | | RU14, −631, 26-tone RU15, 26-tone RU16, −578, −577, 26-tone RU17, 26-tone |
| | | | RU18, −524, −523, −522, −521, −520, −519, −518, −517, 516, −515, −509, |
| | | | −508, −507, −506, −505, −504, −503, −502, −501, −500, 26-tone RU20, 26-tone |
| | | | RU21, −447, −446, 26-tone RU22, 26-tone RU23, −393, 26-tone RU24, −366, |
| | | | 26-tone RU25, 26-tone RU26, −313, −312, 26-tone RU27, 26-tone |
| | | | RU28, −259, −258, −257, −256, −255, −254, −253, 26-tone RU29, 26-tone |
| | | | RU30, −200, −199, 26-tone RU31, 26-tone RU32, −146, 26-tone RU33, −119, |
| | | | 26-tone RU34, 26-tone RU35, −66, −65, 26-tone RU36, 26-tone RU37, −12] |
| | RU 2 | [12:509, | [12, 26-tone RU38, 26-tone RU39, 65, 66, 26-tone RU40, 26-tone RU41, |
| | | 515:1012] | 119, 26-tone RU42, 146, 26-tone RU43, 26-tone RU44, 199, 200, 26-tone |
| | | | RU45, 26-tone RU46, 253, 254, 255, 256, 257, 258, 259, 26-tone RU47, |
| | | | 26-tone RU48, 312, 313, 26-tone RU49, 26-tone RU50, 366, 26-tone |
| | | | RU51, 393, 26-tone RU52, 26-tone RU53, 446, 447, 26-tone RU54, 26-tone |
| | | | RU55, 500, 501, 502, 503, 504, 505, 506, 507, 508, 509, 515, 516, |
| | | | 517, 518, 519, 520, 521, 522, 523, 524, 26-tone RU57, 26-tone RU58, 577, |
| | | | 578, 26-tone RU59, 26-tone RU60, 631, 26-tone RU61, 658, 26-tone |
| | | | RU62, 26-tone RU63, 711, 712, 26-tone RU64, 26-tone RU65, 765, 766, |
| | | | 767, 768, 769, 770, 771, 26-tone RU66, 26-tone RU67, 824, 825, 26-tone |
| | | | RU68, 26-tone RU69, 878, 26-tone RU70, 905, 26-tone RU71, 26-tone |
| | | | RU72, 958, 959, 26-tone RU73, 26-tone RU74, 1012] |

Note:
An undermarked tone index indicates a tone that does not participate in the one-shot distributed tone mapping.

TABLE 7
Construction of a logical RU within a bandwidth of 320 MHz

| | | Logical tone | |
|---|---|---|---|
| Logical | Logical | index of a | |
| RU type | RU index | logical RU | Physical tone index of a logical RU |
| 26-tone | RU 1 | [−2035:−2010] | [−2035, −1887, −1732, −1584, −1412, −1258, −1110, −937, −789, −635, −463, |
| RU | | | −315, −160, 13, 161, 316, 464, 636, 790, 938, 1111, 1259, 1413, 1585, 1733, 1888] |
| | RU 2 | [−2009:−1984] | [−2034, −1886, −1731, −1583, −1411, −1257, −1109, −936, −788, −634, −462, |
| | | | −314, −159, 14, 162, 317, 465, 637, 791, 939, 1112, 1260, 1414, 1586, 1734, 1889] |
| | RU 3 | [−1981:−1956] | [−2033, −1885, −1730, −1582, −1410, −1256, −1108, −935, −787, −633, −461, |
| | | | −311, −158, 15, 163, 318, 466, 638, 792, 940, 1113, 1261, 1415, 1587, 1737, 1890] |
| | RU 4 | [−1955:−1930] | [−2032, −1884, −1729, −1581, −1409, −1255, −1107, −934, −786, −632, −460, |
| | | | −310, −157, 16, 164, 319, 467, 639, 793, 941, 1114, 1262, 1416, 1588, 1738, 1891] |
| | RU 5 | [−1928:−1903] | [−2031, −1883, −1728, −1580, −1408, −1254, −1106, −933, −785, −630, −459, |
| | | | −309, −156, 17, 165, 320, 468, 640, 794, 942, 1115, 1263, 1418, 1589, 1739, 1892] |
| | RU 6 | [−1901:−1876] | [−2030, −1882, −1727, −1579, −1407, −1253, −1105, −932, −784, −629, −458, |
| | | | −308, −155, 18, 166, 321, 469, 641, 795, 943, 1116, 1264, 1419, 1590, 1740, 1893] |
| | RU 7 | [−1875:−1850] | [−2029, −1881, −1726, −1578, −1406, −1252, −1104, −931, −783, −628, −457, |
| | | | −307, −154, 19, 167, 322, 470, 642, 796, 944, 1117, 1265, 1420, 1591, 1741, 1894] |
| | RU 8 | [−1847:−1822] | [−2028, −1880, −1725, −1577, −1405, −1251, −1103, −930, −782, −627, −456, |
| | | | −306, −153, 20, 168, 323, 471, 643, 797, 945, 1118, 1266, 1421, 1592, 1742, 1895] |
| | RU 9 | [−1821:−1796] | [−2027, −1879, −1724, −1576, −1404, −1250, −1102, −929, −781, −626, −455, |
| | | | −305, −152, 21, 169, 324, 472, 644, 798, 946, 1119, 1267, 1422, 1593, 1743, 1896] |
| | RU 10 | [−1788:−1763] | [−2026, −1878, −1723, −1575, −1403, −1249, −1101, −928, −780, −625, −454, |
| | | | −304, −151, 22, 170, 325, 473, 645, 799, 947, 1120, 1268, 1423, 1594, 1744, 1897] |
| | RU 11 | [−1762:−1737] | [−2025, −1877, −1722, −1574, −1402, −1248, −1100, −927, −779, −624, −453, |
| | | | −303, −150, 23, 171, 326, 474, 646, 800, 948, 1121, 1269, 1424, 1595, 1745, 1898] |
| | RU 12 | [−1734:−1709] | [−2024, −1876, −1721, −1573, −1401, −1247, −1099, −926, −778, −623, −452, |
| | | | −302, −149, 24, 172, 327, 475, 647, 801, 949, 1122, 1270, 1425, 1596, 1746, 1899] |
| | RU 13 | [−1708:−1683] | [−2023, −1875, −1720, −1572, −1400, −1246, −1098, −925, −777, −622, −451, |
| | | | −301, −148, 25, 173, 328, 476, 648, 802, 950, 1123, 1271, 1426, 1597, 1747, 1900] |
| | RU 14 | [−1681:−1656] | [−2022, −1874, −1719, −1571, −1399, −1245, −1097, −924, −776, −621, −450, |
| | | | −300, −147, 26, 174, 329, 477, 649, 803, 951, 1124, 1272, 1427, 1598, 1748, 1901] |
| | RU 15 | [−1654:−1629] | [−2021, −1873, −1718, −1570, −1398, −1244, −1096, −923, −775, −620, −449, |
| | | | −299, −145, 27, 175, 330, 478, 650, 804, 952, 1125, 1273, 1428, 1599, 1749, 1903] |
| | RU 16 | [−1628:−1603] | [−2020, −1872, −1717, −1569, −1397, −1243, −1095, −922, −774, −619, −448, |
| | | | −298, −144, 28, 176, 331, 479, 651, 805, 953, 1126, 1274, 1429, 1600, 1750, 1904] |
| | RU 17 | [−1600:−1575] | [−2019, −1871, −1716, −1568, −1396, −1242, −1094, −921, −773, −618, −445, |
| | | | −297, −143, 29, 177, 332, 480, 652, 806, 954, 1127, 1275, 1430, 1603, 1751, 1905] |
| | RU 18 | [−1574:−1549] | [−2018, −1870, −1715, −1567, −1395, −1241, −1093, −920, −772, −617, −444, |
| | | | −296, −142, 30, 178, 333, 481, 653, 807, 955, 1128, 1276, 1431, 1604, 1752, 1906] |
| | RU 19 | [not defined] | |
| | RU 20 | [−1523:−1498] | [−2017, −1869, −1714, −1566, −1394, −1240, −1092, −919, −764, −616, −443, |
| | | | −295, −141, 31, 179, 334, 482, 654, 808, 956, 1129, 1284, 1432, 1605, 1753, 1907] |
| | RU 21 | [−1497:−1472] | [−2016, −1868, −1713, −1565, −1393, −1239, −1091, −918, −763, −615, −442, |
| | | | −294, −140, 32, 180, 335, 483, 655, 809, 957, 1130, 1285, 1433, 1606, 1754, 1908] |
| | RU 22 | [−1469:−1444] | [−2015, −1867, −1712, −1564, −1392, −1238, −1088, −917, −762, −614, −441, |
| | | | −293, −139, 33, 181, 336, 484, 656, 810, 960, 1131, 1286, 1434, 1607, 1755, 1909] |
| | RU 23 | [−1443:−1418] | [−2014, −1866, −1711, −1563, −1391, −1237, −1087, −916, −761, −613, −440, |
| | | | −292, −138, 34, 182, 337, 485, 657, 811, 961, 1132, 1287, 1435, 1608, 1756, 1910] |
| | RU 24 | [−1416:−1391] | [−2013, −1865, −1710, −1562, −1389, −1236, −1086, −915, −760, −612, −439, |
| | | | −291, −137, 35, 183, 338, 486, 659, 812, 962, 1133, 1288, 1436, 1609, 1757, 1911] |
| | RU 25 | [−1389:−1364] | [−2012, −1864, −1709, −1561, −1388, −1235, −1085, −914, −759, −611, −438, |
| | | | −290, −136, 36, 184, 339, 487, 660, 813, 963, 1134, 1289, 1437, 1610, 1758, 1912] |
| | RU 26 | [−1363:−1338] | [−2011, −1863, −1708, −1560, −1387, −1234, −1084, −913, −758, −610, −437, |
| | | | −289, −135, 37, 185, 340, 488, 661, 814, 964, 1135, 1290, 1438, 1611, 1759, 1913] |
| | RU 27 | [−1335:−1310] | [−2010, −1862, −1707, −1559, −1386, −1233, −1083, −912, −757, −609, −436, |
| | | | −288, −134, 38, 186, 341, 489, 662, 815, 965, 1136, 1291, 1439, 1612, 1760, 1914] |
| | RU 28 | [−1309:−1284] | [−2009, −1861, −1706, −1558, −1385, −1232, −1082, −911, −756, −608, −435, |
| | | | −287, −133, 39, 187, 342, 490, 663, 816, 966, 1137, 1292, 1440, 1613, 1761, 1915] |
| | RU 29 | [−1276:−1251] | [−2008, −1860, −1705, −1557, −1384, −1231, −1081, −910, −755, −607, −434, |
| | | | −286, −132, 40, 188, 343, 491, 664, 817, 967, 1138, 1293, 1441, 1614, 1762, 1916] |
| | RU 30 | [−1250:−1225] | [−2007, −1859, −1704, −1556, −1383, −1230, −1080, −909, −754, −606, −433, |
| | | | −285, −131, 41, 189, 344, 492, 665, 818, 968, 1139, 1294, 1442, 1615, 1763, 1917] |
| | RU 31 | [−1222:−1197] | [−2006, −1858, −1703, −1555, −1382, −1229, −1079, −908, −753, −605, −432, |
| | | | −284, −130, 42, 190, 345, 493, 666, 819, 969, 1140, 1295, 1443, 1616, 1764, 1918] |
| | RU 32 | [−1196:−1171] | [−2005, −1857, −1702, −1554, −1381, −1228, −1078, −907, −752, −604, −431, |
| | | | −283, −129, 43, 191, 346, 494, 667, 820, 970, 1141, 1296, 1444, 1617, 1765, 1919] |
| | RU 33 | [−1169:−1144] | [−2004, −1856, −1701, −1553, −1380, −1227, −1077, −906, −751, −603, −430, |
| | | | −282, −128, 44, 192, 347, 495, 668, 821, 971, 1142, 1297, 1445, 1618, 1766, 1920] |
| | RU 34 | [−1142:−1117] | [−2003, −1855, −1700, −1552, −1379, −1226, −1076, −904, −750, −602, −429, |
| | | | −281, −127, 45, 193, 348, 496, 669, 822, 972, 1144, 1298, 1446, 1619, 1767, 1921] |
| | RU 35 | [−1116:−1091] | [−2002, −1854, −1699, −1551, −1378, −1225, −1075, −903, −749, −601, −428, |
| | | | −280, −126, 46, 194, 349, 497, 670, 823, 973, 1145, 1299, 1447, 1620, 1768, 1922] |
| | RU 36 | [−1088:−1063] | [−2001, −1853, −1698, −1550, −1377, −1222, −1074, −902, −748, −600, −427, |
| | | | −279, −125, 47, 195, 350, 498, 671, 826, 974, 1146, 1300, 1448, 1621, 1769, 1923] |
| | RU 37 | [−1062:−1037] | [−2000, −1852, −1697, −1549, −1376, −1221, −1073, −901, −747, −599, −426, |
| | | | −278, −124, 48, 196, 351, 499, 672, 827, 975, 1147, 1301, 1449, 1622, 1770, 1924] |
| | RU 38 | [−1011:−986] | [−1999, −1851, −1696, −1523, −1375, −1220, −1072, −900, −746, −598, −425, |
| | | | −277, −123, 49, 197, 352, 525, 673, 828, 976, 1148, 1302, 1450, 1623, 1771, 1925] |
| | RU 39 | [−985:−960] | [−1998, −1850, −1695, −1522, −1374, −1219, −1071, −899, −745, −597, −424, |
| | | | −276, −122, 50, 198, 353, 526, 674, 829, 977, 1149, 1303, 1451, 1624, 1772, 1926] |
| | RU 40 | [−957:−932] | [−1997, −1847, −1694, −1521, −1373, −1218, −1070, −898, −744, −596, −423, |
| | | | −275, −121, 51, 201, 354, 527, 675, 830, 978, 1150, 1304, 1452, 1625, 1773, 1927] |
| | RU 41 | [−931:−906] | [−1996, −1846, −1693, −1520, −1372, −1217, −1069, −897, −743, −595, −422, |
| | | | −274, −120, 52, 202, 355, 528, 676, 831, 979, 1151, 1305, 1453, 1626, 1774, 1928] |
| | RU 42 | [−904:−879] | [−1995, −1845, −1692, −1519, −1371, −1216, −1068, −896, −742, −594, −421, |
| | | | −273, −118, 53, 203, 356, 529, 677, 832, 980, 1152, 1306, 1454, 1627, 1775, 1930] |
| | RU 43 | [−877:−852] | [−1994, −1844, −1691, −1518, −1370, −1215, −1067, −895, −741, −593, −420, |
| | | | −272, −117, 54, 204, 357, 530, 678, 833, 981, 1153, 1307, 1455, 1628, 1776, 1931] |
| | RU 44 | [−851:−826] | [−1993, −1843, −1690, −1517, −1369, −1214, −1066, −894, −740, −592, −419, |
| | | | −271, −116, 55, 205, 358, 531, 679, 834, 982, 1154, 1308, 1456, 1629, 1777, 1932] |
| | RU 45 | [−823:−798] | [−1992, −1842, −1689, −1516, −1368, −1213, −1065, −893, −739, −591, −418, |
| | | | −270, −115, 56, 206, 359, 532, 680, 835, 983, 1155, 1309, 1457, 1630, 1778, 1933] |
| | RU 46 | [−797:−772] | [−1991, −1841, −1688, −1515, −1367, −1212, −1064, −892, −738, −590, −417, |
| | | | −269, −114, 57, 207, 360, 533, 681, 836, 984, 1156, 1310, 1458, 1631, 1779, 1934] |
| | RU 47 | [−764:−739] | [−1990, −1840, −1687, −1514, −1366, −1211, −1063, −891, −737, −589, −416, |
| | | | −268, −113, 58, 208, 361, 534, 682, 837, 985, 1157, 1311, 1459, 1632, 1780, 1935] |
| | RU 48 | [−738:−713] | [−1989, −1839, −1686, −1513, −1365, −1210, −1062, −890, −736, −588, −415, |
| | | | −267, −112, 59, 209, 362, 535, 683, 838, 986, 1158, 1312, 1460, 1633, 1781, 1936] |
| | RU 49 | [−710:−685] | [−1988, −1838, −1685, −1512, −1364, −1209, −1061, −889, −735, −587, −414, |
| | | | −266, −111, 60, 210, 363, 536, 684, 839, 987, 1159, 1313, 1461, 1634, 1782, 1937] |
| | RU 50 | [−684:−659] | [−1987, −1837, −1684, −1511, −1363, −1208, −1060, −888, −734, −586, −413, |
| | | | −265, −110, 61, 211, 364, 537, 685, 840, 988, 1160, 1314, 1462, 1635, 1783, 1938] |
| | RU 51 | [−657:−632] | [−1986, −1836, −1683, −1510, −1362, −1207, −1059, −887, −733, −585, −412, |
| | | | −264, −109, 62, 212, 365, 538, 686, 841, 989, 1161, 1315, 1463, 1636, 1784, 1939] |
| | RU 52 | [−630:−605] | [−1985, −1835, −1681, −1509, −1361, −1206, −1058, −886, −732, −584, −411, |
| | | | −263, −108, 63, 213, 367, 539, 687, 842, 990, 1162, 1316, 1464, 1637, 1785, 1940] |
| | RU 53 | [−604:−579] | [−1984, −1834, −1680, −1508, −1360, −1205, −1057, −885, −731, −583, −410, |
| | | | −262, −107, 64, 214, 368, 540, 688, 843, 991, 1163, 1317, 1465, 1638, 1786, 1941] |
| | RU 54 | [−576:−551] | [−1981, −1833, −1679, −1507, −1359, −1204, −1056, −884, −730, −582, −409, |
| | | | −261, −106, 67, 215, 369, 541, 689, 844, 992, 1164, 1318, 1466, 1639, 1787, 1942] |
| | RU 55 | [−550:−525] | [−1980, −1832, −1678, −1506, −1358, −1203, −1055, −883, −729, −581, −408, |
| | | | −260, −105, 68, 216, 370, 542, 690, 845, 993, 1165, 1319, 1467, 1640, 1788, 1943] |
| | RU 56 | [not defined] | |
| | RU 57 | [−499:−474] | [−1979, −1831, −1677, −1505, −1357, −1202, −1054, −882, −728, −580, −407, |
| | | | −252, −104, 69, 217, 371, 543, 691, 846, 994, 1166, 1320, 1468, 1641, 1796, 1944] |
| | RU 58 | [−473:−448] | [−1978, −1830, −1676, −1504, −1356, −1201, −1053, −881, −727, −579, −406, |
| | | | −251, −103, 70, 218, 372, 544, 692, 847, 995, 1167, 1321, 1469, 1642, 1797, 1945] |
| | RU 59 | [−445:−420] | [−1977, −1829, −1675, −1503, −1355, −1200, −1052, −880, −726, −576, −405, |
| | | | −250, −102, 71, 219, 373, 545, 693, 848, 996, 1168, 1322, 1472, 1643, 1798, 1946] |
| | RU 60 | [−419:−394] | [−1976, −1828, −1674, −1502, −1354, −1199, −1051, −879, −725, −575, −404, |
| | | | −249, −101, 72, 220, 374, 546, 694, 849, 997, 1169, 1323, 1473, 1644, 1799, 1947] |
| | RU 61 | [−392:−367] | [−1975, −1827, −1673, −1501, −1353, −1198, −1050, −877, −724, −574, −403, |
| | | | −248, −100, 73, 221, 375, 547, 695, 850, 998, 1171, 1324, 1474, 1645, 1800, 1948] |
| | RU 62 | [−365:−340] | [−1974, −1826, −1672, −1500, −1352, −1197, −1049, −876, −723, −573, −402, |
| | | | −247, −99, 74, 222, 376, 548, 696, 851, 999, 1172, 1325, 1475, 1646, 1801, 1949] |
| | RU 63 | [−339:−314] | [−1973, −1825, −1671, −1499, −1351, −1196, −1048, −875, −722, −572, −401, |
| | | | −246, −98, 75, 223, 377, 549, 697, 852, 1000, 1173, 1326, 1476, 1647, 1802, 1950] |
| | RU 64 | [−311:−286] | [−1972, −1824, −1670, −1498, −1350, −1195, −1047, −874, −721, −571, −400, |
| | | | −245, −97, 76, 224, 378, 550, 698, 853, 1001, 1174, 1327, 1477, 1648, 1803, 1951] |
| | RU 65 | [−285:−260] | [−1971, −1823, −1669, −1497, −1349, −1194, −1046, −873, −720, −570, −399, |
| | | | −244, −96, 77, 225, 379, 551, 699, 854, 1002, 1175, 1328, 1478, 1649, 1804, 1952] |
| | RU 66 | [−252:−227] | [−1970, −1822, −1668, −1496, −1348, −1193, −1045, −872, −719, −569, −398, |
| | | | −243, −95, 78, 226, 380, 552, 700, 855, 1003, 1176, 1329, 1479, 1650, 1805, 1953] |
| | RU 67 | [−226:−201] | [−1969, −1821, −1667, −1495, −1347, −1192, −1044, −871, −718, −568, −397, |
| | | | −242, −94, 79, 227, 381, 553, 701, 856, 1004, 1177, 1330, 1480, 1651, 1806, 1954] |
| | RU 68 | [−198:−173] | [−1968, −1820, −1666, −1494, −1346, −1191, −1043, −870, −717, −567, −396, |
| | | | −241, −93, 80, 228, 382, 554, 702, 857, 1005, 1178, 1331, 1481, 1652, 1807, 1955] |
| | RU 69 | [−172:−147] | [−1967, −1819, −1665, −1493, −1345, −1190, −1042, −869, −716, −566, −395, |
| | | | −240, −92, 81, 229, 383, 555, 703, 858, 1006, 1179, 1332, 1482, 1653, 1808, 1956] |
| | RU 70 | [−145:−120] | [−1966, −1818, −1664, −1492, −1344, −1189, −1041, −868, −715, −565, −394, |
| | | | −239, −91, 82, 230, 384, 556, 704, 859, 1007, 1180, 1333, 1483, 1654, 1809, 1957] |
| | RU 71 | [−118:−93] | [−1965, −1817, −1663, −1491, −1343, −1188, −1040, −867, −714, −564, −392, |
| | | | −238, −90, 83, 231, 385, 557, 705, 860, 1008, 1181, 1334, 1484, 1656, 1810, 1958] |
| | RU 72 | [−92:−67] | [−1964, −1816, −1662, −1490, −1342, −1187, −1039, −866, −713, −563, −391, |
| | | | −237, −89, 84, 232, 386, 558, 706, 861, 1009, 1182, 1335, 1485, 1657, 1811, 1959] |
| | RU 73 | [−64:−39] | [−1963, −1815, −1661, −1489, −1341, −1186, −1038, −865, −710, −562, −390, |
| | | | −236, −88, 85, 233, 387, 559, 707, 862, 1010, 1183, 1338, 1486, 1658, 1812, 1960] |
| | RU 74 | [−38:−13] | [−1962, −1814, −1660, −1488, −1340, −1185, −1037, −864, −709, −561, −389, |
| | | | −235, −87, 86, 234, 388, 560, 708, 863, 1011, 1184, 1339, 1487, 1659, 1813, 1961] |
| | RU 75 | [13:38] | [−1961, −1813, −1659, −1487, −1339, −1184, −1011, −863, −708, −560, −388, |
| | | | −234, −86, 87, 235, 389, 561, 709, 864, 1037, 1185, 1340, 1488, 1660, 1814, 1962] |
| | RU 76 | [39:64] | [−1960, −1812, −1658, −1486, −1338, −1183, −1010, −862, −707, −559, −387, |
| | | | −233, −85, 88, 236, 390, 562, 710, 865, 1038, 1186, 1341, 1489, 1661, 1815, 1963] |
| | RU 77 | [67:92] | [−1959, −1811, −1657, −1485, −1335, −1182, −1009, −861, −706, −558, −386, |
| | | | −232, −84, 89, 237, 391, 563, 713, 866, 1039, 1187, 1342, 1490, 1662, 1816, 1964] |
| | RU 78 | [93:118] | [−1958, −1810, −1656, −1484, −1334, −1181, −1008, −860, −705, −557, −385, |
| | | | −231, −83, 90, 238, 392, 564, 714, 867, 1040, 1188, 1343, 1491, 1663, 1817, 1965] |
| | RU 79 | [120:145] | [−1957, −1809, −1654, −1483, −1333, −1180, −1007, −859, −704, −556, −384, |
| | | | −230,−82, 91, 239, 394, 565, 715, 868, 1041, 1189, 1344, 1492, 1664, 1818, 1966] |
| | RU 80 | [147:172] | [−1956, −1808, −1653, −1482, −1332, −1179, −1006, −858, −703, −555, −383, |
| | | | −229, −81, 92, 240, 395, 566, 716, 869, 1042, 1190, 1345, 1493, 1665, 1819, 1967] |
| | RU 81 | [173:198] | [−1955, −1807, −1652, −1481, −1331, −1178, −1005, −857, −702, −554, −382, |
| | | | −228, −80, 93, 241, 396, 567, 717, 870, 1043, 1191, 1346, 1494, 1666, 1820, 1968] |
| | RU 82 | [201:226] | [−1954, −1806, −1651, −1480, −1330, −1177, −1004, −856, −701, −553, −381, |
| | | | −227, −79, 94, 242, 397, 568, 718, 871, 1044, 1192, 1347, 1495, 1667, 1821, 1969] |
| | RU 83 | [227:252] | [−1953, −1805, −1650, −1479, −1329, −1176, −1003, −855, −700, −552, −380, |
| | | | −226, −78, 95, 243, 398, 569, 719, 872, 1045, 1193, 1348, 1496, 1668, 1822, 1970] |
| | RU 84 | [260:285] | [−1952, −1804, −1649, −1478, −1328, −1175, −1002, −854, −699, −551, −379, |
| | | | −225, −77, 96, 244, 399, 570, 720, 873, 1046, 1194, 1349, 1497, 1669, 1823, 1971] |
| | RU 85 | [286:311] | [−1951, −1803, −1648, −1477, −1327, −1174, −1001, −853, −698, −550, −378, |
| | | | −224, −76, 97, 245, 400, 571, 721, 874, 1047, 1195, 1350, 1498, 1670, 1824, 1972] |
| | RU 86 | [314:339] | [−1950, −1802, −1647, −1476, −1326, −1173, −1000, −852, −697, −549, −377, |
| | | | −223, −75, 98, 246, 401, 572, 722, 875, 1048, 1196, 1351, 1499, 1671, 1825, 1973] |
| | RU 87 | [340:365] | [−1949, −1801, −1646, −1475, −1325, −1172, −999, −851, −696, −548, −376, −222, |
| | | | −74, 99, 247, 402, 573, 723, 876, 1049, 1197, 1352, 1500, 1672, 1826, 1974] |
| | RU 88 | [367:392] | [−1948, −1800, −1645, −1474, −1324, −1171, −998, −850, −695, −547, −375, −221, |
| | | | −73, 100, 248, 403, 574, 724, 877, 1050, 1198, 1353, 1501, 1673, 1827, 1975] |
| | RU 89 | [394:419] | [−1947, −1799, −1644, −1473, −1323, −1169, −997, −849, −694, −546, −374, −220, |
| | | | −72, 101, 249, 404, 575, 725, 879, 1051, 1199, 1354, 1502, 1674, 1828, 1976] |
| | RU 90 | [420:445] | [−1946, −1798, −1643, −1472, −1322, −1168, −996, −848, −693, −545, −373, −219, |
| | | | −71, 102, 250, 405, 576, 726, 880, 1052, 1200, 1355, 1503, 1675, 1829, 1977] |
| | RU 91 | [448:473] | [−1945, −1797, −1642, −1469, −1321, −1167, −995, −847, −692, −544, −372, −218, |
| | | | −70, 103, 251, 406, 579, 727, 881, 1053, 1201, 1356, 1504, 1676, 1830, 1978] |
| | RU 92 | [474:499] | [−1944, −1796, −1641, −1468, −1320, −1166, −994, −846, −691, −543, −371, −217, |
| | | | −69, 104, 252, 407, 580, 728, 882, 1054, 1202, 1357, 1505, 1677, 1831, 1979] |
| | RU 93 | [not defined] | |
| | RU 94 | [525:550] | [−1943, −1788, −1640, −1467, −1319, −1165, −993, −845, −690, −542, −370, −216, |
| | | | −68, 105, 260, 408, 581, 729, 883, 1055, 1203, 1358, 1506, 1678, 1832, 1980] |
| | RU 95 | [551:576] | [−1942, −1787, −1639, −1466, −1318, −1164, −992, −844, −689, −541, −369, −215, |
| | | | −67, 106, 261, 409, 582, 730, 884, 1056, 1204, 1359, 1507, 1679, 1833, 1981] |
| | RU 96 | [579:604] | [−1941, −1786, −1638, −1465, −1317, −1163, −991, −843, −688, −540, −368, −214, |
| | | | −64, 107, 262, 410, 583, 731, 885, 1057, 1205, 1360, 1508, 1680, 1834, 1984] |
| | RU 97 | [605:630] | [−1940, −1785, −1637, −1464, −1316, −1162, −990, −842, −687, −539, −367, −213, |
| | | | −63, 108, 263, 411, 584, 732, 886, 1058, 1206, 1361, 1509, 1681, 1835, 1985] |
| | RU 98 | [632:657] | [−1939, −1784, −1636, −1463, −1315, −1161, −989, −841, −686, −538, −365, −212, |
| | | | −62, 109, 264, 412, 585, 733, 887, 1059, 1207, 1362, 1510, 1683, 1836, 1986] |
| | RU 99 | [659:684] | [−1938, −1783, −1635, −1462, −1314, −1160, −988, −840, −685, −537, −364, −211, |
| | | | −61, 110, 265, 413, 586, 734, 888, 1060, 1208, 1363, 1511, 1684, 1837, 1987] |
| | RU 100 | [685:710] | [−1937, −1782, −1634, −1461, −1313, −1159, −987, −839, −684, −536, −363, −210, |
| | | | −60, 111, 266, 414, 587, 735, 889, 1061, 1209, 1364, 1512, 1685, 1838, 1988] |
| | RU 101 | [713:738] | [−1936, −1781, −1633, −1460, −1312, −1158, −986, −838, −683, −535, −362, −209, |
| | | | −59, 112, 267, 415, 588, 736, 890, 1062, 1210, 1365, 1513, 1686, 1839, 1989] |
| | RU 102 | [739:764] | [−1935, −1780, −1632, −1459, −1311, −1157, −985, −837, −682, −534, −361, −208, |
| | | | −58, 113, 268, 416, 589, 737, 891, 1063, 1211, 1366, 1514, 1687, 1840, 1990] |
| | RU 103 | [772:797] | [−1934, −1779, −1631, −1458, −1310, −1156, −984, −836, −681, −533, −360, −207, |
| | | | −57, 114, 269, 417, 590, 738, 892, 1064, 1212, 1367, 1515, 1688, 1841, 1991] |
| | RU 104 | [798:823] | [−1933, −1778, −1630, −1457, −1309, −1155, −983, −835, −680, −532, −359, −206, |
| | | | −56, 115, 270, 418, 591, 739, 893, 1065, 1213, 1368, 1516, 1689, 1842, 1992] |
| | RU 105 | [826:851] | [−1932, −1777, −1629, −1456, −1308, −1154, −982, −834, −679, −531, −358, −205, |
| | | | −55, 116, 271, 419, 592, 740, 894, 1066, 1214, 1369, 1517, 1690, 1843, 1993] |
| | RU 106 | [852:877] | [−1931, −1776, −1628, −1455, −1307, −1153, −981, −833, −678, −530, −357, −204, |
| | | | −54, 117, 272, 420, 593, 741, 895, 1067, 1215, 1370, 1518, 1691, 1844, 1994] |
| | RU 107 | [879:904] | [−1930, −1775, −1627, −1454, −1306, −1152, −980, −832, −677, −529, −356, −203, |
| | | | −53, 118, 273, 421, 594, 742, 896, 1068, 1216, 1371, 1519, 1692, 1845, 1995] |
| | RU 108 | [906:931] | [−1928, −1774, −1626, −1453, −1305, −1151, −979, −831, −676, −528, −355, −202, |
| | | | −52, 120, 274, 422, 595, 743, 897, 1069, 1217, 1372, 1520, 1693, 1846, 1996] |
| | RU 109 | [932:957] | [−1927, −1773, −1625, −1452, −1304, −1150, −978, −830, −675, −527, −354, −201, |
| | | | −51, 121, 275, 423, 596, 744, 898, 1070, 1218, 1373, 1521, 1694, 1847, 1997] |
| | RU 110 | [960:985] | [−1926, −1772, −1624, −1451, −1303, −1149, −977, −829, −674, −526, −353, −198, |
| | | | −50, 122, 276, 424, 597, 745, 899, 1071, 1219, 1374, 1522, 1695, 1850, 1998] |
| | RU 111 | [986:1011] | [−1925, −1771, −1623, −1450, −1302, −1148, −976, −828, −673, −525, −352, −197, |
| | | | −49, 123, 277, 425, 598, 746, 900, 1072, 1220, 1375, 1523, 1696, 1851, 1999] |
| | RU 112 | [1037:1062] | [−1924, −1770, −1622, −1449, −1301, −1147, −975, −827, −672, −499, −351, −196, |
| | | | −48, 124, 278, 426, 599, 747, 901, 1073, 1221, 1376, 1549, 1697, 1852, 2000] |
| | RU 113 | [1063:1088] | [−1923, −1769, −1621, −1448, −1300, −1146, −974, −826, −671, −498, −350, −195, |
| | | | −47, 125, 279, 427, 600, 748, 902, 1074, 1222, 1377, 1550, 1698, 1853, 2001] |
| | RU 114 | [1091:1116] | [−1922, −1768, −1620, −1447, −1299, −1145, −973, −823, −670, −497, −349, −194, |
| | | | −46, 126, 280, 428, 601, 749, 903, 1075, 1225, 1378, 1551, 1699, 1854, 2002] |
| | RU 115 | [1117:1142] | [−1921, −1767, −1619, −1446, −1298, −1144, −972, −822, −669, −496, −348, −193, |
| | | | −45, 127, 281, 429, 602, 750, 904, 1076, 1226, 1379, 1552, 1700, 1855, 2003] |
| | RU 116 | [1144:1169] | [−1920, −1766, −1618, −1445, −1297, −1142, −971, −821, −668, −495, −347, − 192, |
| | | | −44, 128, 282, 430, 603, 751, 906, 1077, 1227, 1380, 1553, 1701, 1856, 2004] |
| | RU 117 | [1171:1196] | [−1919, −1765, −1617, −1444, −1296, −1141, −970, −820, −667, −494, −346, −191, |
| | | | −43, 129, 283, 431, 604, 752, 907, 1078, 1228, 1381, 1554, 1702, 1857, 2005] |
| | RU 118 | [1197:1222] | [−1918, −1764, −1616, −1443, −1295, −1140, −969, −819, −666, −493, −345, −190, |
| | | | −42, 130, 284, 432, 605, 753, 908, 1079, 1229, 1382, 1555, 1703, 1858, 2006] |
| | RU 119 | [1225:1250] | [−1917, −1763, −1615, −1442, −1294, −1139, −968, −818, −665, −492, −344, −189, |
| | | | −41, 131, 285, 433, 606, 754, 909, 1080, 1230, 1383, 1556, 1704, 1859, 2007] |
| | RU 120 | [1251:1276] | [−1916, −1762, −1614, −1441, −1293, −1138, −967, −817, −664, −491, −343, −188, |
| | | | −40, 132, 286, 434, 607, 755, 910, 1081, 1231, 1384, 1557, 1705, 1860, 2008] |
| | RU 121 | [1284:1309] | [−1915, −1761, −1613, −1440, −1292, −1137, −966, −816, −663, −490, −342, −187, |
| | | | −39, 133, 287, 435, 608, 756, 911, 1082, 1232, 1385, 1558, 1706, 1861, 2009] |
| | RU 122 | [1310:1335] | [−1914, −1760, −1612, −1439, −1291, −1136, −965, −815, −662, −489, −341, −186, |
| | | | −38, 134, 288, 436, 609, 757, 912, 1083, 1233, 1386, 1559, 1707, 1862, 2010] |
| | RU 123 | [1338:1363] | [−1913, −1759, −1611, −1438, −1290, −1135, −964, −814, −661, −488, −340, −185, |
| | | | −37, 135, 289, 437, 610, 758, 913, 1084, 1234, 1387, 1560, 1708, 1863, 2011] |
| | RU 124 | [1364:1389] | [−1912, −1758, −1610, −1437, −1289, −1134, −963, −813, −660, −487, −339, −184, |
| | | | −36, 136, 290, 438, 611, 759, 914, 1085, 1235, 1388, 1561, 1709, 1864, 2012] |
| | RU 125 | [1391:1416] | [−1911, −1757, −1609, −1436, −1288, −1133, −962, −812, −659, −486, −338, −183, |
| | | | −35, 137, 291, 439, 612, 760, 915, 1086, 1236, 1389, 1562, 1710, 1865, 2013] |
| | RU 126 | [1418:1443] | [−1910, −1756, −1608, −1435, −1287, −1132, −961, −811, −657, −485, −337, −182, |
| | | | −34, 138, 292, 440, 613, 761, 916, 1087, 1237, 1391, 1563, 1711, 1866, 2014] |
| | RU 127 | [1444:1469] | [−1909, −1755, −1607, −1434, −1286, −1131, −960, −810, −656, −484, −336, −181, |
| | | | −33, 139, 293, 441, 614, 762, 917, 1088, 1238, 1392, 1564, 1712, 1867, 2015] |
| | RU 128 | [1472:1497] | [−1908, −1754, −1606, −1433, −1285, −1130, −957, −809, −655, −483, −335, −180, |
| | | | −32, 140, 294, 442, 615, 763, 918, 1091, 1239, 1393, 1565, 1713, 1868, 2016] |
| | RU 129 | [1498:1523] | [−1907, −1753, −1605, −1432, −1284, −1129, −956, −808, −654, −482, −334, −179, |
| | | | −31, 141, 295, 443, 616, 764, 919, 1092, 1240, 1394, 1566, 1714, 1869, 2017] |
| | RU 130 | [not defined] | |
| | RU 131 | [1549:1574] | [−1906, −1752, −1604, −1431, −1276, −1128, −955, −807, −653, −481, −333, −178, |
| | | | −30, 142, 296, 444, 617, 772, 920, 1093, 1241, 1395, 1567, 1715, 1870, 2018] |
| | RU 132 | [1575:1600] | [−1905, −1751, −1603, −1430, −1275, −1127, −954, −806, −652, −480, −332, −177, |
| | | | −29, 143, 297, 445, 618, 773, 921, 1094, 1242, 1396, 1568, 1716, 1871, 2019] |
| | RU 133 | [1603:1628] | [−1904, −1750, −1600, −1429, −1274, −1126, −953, −805, −651, −479, −331, −176, |
| | | | −28, 144, 298, 448, 619, 774, 922, 1095, 1243, 1397, 1569, 1717, 1872, 2020] |
| | RU 134 | [1629:1654] | [−1903, −1749, −1599, −1428, −1273, −1125, −952, −804, −650, −478, −330, −175, |
| | | | −27, 145, 299, 449, 620, 775, 923, 1096, 1244, 1398, 1570, 1718, 1873, 2021] |
| | RU 135 | [1656:1681] | [−1901, −1748, −1598, −1427, −1272, −1124, −951, −803, −649, −477, −329, −174, |
| | | | −26, 147, 300, 450, 621, 776, 924, 1097, 1245, 1399, 1571, 1719, 1874, 2022] |
| | RU 136 | [1683:1708] | [−1900, −1747, −1597, −1426, −1271, −1123, −950, −802, −648, −476, −328, −173, |
| | | | −25, 148, 301, 451, 622, 777, 925, 1098, 1246, 1400, 1572, 1720, 1875, 2023] |
| | RU 137 | [1709:1734] | [−1899, −1746, −1596, −1425, −1270, −1122, −949, −801, −647, −475, −327, −172, |
| | | | −24, 149, 302, 452, 623, 778, 926, 1099, 1247, 1401, 1573, 1721, 1876, 2024] |
| | RU 138 | [1737:1762] | [−1898, −1745, −1595, −1424, −1269, −1121, −948, −800, −646, −474, −326, −171, |
| | | | −23, 150, 303, 453, 624, 779, 927, 1100, 1248, 1402, 1574, 1722, 1877, 2025] |
| | RU 139 | [1763:1788] | [−1897, −1744, −1594, −1423, −1268, −1120, −947, −799, −645, −473, −325, −170, |
| | | | −22, 151, 304, 454, 625, 780, 928, 1101, 1249, 1403, 1575, 1723, 1878, 2026] |
| | RU 140 | [1796:1821] | [−1896, −1743, −1593, −1422, −1267, −1119, −946, −798, −644, −472, −324, −169, |
| | | | −21, 152, 305, 455, 626, 781, 929, 1102, 1250, 1404, 1576, 1724, 1879, 2027] |
| | RU 141 | [1822:1847] | [−1895, −1742, −1592, −1421, −1266, −1118, −945, −797, −643, −471, −323, −168, |
| | | | −20, 153, 306, 456, 627, 782, 930, 1103, 1251, 1405, 1577, 1725, 1880, 2028] |
| | RU 142 | [1850:1875] | [−1894, −1741, −1591, −1420, −1265, −1117, −944, −796, −642, −470, −322, −167, |
| | | | −19, 154, 307, 457, 628, 783, 931, 1104, 1252, 1406, 1578, 1726, 1881, 2029] |
| | RU 143 | [1876:1901] | [−1893, −1740, −1590, −1419, −1264, −1116, −943, −795, −641, −469, −321, −166, |
| | | | −18, 155, 308, 458, 629, 784, 932, 1105, 1253, 1407, 1579, 1727, 1882, 2030] |
| | RU 144 | [1903:1928] | [−1892, −1739, −1589, −1418, −1263, −1115, −942, −794, −640, −468, −320, −165, |
| | | | −17, 156, 309, 459, 630, 785, 933, 1106, 1254, 1408, 1580, 1728, 1883, 2031] |
| | RU 145 | [1930:1955] | [−1891, −1738, −1588, −1416, −1262, −1114, −941, −793, −639, −467, −319, −164, |
| | | | −16, 157, 310, 460, 632, 786, 934, 1107, 1255, 1409, 1581, 1729, 1884, 2032] |
| | RU 146 | [1956:1981] | [−1890, −1737, −1587, −1415, −1261, −1113, −940, −792, −638, −466, −318, −163, |
| | | | −15, 158, 311, 461, 633, 787, 935, 1108, 1256, 1410, 1582, 1730, 1885, 2033] |
| | RU 147 | [1984:2009] | [−1889, −1734, −1586, −1414, −1260, −1112, −939, −791, −637, −465, −317, −162, |
| | | | −14, 159, 314, 462, 634, 788, 936, 1109, 1257, 1411, 1583, 1731, 1886, 2034] |
| | RU 148 | [2010:2035] | [−1888, −1733, −1585, −1413, −1259, −1111, −938, −790, −636, −464, −316, −161, |
| | | | −13, 160, 315, 463, 635, 789, 937, 1110, 1258, 1412, 1584, 1732, 1887, 2035] |
| 52-tone | RU 1 | [−2035:−1984] | [26-tone RU1, 26-tone RU2] |
| RU | RU 2 | [−1981:−1930] | [26-tone RU3, 26-tone RU4] |
| | RU 3 | [−1901:−1850] | [26-tone RU6, 26-tone RU7] |
| | RU 4 | [−1847:−1796] | [26-tone RU8, 26-tone RU9] |
| | RU 5 | [−1788:−1737] | [26-tone RU10, 26-tone RU11] |
| | RU 6 | [−1734:−1683] | [26-tone RU12, 26-tone RU13] |
| | RU 7 | [−1654:−1603] | [26-tone RU15, 26-tone RU16] |
| | RU 8 | [−1600:−1549] | [26-tone RU17, 26-tone RU18] |
| | RU 9 | [−1523:−1472] | [26-tone RU20, 26-tone RU21] |
| | RU 10 | [−1469:−1418] | [26-tone RU22, 26-tone RU23] |
| | RU 11 | [−1389:−1338] | [26-tone RU25, 26-tone RU26] |
| | RU 12 | [−1335:−1284] | [26-tone RU27, 26-tone RU28] |
| | RU 13 | [−1276:−1225] | [26-tone RU29, 26-tone RU30] |
| | RU 14 | [−1222:−1171] | [26-tone RU31, 26-tone RU32] |
| | RU 15 | [−1142:−1091] | [26-tone RU34, 26-tone RU35] |
| | RU 16 | [−1088:−1037] | [26-tone RU36, 26-tone RU37] |
| | RU 17 | [−1011:−960] | [26-tone RU38, 26-tone RU39] |
| | RU 18 | [−957:−906] | [26-tone RU40, 26-tone RU41] |
| | RU 19 | [−877:−826] | [26-tone RU43, 26-tone RU44] |
| | RU 20 | [−823:−772] | [26-tone RU45, 26-tone RU46] |
| | RU 21 | [−764:−713] | [26-tone RU47, 26-tone RU48] |
| | RU 22 | [−710:−659] | [26-tone RU49, 26-tone RU50] |
| | RU 23 | [−630:−579] | [26-tone RU52, 26-tone RU53] |
| | RU 24 | [−576:−525] | [26-tone RU54, 26-tone RU55] |
| | RU 25 | [−499:−448] | [26-tone RU57, 26-tone RU58] |
| | RU 26 | [−445:−394] | [26-tone RU59, 26-tone RU60] |
| | RU 27 | [−365:−314] | [26-tone RU62, 26-tone RU63] |
| | RU 28 | [−311:−260] | [26-tone RU64, 26-tone RU65] |
| | RU 29 | [−252:−201] | [26-tone RU66, 26-tone RU67] |
| | RU 30 | [−198:−147] | [26-tone RU68, 26-tone RU69] |
| | RU 31 | [−118:−67] | [26-tone RU71, 26-tone RU72] |
| | RU 32 | [−64:−13] | [26-tone RU73, 26-tone RU74] |
| | RU 33 | [13:64] | [26-tone RU75, 26-tone RU76] |
| | RU 34 | [67:118] | [26-tone RU77, 26-tone RU78] |
| | RU 35 | [147:198] | [26-tone RU80, 26-tone RU81] |
| | RU 36 | [201:252] | [26-tone RU82, 26-tone RU83] |
| | RU 37 | [260:311] | [26-tone RU84, 26-tone RU85] |
| | RU 38 | [314:365] | [26-tone RU86, 26-tone RU87] |
| | RU 39 | [394:445] | [26-tone RU89, 26-tone RU90] |
| | RU 40 | [448:499] | [26-tone RU91, 26-tone RU92] |
| | RU 41 | [525:576] | [26-tone RU94, 26-tone RU95] |
| | RU 42 | [579:630] | [26-tone RU96, 26-tone RU97] |
| | RU 43 | [659:710] | [26-tone RU99, 26-tone RU100] |
| | RU 44 | [713:764] | [26-tone RU101, 26-tone RU102] |
| | RU 45 | [772:823] | [26-tone RU103, 26-tone RU104] |
| | RU 46 | [826:877] | [26-tone RU105, 26-tone RU106] |
| | RU 47 | [906:957] | [26-tone RU108, 26-tone RU109] |
| | RU 48 | [960:1011] | [26-tone RU110, 26-tone RU111] |
| | RU 49 | [1037:1088] | [26-tone RU112, 26-tone RU113] |
| | RU 50 | [1091:1142] | [26-tone RU114, 26-tone RU115] |
| | RU 51 | [1171:1222] | [26-tone RU117, 26-tone RU118] |
| | RU 52 | [1225:1276] | [26-tone RU119, 26-tone RU120] |
| | RU 53 | [1284:1335] | [26-tone RU121, 26-tone RU122] |
| | RU 54 | [1338:1389] | [26-tone RU123, 26-tone RU124] |
| | RU 55 | [1418:1469] | [26-tone RU126, 26-tone RU127] |
| | RU 56 | [1472:1523] | [26-tone RU128, 26-tone RU129] |
| | RU 57 | [1549:1600] | [26-tone RU131, 26-tone RU132] |
| | RU 58 | [1603:1654] | [26-tone RU133, 26-tone RU134] |
| | RU 59 | [1683:1734] | [26-tone RU136, 26-tone RU137] |
| | RU 60 | [1737:1788] | [26-tone RU138, 26-tone RU139] |
| | RU 61 | [1796:1847] | [26-tone RU140, 26-tone RU141] |
| | RU 62 | [1850:1901] | [26-tone RU142, 26-tone RU143] |
| | RU 63 | [1930:1981] | [26-tone RU145, 26-tone RU146] |
| | RU 64 | [1984:2035] | [26-tone RU147, 26-tone RU148] |
| 106-tone | RU 1 | [−2035:−1930] | [26-tone RU1, 26-tone RU2, −1983, −1982, 26-tone RU3, 26-tone RU4] |
| RU | RU 2 | [−1901:−1796] | [26-tone RU6, 26-tone RU7, −1849, −1848, 26-tone RU8, 26-tone RU9] |
| | RU 3 | [−1788:−1683] | [26-tone RU10, 26-tone RU11, −1736, −1735, 26-tone RU12, 26-tone RU13] |
| | RU 4 | [−1654:−1549] | [26-tone RU15, 26-tone RU16, −1602, −1601, 26-tone RU17, 26-tone RU18] |
| | RU 5 | [−1523:−1418] | [26-tone RU20, 26-tone RU21, −1471, −1470, 26-tone RU22, 26-tone RU23] |
| | RU 6 | [−1389:−1284] | [26-tone RU25, 26-tone RU26, −1337, −1336, 26-tone RU27, 26-tone RU28] |
| | RU 7 | [−1276:−1171] | [26-tone RU29, 26-tone RU30, −1224, −1223, 26-tone RU31, 26-tone RU32] |
| | RU 8 | [−1142:−1037] | [26-tone RU34, 26-tone RU35, −1090, −1089, 26-tone RU36, 26-tone RU37] |
| | RU 9 | [−1011:−906] | [26-tone RU38, 26-tone RU39, −959, −958, 26-tone RU40, 26-tone RU41] |
| | RU 10 | [−877:−772] | [26-tone RU43, 26-tone RU44, −825, −824, 26-tone RU45, 26-tone RU46] |
| | RU 11 | [−764:−659] | [26-tone RU47, 26-tone RU48, −712, −711, 26-tone RU49, 26-tone RU50] |
| | RU 12 | [−630:−525] | [26-tone RU52, 26-tone RU53, −578, −577, 26-tone RU54, 26-tone RU55] |
| | RU 13 | [−499:−394] | [26-tone RU57, 26-tone RU58, −447, −446, 26-tone RU59, 26-tone RU60] |
| | RU 14 | [−365:−260] | [26-tone RU62, 26-tone RU63, −313, −312, 26-tone RU64, 26-tone RU65] |
| | RU 15 | [−252:−147] | [26-tone RU66, 26-tone RU67, −200, −199, 26-tone RU68, 26-tone RU69] |
| | RU 16 | [−118:−13] | [26-tone RU71, 26-tone RU72, −66, −65, 26-tone RU73, 26-tone RU74] |
| | RU 17 | [13:118] | [26-tone RU75, 26-tone RU76, 65, 66, 26-tone RU77, 26-tone RU78] |
| | RU 18 | [147:252] | [26-tone RU80, 26-tone RU81, 199, 200, 26-tone RU82, 26-tone RU83] |
| | RU 19 | [260:365] | [26-tone RU84, 26-tone RU85, 312, 313, 26-tone RU86, 26-tone RU87] |
| | RU 20 | [394:499] | [26-tone RU89, 26-tone RU90, 446, 447, 26-tone RU91, 26-tone RU92] |
| | RU 21 | [525:630] | [26-tone RU94, 26-tone RU95, 577, 578, 26-tone RU96, 26-tone RU97] |
| | RU 22 | [659:764] | [26-tone RU99, 26-tone RU100, 711, 712, 26-tone RU101, 26-tone RU102] |
| | RU 23 | [772:877] | [26-tone RU103, 26-tone RU104, 824, 825, 26-tone RU105, 26-tone RU106] |
| | RU 24 | [906:1011] | [26-tone RU108, 26-tone RU109, 958, 959, 26-tone RU110, 26-tone RU111] |
| | RU 25 | [1037:1142] | [26-tone RU112, 26-tone RU113, 1089, 1090, 26-tone RU114, 26-tone RU115] |
| | RU 26 | [1171:1276] | [26-tone RU117, 26-tone RU118, 1223, 1224, 26-tone RU119, 26-tone RU120] |
| | RU 27 | [1284:1389] | [26-tone RU121, 26-tone RU122, 1336, 1337, 26-tone RU123, 26-tone RU124] |
| | RU 28 | [1418:1523] | [26-tone RU126, 26-tone RU127, 1470, 1471, 26-tone RU128, 26-tone RU129] |
| | RU 29 | [1549:1654] | [26-tone RU131, 26-tone RU132, 1601, 1602, 26-tone RU133, 26-tone RU134] |
| | RU 30 | [1683:1788] | [26-tone RU136, 26-tone RU137, 1735, 1736, 26-tone RU138, 26-tone RU139] |
| | RU 31 | [1796:1901] | [26-tone RU140, 26-tone RU141, 1848, 1849, 26-tone RU142, 26-tone RU143] |
| | RU 32 | [1930:2035] | [26-tone RU145, 26-tone RU146, 1982, 1983, 26-tone RU147, 26-tone RU148] |
| 242-tone | RU 1 | [−2036:−1795] | [−2036, 26-tone RU1, 26-tone RU2, −1983, −1982, 26-tone RU3, 26-tone |
| RU | | | RU4, −1929, 26-tone RU5, −1902, 26-tone RU6, 26-tone RU7, −1849, |
| | | | −1848, 26-tone RU8, 26-tone RU9, −1795] |
| | RU 2 | [−1789:−1548] | [−1789, 26-tone RU10, 26-tone RU11, −1736, −1735, 26-tone RU12, 26- |
| | | | tone RU13, −1682, 26-tone RU14, −1655, 26-tone RU15, 26-tone RU16, |
| | | | −1602, −1601, 26-tone RU17, 26-tone RU18, −1548] |
| | RU 3 | [−1524:−1283] | [−1524, 26-tone RU20, 26-tone RU21, −1471, −1470, 26-tone RU22, 26- |
| | | | tone RU23, −1417, 26-tone RU24, −1390, 26-tone RU25, 26-tone RU26, |
| | | | −1337, −1336, 26-tone RU27, 26-tone RU28, −1283] |
| | RU 4 | [−1277:−1036] | [−1277, 26-tone RU29, 26-tone RU30, −1224, −1223, 26-tone RU31, 26- |
| | | | tone RU32, −1170, 26-tone RU33, −1143, 26-tone RU34, 26-tone RU35, |
| | | | −1090, −1089, 26-tone RU36, 26-tone RU37, −1036] |
| | RU 5 | [−1012:−771] | [−1012, 26-tone RU38, 26-tone RU39, −959, −958, 26-tone RU40, 26-tone |
| | | | RU41, −905, 26-tone RU42, −878, 26-tone RU43, 26-tone RU44, −825, |
| | | | −824, 26-tone RU45, 26-tone RU46, −771] |
| | RU 6 | [−765:−524] | [−765, 26-tone RU47, 26-tone RU48, −712, −711, 26-tone RU49, 26-tone |
| | | | RU50, −658, 26-tone RU51, −631, 26-tone RU52, 26-tone RU53, −578, |
| | | | −577, 26-tone RU54, 26-tone RU55, −524] |
| | RU 7 | [−500:−259] | [−500, 26-tone RU57, 26-tone RU58, −447, −446, 26-tone RU59, 26-tone |
| | | | RU60, −393, 26-tone RU61, −366, 26-tone RU62, 26-tone RU63, −313, |
| | | | −312, 26-tone RU64, 26-tone RU65, −259] |
| | RU 8 | [−253:−12] | [−253, 26-tone RU66, 26-tone RU67, −200, −199, 26-tone RU68, 26-tone |
| | | | RU69, −146, 26-tone RU70, −119, 26-tone RU71, 26-tone RU72, −66, −65, |
| | | | 26-tone RU73, 26-tone RU74, −12] |
| | RU 9 | [12:253] | [12, 26-tone RU75, 26-tone RU76, 65, 66, 26-tone RU77, 26-tone RU78, |
| | | | 119, 26-tone RU79, 146, 26-tone RU80, 26-tone RU81, 199, 200, 26-tone |
| | | | RU82, 26-tone RU83, 253] |
| | RU 10 | [259:500] | [259, 26-tone RU84, 26-tone RU85, 312, 313, 26-tone RU86, 26-tone |
| | | | RU87, 366, 26-tone RU88, 393, 26-tone RU89, 26-tone RU90, 446, |
| | | | 447, 26-tone RU91, 26-tone RU92, 500] |
| | RU 11 | [524:765] | [524, 631, 26-tone RU94, 26-tone RU95, 577, 578, 26-tone RU96, 26- |
| | | | tone RU97, 631, 26-tone RU98, 658, 26-tone RU99, 26-tone RU100, 711, |
| | | | 712, 26-tone RU101, 26-tone RU102, 765] |
| | RU 12 | [771:1012] | [771, 26-tone RU103, 26-tone RU104, 824, 825, 26-tone RU105, 26-tone |
| | | | RU106, 878, 26-tone RU107, 905, 26-tone RU108, 26-tone |
| | | | RU109, 958, 959, 26-tone RU110, 26-tone RU111, 1012] |
| | RU 13 | [1036:1277] | [1036, 26-tone RU112, 26-tone RU113, 1089, 1090, 26-tone RU114, 26- |
| | | | tone RU115, 1143, 26-tone RU116, 1170, 26-tone RU117, 26-tone |
| | | | RU118, 1223, 1224, 26-tone RU119, 26-tone RU120, 1277] |
| | RU 14 | [1283:1524] | [1283, 26-tone RU121, 26-tone RU122, 1336, 1337, 26-tone RU123, 26- |
| | | | tone RU124, 1390, 26-tone RU125, 1417, 26-tone RU126, 26-tone |
| | | | RU127, 1470, 1471, 26-tone RU128, 26-tone RU129, 1524] |
| | RU 15 | [1548:1789] | [1548, 26-tone RU131, 26-tone RU132, 1601, 1602, 26-tone RU133, 26- |
| | | | tone RU134, 1655, 26-tone RU135, 1682, 26-tone RU136, 26-tone |
| | | | RU137, 1735, 1736, 26-tone RU138, 26-tone RU139, 1789] |
| | RU 16 | [1795:2036] | [1795, 26-tone RU140, 26-tone RU141, 1848, 1849, 26-tone RU142, 26- |
| | | | tone RU143, 1902, 26-tone RU144, 1929, 26-tone RU145, 26-tone |
| | | | RU146, 1982, 1983, 26-tone RU147, 26-tone RU148, 2036] |
| 484-tone | RU 1 | [−2036:−1795, | [−2036, 26-tone RU1, 26-tone RU2, −1983, −1982, 26-tone RU3, 26-tone |
| RU | | −1789:−1548] | RU4, −1929, 26-tone RU5, −1902, 26-tone RU6, 26-tone RU7, −1849, |
| | | | −1848, 26-tone RU8, 26-tone RU9, −1795, −1789, 26-tone RU10, 26-tone |
| | | | RU11, −1736, −1735, 26-tone RU12, 26-tone RU13, −1682, 26-tone |
| | | | RU14, −1655, 26-tone RU15, 26-tone RU16, −1602, −1601, 26-tone RU17, |
| | | | 26-tone RU18, −1548] |
| | RU 2 | [−1524:−1283, | [−1524, 26-tone RU20, 26-tone RU21, −1471, −1470, 26-tone RU22, 26- |
| | | −1277:−1036] | tone RU23, −1417, 26-tone RU24, −1390, 26-tone RU25, 26-tone RU26, |
| | | | −1337, −1336, 26-tone RU27, 26-tone RU28, −1283, −1277, 26-tone RU29, |
| | | | 26-tone RU30, −1224, −1223, 26-tone RU31, 26-tone RU32, −1170, 26- |
| | | | tone RU33, −1143, 26-tone RU34, 26-tone RU35, −1090, −1089, 26-tone |
| | | | RU36, 26-tone RU37, −1036] |
| | RU 3 | [−1012:−771, | [−1012, 26-tone RU38, 26-tone RU39, −959, −958, 26-tone RU40, 26-tone |
| | | −765:−524] | RU41, −905, 26-tone RU42, −878, 26-tone RU43, 26-tone RU44, −825, |
| | | | −824, 26-tone RU45, 26-tone RU46, −771, −765, 26-tone RU47, 26-tone |
| | | | RU48, −712, −711, 26-tone RU49, 26-tone RU50, −658, 26-tone RU51, |
| | | | −631, 26-tone RU52, 26-tone RU53, −578, −577, 26-tone RU54, 26-tone |
| | | | RU55, −524] |
| | RU 4 | [−500:−259, | [−500, 26-tone RU57, 26-tone RU58, −447, −446, 26-tone RU59, 26-tone |
| | | −253:−12] | RU60, −393, 26-tone RU61, −366, 26-tone RU62, 26-tone RU63, −313, |
| | | | −312, 26-tone RU64, 26-tone RU65, −259, −253, 26-tone RU66, 26-tone |
| | | | RU67, −200, −199, 26-tone RU68, 26-tone RU69, −146, 26-tone RU70, |
| | | | −119, 26-tone RU71, 26-tone RU72, −66, −65, 26-tone RU73, 26-tone |
| | | | RU74, −12] |
| | RU 5 | [12:253, | [12, 26-tone RU75, 26-tone RU76, 65, 66, 26-tone RU77, 26-tone RU78, |
| | | 259:500] | 119, 26-tone RU79, 146, 26-tone RU80, 26-tone RU81, 199, 200, 26-tone |
| | | | RU82, 26-tone RU83, 253, 259, 26-tone RU84, 26-tone RU85, 312, |
| | | | 313, 26-tone RU86, 26-tone RU87, 366, 26-tone RU88, 393, 26-tone |
| | | | RU89, 26-tone RU90, 446, 447, 26-tone RU91, 26-tone RU92, 500] |
| | RU 6 | [524:765, | [524, 631, 26-tone RU94, 26-tone RU95, 577, 578, 26-tone RU96, 26- |
| | | 771:1012] | tone RU97, 631, 26-tone RU98, 658, 26-tone RU99, 26-tone RU100, 711, |
| | | | 712, 26-tone RU101, 26-tone RU102, 765, 771, 26-tone RU103, 26-tone |
| | | | RU104, 824, 825, 26-tone RU105, 26-tone RU106, 878, 26-tone |
| | | | RU107, 905, 26-tone RU108, 26-tone RU109, 958, 959, 26-tone RU110, |
| | | | 26-tone RU111, 1012] |
| | RU 7 | [1036:1277, | [1036, 26-tone RU112, 26-tone RU113, 1089, 1090, 26-tone RU114, 26- |
| | | 1283:1524] | tone RU115, 1143, 26-tone RU116, 1170, 26-tone RU117, 26-tone |
| | | | RU118, 1223, 1224, 26-tone RU119, 26-tone RU120, 1277, 1283, 26- |
| | | | tone RU121, 26-tone RU122, 1336, 1337, 26-tone RU123, 26-tone |
| | | | RU124, 1390, 26-tone RU125, 1417, 26-tone RU126, 26-tone RU127, |
| | | | 1470, 1471, 26-tone RU128, 26-tone RU129, 1524] |
| | RU 8 | [1548:1789, | [1548, 26-tone RU131, 26-tone RU132, 1601, 1602, 26-tone RU133, 26- |
| | | 1795:2036] | tone RU134, 1655, 26-tone RU135, 1682, 26-tone RU136, 26-tone |
| | | | RU137, 1735, 1736, 26-tone RU138, 26-tone RU139, 1789, 1795, 26-tone |
| | | | RU140, 26-tone RU141, 1848, 1849, 26-tone RU142, 26-tone RU143, |
| | | | 1902, 26-tone RU144, 1929, 26-tone RU145, 26-tone RU146, 1982, |
| | | | 1983, 26-tone RU147, 26-tone RU148, 2036] |
| 996-tone | RU 1 | [−2036:−1539, | [−2036, 26-tone RU1, 26-tone RU2, −1983, −1982, 26-tone RU3, 26-tone |
| RU | | −1533:−1036] | RU4, −1929, 26-tone RU5, −1902, 26-tone RU6, 26-tone RU7, −1849, |
| | | | −1848, 26-tone RU8, 26-tone RU9, −1795, −1794, −1793, −1792, −1791, |
| | | | −1790, −1789, 26-tone RU10, 26-tone RU11, −1736, −1735, 26-tone RU12, |
| | | | 26-tone RU13, −1682, 26-tone RU14, −1655, 26-tone RU15, 26-tone |
| | | | RU16, −1602, −1601, 26-tone RU17, 26-tone RU18, −1548, −1547, −1546, |
| | | | −1545, −1544, −1543, −1542, −1541, −1540, −1539, −1533, −1532, −1531, |
| | | | −1530, −1529, −1528, −1527, −1526, −1525, −1524, 26-tone RU20, 26-tone |
| | | | RU21, −1471, −1470, 26-tone RU22, 26-tone RU23, −1417, 26-tone RU24, |
| | | | −1390, 26-tone RU25, 26-tone RU26, −1337, −1336, 26-tone RU27, 26- |
| | | | tone RU28, −1283, −1282, −1281, −1280, −1279, −1278, −1277, 26-tone |
| | | | RU29, 26-tone RU30, −1224, −1223, 26-tone RU31, 26-tone RU32, −1170, |
| | | | 26-tone RU33, −1143, 26-tone RU34, 26-tone RU35, −1090, −1089, 26- |
| | | | tone RU36, 26-tone RU37, −1036] |
| | RU 2 | [−1012:−515, | [−1012, 26-tone RU38, 26-tone RU39, −959, −958, 26-tone RU40, 26-tone |
| | | −509:−12] | RU41, −905, 26-tone RU42, −878, 26-tone RU43, 26-tone RU44, −825, |
| | | | −824, 26-tone RU45, 26-tone RU46, −771, −770, −769, −768, −767, −766, |
| | | | −765, 26-tone RU47, 26-tone RU48, −712, −711, 26-tone RU49, 26-tone |
| | | | RU50, −658, 26-tone RU51, −631, 26-tone RU52, 26-tone RU53, −578, |
| | | | −577, 26-tone RU54, 26-tone RU55, −524, −523, −522, −521, −520, −519, |
| | | | −518, −517, −516, −515, −509, −508, −507, −506, −505, −504, −503, −502, |
| | | | −501, −500, 26-tone RU57, 26-tone RU58, −447, −446, 26-tone RU59, 26- |
| | | | tone RU60, −393, 26-tone RU61, −366, 26-tone RU62, 26-tone RU63, |
| | | | −313, −312, 26-tone RU64, 26-tone RU65, −259, −258, −257, −256, −255, |
| | | | −254, −253, 26-tone RU66, 26-tone RU67, −200, −199, 26-tone RU68, 26- |
| | | | tone RU69, −146, 26-tone RU70, −119, 26-tone RU71, 26-tone RU72, |
| | | | −66, −65, 26-tone RU73, 26-tone RU74, −12] |
| | RU 3 | [12:509, | [12, 26-tone RU75, 26-tone RU76, 65, 66, 26-tone RU77, 26-tone RU78, |
| | | 515:1012] | 119, 26-tone RU79, 146, 26-tone RU80, 26-tone RU81, 199, 200, 26-tone |
| | | | RU82, 26-tone RU83, 253, 254, 255, 256, 257, 258, 259, 26-tone RU84, |
| | | | 26-tone RU85, 312, 313, 26-tone RU86, 26-tone RU87, 366, 26-tone |
| | | | RU88, 393, 26-tone RU89, 26-tone RU90, 446, 447, 26-tone RU91, 26- |
| | | | tone RU92, 500, 501, 502, 503, 504, 505, 506, 507, 508, 509, 515, 516, |
| | | | 517, 518, 519, 520, 521, 522, 523, 524, 26-tone RU94, 26-tone RU95, |
| | | | 577, 578, 26-tone RU96, 26-tone RU97, 631, 26-tone RU98, 658, 26-tone |
| | | | RU99, 26-tone RU100, 711, 712, 26-tone RU101, 26-tone RU102, 765, |
| | | | 766, 767, 768, 769, 770, 771, 26-tone RU103, 26-tone |
| | | | RU104, 824, 825, 26-tone RU105, 26-tone RU106, 878, 26-tone |
| | | | RU107, 905, 26-tone RU108, 26-tone RU109, 958, 959, 26-tone RU110, |
| | | | 26-tone RU111, 1012] |
| | RU 4 | [1036:1533, | [1036, 26-tone RU112, 26-tone RU113, 1089, 1090, 26-tone RU114, 26- |
| | | 1539:2036] | tone RU115, 1143, 26-tone RU116, 1170, 26-tone RU117, 26-tone |
| | | | RU118, 1223, 1224, 26-tone RU119, 26-tone RU120, 1277, 1278, 1279, |
| | | | 1280, 1281, 1282, 1283, 26-tone RU121, 26-tone RU122, 1336, 1337, |
| | | | 26-tone RU123, 26-tone RU124, 1390, 26-tone RU125, 1417, 26-tone |
| | | | RU126, 26-tone RU127, 1470, 1471, 26-tone RU128, 26-tone RU129, |
| | | | 1524, 1525, 1526, 1527, 1528, 1529, 1530, 1531, 1532, 1533, 1539, 1540, |
| | | | 1541, 1542, 1543, 1544, 1545, 1546, 1547, 1548, 26-tone RU131, 26- |
| | | | tone RU132, 1601, 1602, 26-tone RU133, 26-tone RU134, 1655, 26-tone |
| | | | RU135, 1682, 26-tone RU136, 26-tone RU137, 1735, 1736, 26-tone |
| | | | RU138, 26-tone RU139, 1789, 1790, 1791, 1792, 1793, 1794, 1795, 26- |
| | | | tone RU140, 26-tone RU141, 1848, 1849, 26-tone RU142, 26-tone RU143, |
| | | | 1902, 26-tone RU144, 1929, 26-tone RU145, 26-tone RU146, 1982, |
| | | | 1983, 26-tone RU147, 26-tone RU148, 2036] |
| 2 × | RU 1 | [−2036:−1539, | [−2036, 26-tone RU1, 26-tone RU2, −1983, −1982, 26-tone RU3, 26-tone |
| 996-tone | | −1533:−1036, | RU4, −1929, 26-tone RU5, −1902, 26-tone RU6, 26-tone RU7, −1849, |
| RU | | −1012:−515, | −1848, 26-tone RU8, 26-tone RU9, −1795, −1794, −1793, −1792, −1791, |
| | | −509:−12] | −1790, −1789, 26-tone RU10, 26-tone RU11, −1736, −1735, 26-tone RU12, |
| | | | 26-tone RU13, −1682, 26-tone RU14, −1655, 26-tone RU15, 26-tone |
| | | | RU16, −1602, −1601, 26-tone RU17, 26-tone RU18, −1548, −1547, −1546, |
| | | | −1545, −1544, −1543, −1542, −1541, −1540, −1539, −1533, −1532, −1531, |
| | | | −1530, −1529, −1528, −1527, −1526, −1525, −1524, 26-tone RU20, 26-tone |
| | | | RU21, −1471, −1470, 26-tone RU22, 26-tone RU23, −1417, 26-tone RU24, |
| | | | −1390, 26-tone RU25, 26-tone RU26, −1337, −1336, 26-tone RU27, 26- |
| | | | tone RU28, −1283, −1282, −1281, −1280, −1279, −1278, −1277, 26-tone |
| | | | RU29, 26-tone RU30, −1224, −1223, 26-tone RU31, 26-tone RU32, −1170, |
| | | | 26-tone RU33, −1143, 26-tone RU34, 26-tone RU35, −1090, −1089, 26- |
| | | | tone RU36, 26-tone RU37, −1036, −1012, 26-tone RU38, 26-tone RU39, |
| | | | −959, −958, 26-tone RU40, 26-tone RU41, −905, 26-tone RU42, −878, 26- |
| | | | tone RU43, 26-tone RU44, −825, −824, 26-tone RU45, 26-tone RU46, |
| | | | −771, −770, −769, −768, −767, −766, −765, 26-tone RU47, 26-tone RU48, |
| | | | −712, −711, 26-tone RU49, 26-tone RU50, −658, 26-tone RU51, −631, 26- |
| | | | tone RU52, 26-tone RU53, −578, −577, 26-tone RU54, 26-tone RU55, −524, |
| | | | −523, −522, −521, −520, −519, −518, −517, −516, −515, −509, −508, −507, |
| | | | −506, −505, −504, −503, −502, −501, −500, 26-tone RU57, 26-tone RU58, |
| | | | −447, −446, 26-tone RU59, 26-tone RU60, −393, 26-tone RU61, −366, 26- |
| | | | tone RU62, 26-tone RU63, −313, −312, 26-tone RU64, 26-tone RU65, |
| | | | −259, −258, −257, −256, −255, −254, −253, 26-tone RU66, 26-tone RU67, |
| | | | −200, −199, 26-tone RU68, 26-tone RU69, −146, 26-tone RU70, −119, 26- |
| | | | tone RU71, 26-tone RU72, −66, −65, 26-tone RU73, 26-tone RU74, −12] |
| | RU 2 | [12:509, | [12, 26-tone RU75, 26-tone RU76, 65, 66, 26-tone RU77, 26-tone RU78, |
| | | 515:1012, | 119, 26-tone RU79, 146, 26-tone RU80, 26-tone RU81, 199, 200, 26-tone |
| | | 1036:1533, | RU82, 26-tone RU83, 253, 254, 255, 256, 257, 258, 259, 26-tone RU84, |
| | | 1539:2036] | 26-tone RU85, 312, 313, 26-tone RU86, 26-tone RU87, 366, 26-tone |
| | | | RU88, 393, 26-tone RU89, 26-tone RU90, 446, 447, 26-tone RU91, 26- |
| | | | tone RU92, 500, 501, 502, 503, 504, 505, 506, 507, 508, 509, 515, 516, |
| | | | 517, 518, 519, 520, 521, 522, 523, 524, 26-tone RU94, 26-tone RU95, |
| | | | 577, 578, 26-tone RU96, 26-tone RU97, 631, 26-tone RU98, 658, 26-tone |
| | | | RU99, 26-tone RU100, 711, 712, 26-tone RU101, 26-tone RU102, 765, |
| | | | 766, 767, 768, 769, 770, 771, 26-tone RU103, 26-tone |
| | | | RU104, 824, 825, 26-tone RU105, 26-tone RU106, 878, 26-tone RU107, |
| | | | 905, 26-tone RU108, 26-tone RU109, 958, 959, 26-tone RU110, 26-tone |
| | | | RU111, 1012, 1036, 26-tone RU112, 26-tone RU113, 1089, 1090, 26-tone |
| | | | RU114, 26-tone RU115, 1143, 26-tone RU116, 1170, 26-tone RU117, |
| | | | 26-tone RU118, 1223, 1224, 26-tone RU119, 26-tone RU120, 1277, |
| | | | 1278, 1279, 1280, 1281, 1282, 1283, 26-tone RU121, 26-tone RU122, |
| | | | 1336, 1337, 26-tone RU123, 26-tone RU124, 1390, 26-tone RU125, |
| | | | 1417, 26-tone RU126, 26-tone RU127, 1470, 1471, 26-tone RU128, 26- |
| | | | tone RU129, 1524, 1525, 1526, 1527, 1528, 1529, 1530, 1531, 1532, |
| | | | 1533, 1539, 1540, 1541, 1542, 1543, 1544, 1545, 1546, 1547, 1548, 26- |
| | | | tone RU131, 26-tone RU132, 1601, 1602, 26-tone RU133, 26-tone RU134, |
| | | | 1655, 26-tone RU135, 1682, 26-tone RU136, 26-tone RU137, 1735, |
| | | | 1736, 26-tone RU138, 26-tone RU139, 1789, 1790, 1791, 1792, 1793, |
| | | | 1794, 1795, 26-tone RU140, 26-tone RU141, 1848, 1849, 26-tone RU142, |
| | | | 26-tone RU143, 1902, 26-tone RU144, 1929, 26-tone RU145, 26-tone |
| | | | RU146, 1982, 1983, 26-tone RU147, 26-tone RU148, 2036] |

Note:
An undermarked tone index indicates a tone that does not participate in the one-shot distributed tone mapping.

### 5.2 Construction of a Logical RU in Two-Shot Distributed Tone Mapping

Example 14: Construction of different types of logical RUs by using logical tones obtained by the two-shot distributed tone mapping is shown.

In Example 14, Table 8 to Table 11 respectively indicate construction of a logical RU within bandwidths of 40 MHz, 80 MHz, 160 MHz, and 320 MHz.

TABLE 8
Construction of a logical RU within a bandwidth of 40 MHz

| Logical | Logical | Logical tone | |
|---|---|---|---|
| RU | RU | index of a | |
| type | index | logical RU | Physical tone index of a logical RU |
| 26- | RU 1 | [−243: −218] | [−86, −159, −190, −84, −157, −239, −73, |
| tone | | | −155, −228, −62, −153, −226, −60, 87, 14, 180, 89, |
| RU | | | 16, 182, 100, 18, 184, 112, 20, 186, 114] |
| | RU 2 | [−217: −192] | [−234, −68, −141, −232, −66, −139, −221, |
| | | | −53, −136, −210, −42, −134, −208, −40, 105, |
| | | | 32, 200, 107, 34, 202, 119, 36, 204, 130, 38, 206] |
| | RU 3 | [−189: −164] | [−48, −122, −214, −46, −120, −203, −35, |
| | | | −118, −192, −24, −116, −188, −22, 124, 50, 218, |
| | | | 126, 52, 220, 138, 54, 222, 149, 58, 224, 151] |
| | RU 4 | [−163: −138] | [−198, −30, −103, −196, −28, −101, −183, |
| | | | −17, −99, −172, −6, −97, −170, −4, 143, 70, |
| | | | 236, 145, 72, 238, 156, 74, 240, 167, 76, 242] |
| | RU 5 | [−136: −111] | [−178, −12, −85, −176, −10, −83, −165, |
| | | | −110, −81, −154, −56, −79, −152, 3, 161, 88, 57, |
| | | | 163, 90, 8, 174, 92, 19, 185, 94, 21] |
| | RU 6 | [−109: −84] | [−160, −233, −67, −158, −231, −65, −147, |
| | | | −229, −63, −135, −227, −61, −133, 13, 179, 106, 15, |
| | | | 181, 108, 26, 194, 111, 37, 205, 113, 39] |
| | RU 7 | [−83: −58] | [207, −142, −215, −47, −140, −213, −45, |
| | | | −128, −211, −43, −117, −209, −41, −115, 31, |
| | | | 199, 125, 33, 201, 127, 44, 212, 129, 55, 223, 131] |
| | RU 8 | [−55: −30] | [−123, −197, −29, −121, −195, −27, −109, |
| | | | −193, −25, −98, −189, −23, −96, 49, 217, 144, 51, |
| | | | 219, 146, 64, 230, 148, 75, 241, 150, 77] |
| | RU 9 | [−29: −4] | [243, −104, −177, −11, −102, −175, −9, −91, |
| | | | −173, −7, −80, −171, −5, −78, 69, 235, 162, 71, |
| | | | 237, 164, 82, 137, 166, 93, 191, 168] |
| | RU 10 | [4: 29] | [−77, −150, −241, −75, −148, −230, −64, |
| | | | −146, −219, −51, −144, −217, −49, 96, 23, 189, |
| | | | 98, 25, 193, 109, 27, 195, 121, 29, 197, 123] |
| | RU 11 | [30: 55] | [−225, −59, −131, −223, −55, −129, −212, |
| | | | −44, −127, −201, −33, −125, −199, −31, 115, |
| | | | 41, 209, 117, 43, 211, 128, 45, 213, 140, 47, 215] |
| | RU 12 | [58: 83] | [−39, −113, −205, −37, −111, −194, −26, |
| | | | −108, −181, −15, −106, −179, −13, 133, 61, 227, |
| | | | 135, 63, 229, 147, 65, 231, 158, 67, 233, 160] |
| | RU 13 | [84: 109] | [−187, −21, −94, −185, −19, −92, −174, |
| | | | −8, −90, −163, −57, −88, −161, −3, 152, 79, |
| | | | 56, 154, 81, 110, 165, 83, 10, 176, 85, 12] |
| | RU 14 | [111: 136] | [−169, −242, −76, −167, −240, −74, −156, |
| | | | −238, −72, −145, −236, −70, −143, 4, 170, 97, 6, |
| | | | 172, 99, 17, 183, 101, 28, 196, 103, 30] |
| | RU 15 | [138: 163] | [−151, −224, −58, −149, −222, −54, −138, |
| | | | −220, −52, −126, −218, −50, −124, 22, 188, 116, |
| | | | 24, 192, 118, 35, 203, 120, 46, 214, 122, 48] |
| | RU 16 | [164: 189] | [216, −132, −206, −38, −130, −204, −36, −119, |
| | | | −202, −34, −107, −200, −32, −105, 40, 208, 134, |
| | | | 42, 210, 136, 53, 221, 139, 66, 232, 141] |
| | RU 17 | [192: 217] | [−114, −186, −20, −112, −184, −18, −100, |
| | | | −182, −16, −89, −180, −14, −87, 60, 226, 153, |
| | | | 62, 228, 155, 73, 239, 157, 84, 190, 159, 86] |
| | RU 18 | [218: 243] | [244, −95, −168, −191, −93, −166, −137, −82, |
| | | | −164, −237, −71, −162, −235, −69, 78, 5, 171, 80, |
| | | | 7, 173, 91, 9, 175, 102, 11, 177] |
| 52- | RU 1 | [−243: −192] | [26-tone RU1, 26-tone RU2] |
| tone | RU 2 | [−189: −138] | [26-tone RU3, 26-tone RU4] |
| RU | RU 3 | [−109: −58] | [26-tone RU6, 26-tone RU7] |
| | RU 4 | [−55: −4] | [26-tone RU8, 26-tone RU9] |
| | RU 5 | [4: 55] | [26-tone RU10, 26-tone RU11] |
| | RU 6 | [58: 109] | [26-tone RU12, 26-tone RU13] |
| | RU 7 | [138: 189] | [26-tone RU15, 26-tone RU16] |
| | RU 8 | [192: 243] | [26-tone RU17, 26-tone RU18] |
| 106- | RU 1 | [−243: −138] | [26-tone RU1, 26-tone RU2, 132, −216, 26-tone RU3, 26-tone RU4] |
| tone | RU 2 | [−109: −4] | [26-tone RU6, 26-tone RU7, 59, 225, 26-tone RU8, 26-tone RU9] |
| RU | RU 3 | [4: 109] | [26-tone RU10, 26-tone RU11, 142, −207, 26-tone RU12, 26-tone RU13] |
| | RU 4 | [138: 243] | [26-tone RU15, 26-tone RU16, 68, 234, 26-tone RU17, 26-tone RU18] |
| 242- | RU 1 | [−244: −3] | [−244, 26-tone RU1, 26-tone RU2, 132, −216, 26-tone RU3, |
| tone | | | 26-tone RU4, 169, 26-tone RU 5, 187, 26-tone RU6, 26-tone RU7, 59, 225, |
| RU | | | 26-tone RU8, 26-tone RU9, 95] |
| | RU 2 | [3: 244] | [3, 26-tone RU10, 26-tone RU11, 142, −207, 26-tone RU12, 26-tone RU13, |
| | | | 178, 26-tone RU 14, 198, 26-tone RU15, 26-tone RU16, 68, 234, 26-tone |
| | | | RU17, 26-tone RU18, 104] |

TABLE 9
Construction of a logical RU within a bandwidth of 80 MHz

| Logical | Logical | Logical tone | |
|---|---|---|---|
| RU | RU | index of a | |
| type | index | logical RU | Physical tone index of a logical RU |
| 26- | RU 1 | [−499: −474] | [−398, −286, −415, −303, −452, −340, −469, −357, |
| tone | | | −495, −384, −273, −411, −299, −428, −318, −465, |
| RU | | | −353, −482, −371, −260, −169, −57, −186, −76, |
| | | | −223, −111] |
| | RU 2 | [−473: −448] | [−240, −129, −18, −156, −44, −182, −72, −201, |
| | | | −89, −236, −125, −14, −142, −31, 78, 188, 59, 171, 24, |
| | | | 135, 246, 117, 229, 91, 203, 63] |
| | RU 3 | [−445: −420] | [158, 200, 122, 233, 104, 216, 305, 417, 288, 400, 313, 363, 475, 346, 458, |
| | | | 320, 430, 292, 404, 275, 386, 497, 350, 462, 333, 443] |
| | RU 4 | [−419: −394] | [−472, −360, −489, −378, −267, −414, −302, −431, |
| | | | −321, −459, −347, −485, −374, −263, −391, −280, |
| | | | −427, −317, −444, −334, −243, −132, −21, −150, −38, |
| | | | −185] |
| | RU 5 | [−392: −367] | [−204, −92, −230, −118, −119, −145, −34, −163, |
| | | | −51, −198, −88, −217, −105, 12, 114, 226, 97, 209, 60, 172, |
| | | | 43, 155, 17, 128, 239, 101] |
| | RU 6 | [−365: −340] | [84, 194, 47, 159, 30, 141, 252, 343, 455, 326, 436, 289, 401, 272, 383, 494, |
| | | | 356, 468, 330, 440, 311, 423, 276, 387, 498, 370] |
| | RU 7 | [−339: −314] | [481, −434, −324, −453, −341, −488, −377, −266, |
| | | | −395, −283, −421, −309, −449, −337, −466, −354, |
| | | | −312, −390, −279, −408, −296, −207, −95, −224, −112, |
| | | | −199] |
| | RU 8 | [−311: −286] | [−166, −54, −192, −82, −220, −108, −237, −126, |
| | | | −15, −162, −50, −179, −69, 40, 152, 23, 134, 245, 98, 210, 81, |
| | | | 191, 53, 165, 27, 138] |
| | RU 9 | [−285: −260] | [249, 121, 232, 85, 195, 68, 178, 269, 380, 491, 362, 474, 327, 437, 308, 420, |
| | | | 282, 394, 393, 367, 478, 349, 461, 314, 424, 295] |
| | RU 10 | [−252: −227] | [−388, −277, −406, −294, −441, −331, −460, −348, |
| | | | −486, −375, −264, −402, −290, −419, −307, −456, |
| | | | −344, −473, −361, −259, −160, −48, −177, −67, −214, |
| | | | −102] |
| | RU 11 | [−226: −201] | [−231, −120, −146, −147, −35, −173, −61, −190, |
| | | | −80, −227, −115, −244, −133, −22, 87, 197, 70, 180, 33, |
| | | | 144, 16, 127, 238, 100, 212, 74] |
| | RU 12 | [−198: −173] | [167, 20, 131, 242, 113, 225, 316, 426, 297, 409, 262, 373, 484, 355, 467, |
| | | | 329, 439, 301, 413, 284, 396, 446, 359, 471, 342, 454] |
| | RU 13 | [−172: −147] | [−463, −351, −480, −369, −447, −405, −293, −422, |
| | | | −310, −450, −338, −476, −364, −493, −382, −271, |
| | | | −418, −306, −435, −325, −234, −123, −251, −140, −29, |
| | | | −176] |
| | RU 14 | [−145: −120] | [−193, −83, −221, −109, −247, −136, −25, −154, |
| | | | −42, −189, −79, −208, −96, 13, 124, 235, 106, 218, 71, 181, 52, |
| | | | 164, 26, 137, 248, 110] |
| | RU 15 | [−118: −93] | [93, 205, 56, 168, 39, 151, 253, 352, 464, 335, 445, 298, 410, 281, 392, 366, |
| | | | 365, 477, 339, 451, 322, 432, 285, 397, 268, 379] |
| | RU 16 | [−92: −67] | [490, −425, −315, −442, −332, −479, −368, −496, |
| | | | −385, −274, −412, −300, −438, −328, −457, −345, −492, |
| | | | −381, −270, −399, −287, −196, −86, −215, −103, −250] |
| | RU 17 | [−64: −39] | [−157, −45, −183, −73, −211, −99, −228, −116, |
| | | | −66, −153, −41, −170, −58, 49, 161, 32, 143, 65, 107, 219, 90, |
| | | | 202, 62, 174, 36, 148] |
| | RU 18 | [−38: −13] | [19, 130, 241, 94, 206, 77, 187, 278, 389, 261, 372, 483, 336, 448, 319, 429, |
| | | | 291, 403, 265, 376, 487, 358, 470, 323, 433, 304] |
| | RU 19 | [not defined] | |
| | RU 20 | [13: 38] | [−379, −268, −397, −285, −432, −322, −451, −339, |
| | | | −477, −365, −366, −392, −281, −410, −298, −445, −335, |
| | | | −464, −352, −253, −151, −39, −168, −56, −205, −93] |
| | RU 21 | [39: 64] | [−222, −110, −248, −137, −26, −164, −52, −181, |
| | | | −71, −218, −106, −235, −124, −13, 96, 208, 79, 189, 42, 154, |
| | | | 25, 136, 247, 109, 221, 83] |
| | RU 22 | [67: 92] | [176, 29, 140, 251, 123, 234, 325, 435, 306, 418, 271, 382, 493, 364, 476, 338, |
| | | | 450, 310, 422, 293, 405, 447, 369, 480, 351, 463] |
| | RU 23 | [93: 118] | [−454, −342, −471, −359, −446, −396, −284, −413, |
| | | | −301, −439, −329, −467, −355, −484, −373, −262, −409, |
| | | | −297, −426, −316, −225, −113, −242, −131, −20, −167] |
| | RU 24 | [120: 145] | [−184, −74, −212, −100, −238, −127, −16, −144, |
| | | | −33, −180, −70, −197, −87, 22, 133, 244, 115, 227, 80, 190, 61, 173, |
| | | | 35, 147, 146, 120] |
| | RU 25 | [147: 172] | [102, 214, 67, 177, 48, 160, 259, 361, 473, 344, 456, 307, 419, 290, 402, 264, |
| | | | 375, 486, 348, 460, 331, 441, 294, 406, 277, 388] |
| | RU 26 | [173: 198] | [499, −416, −304, −433, −323, −470, −358, −487, −376, |
| | | | −265, −403, −291, −429, −319, −448, −336, −483, −372, |
| | | | −261, −389, −278, −187, −77, −206, −94, −241] |
| | RU 27 | [201: 226] | [−148, −36, −174, −62, −202, −90, −219, −107, −65, |
| | | | −143, −32, −161, −49, 58, 170, 41, 153, 66, 116, 228, 99, 211, 73, |
| | | | 183, 45, 157] |
| | RU 28 | [227: 252] | [28, 139, 250, 103, 215, 86, 196, 287, 399, 270, 381, 492, 345, 457, 328, 438, |
| | | | 300, 412, 274, 385, 496, 368, 479, 332, 442, 315] |
| | RU 29 | [260: 285] | [−370, −498, −387, −276, −423, −311, −440, −330, −468, |
| | | | −356, −494, −383, −272, −401, −289, −436, −326, −455, |
| | | | −343, −252, −141, −30, −159, −47, −194, −84] |
| | RU 30 | [286: 311] | [−213, −101, −239, −128, −17, −155, −43, −172, −60, |
| | | | −209, −97, −226, −114, −12, 105, 217, 88, 198, 51, 163, 34, 145, |
| | | | 119, 118, 230, 92] |
| | RU 31 | [314: 339] | [185, 38, 150, 21, 132, 243, 334, 444, 317, 427, 280, 391, 263, 374, 485, 347, |
| | | | 459, 321, 431, 302, 414, 267, 378, 489, 360, 472] |
| | RU 32 | [340: 365] | [−443, −333, −462, −350, −497, −386, −275, −404, |
| | | | −292, −430, −320, −458, −346, −475, −363, −313, −400, |
| | | | −288, −417, −305, −216, −104, −233, −122, −200, −158] |
| | RU 33 | [367: 392] | [−175, −63, −203, −91, −229, −117, −246, −135, −24, |
| | | | −171, −59, −188, −78, 31, 142, 14, 125, 236, 89, 201, 72, 182, 44, |
| | | | 156, 18, 129] |
| | RU 34 | [394: 419] | [111, 223, 76, 186, 57, 169, 260, 371, 482, 353, 465, 318, 428, 299, 411, 273, |
| | | | 384, 495, 357, 469, 340, 452, 303, 415, 286, 398] |
| | RU 35 | [420: 445] | [500, −407, −295, −424, −314, −461, −349, −478, |
| | | | −367, −393, −394, −282, −420, −308, −437, −327, |
| | | | −474, −362, −491, −380, −269, −178, −68, −195, |
| | | | −85, −232] |
| | RU 36 | [448: 473] | [−138, −27, −165, −53, −191, −81, −210, −98, |
| | | | −245, −134, −23, −152, −40, 69, 179, 50, 162, 15, 126, 237, |
| | | | 108, 220, 82, 192, 54, 166] |
| | RU 37 | [474: 499] | [37, 149, 199, 112, 224, 95, 207, 296, 408, 279, 390, 312, 354, 466, 337, |
| | | | 449, 309, 421, 283, 395, 266, 377, 488, 341, 453, 324] |
| 52- | RU 1 | [−499: −448] | [26-tone RU1, 26-tone RU2] |
| tone | RU 2 | [−445: −394] | [26-tone RU3, 26-tone RU4] |
| RU | RU 3 | [−365: −314] | [26-tone RU6, 26-tone RU7] |
| | RU 4 | [−311: −260] | [26-tone RU8, 26-tone RU9] |
| | RU 5 | [−252: −201] | [26-tone RU10, 26-tone RU11] |
| | RU 6 | [−198: −147] | [26-tone RU12, 26-tone RU13] |
| | RU 7 | [−118: −67] | [26-tone RU15, 26-tone RU16] |
| | RU 8 | [−64: −13] | [26-tone RU17, 26-tone RU18] |
| | RU 9 | [13: 64] | [26-tone RU20, 26-tone RU21] |
| | RU 10 | [67: 118] | [26-tone RU22, 26-tone RU23] |
| | RU 11 | [147: 198] | [26-tone RU25, 26-tone RU26] |
| | RU 12 | [201: 252] | [26-tone RU27, 26-tone RU28] |
| | RU 13 | [260: 311] | [26-tone RU29, 26-tone RU30] |
| | RU 14 | [314: 365] | [26-tone RU31, 26-tone RU32] |
| | RU 15 | [394: 445] | [26-tone RU34, 26-tone RU35] |
| | RU 16 | [448: 499] | [26-tone RU36, 26-tone RU37] |
| 106- | RU 1 | [−499: −394] | [26-tone RU1, 26-tone RU2, 175, 46, 26-tone RU3, 26-tone RU4] |
| tone | RU 2 | [−365: −260] | [26-tone RU6, 26-tone RU7, −149, −37, 26-tone RU8, 26-tone RU9] |
| RU | RU 3 | [−252: −147] | [26-tone RU10, 26-tone RU11, 184, 55, 26-tone RU12, 26-tone RU13] |
| | RU 4 | [−118: −13] | [26-tone RU15, 26-tone RU16, −139, −28, 26-tone RU17, 26-tone RU18] |
| | RU 5 | [13: 118] | [26-tone RU20, 26-tone RU21, 193, 64, 26-tone RU22, 26-tone RU23] |
| | RU 6 | [147: 252] | [26-tone RU25, 26-tone RU26, −130, −19, 26-tone RU27, 26-tone RU28] |
| | RU 7 | [260: 365] | [26-tone RU29, 26-tone RU30, 204, 75, 26-tone RU31, 26-tone RU32] |
| | RU 8 | [394: 499] | [26-tone RU34, 26-tone RU35, −121, −249, 26-tone RU36, 26-tone RU37] |
| 242- | RU 1 | [−500: −259] | [−500, 26-tone RU1, 26-tone RU2, 175, 46, 26-tone RU3, 26-tone RU4, −75, |
| tone | | | 26-tone RU 5, −213, 26-tone RU6, 26-tone RU7, −149, −37, 26-tone RU8, |
| RU | | | 26-tone RU9, 407] |
| | RU 2 | [−253: −12] | [−499, 26-tone RU10, 26-tone RU11, 184, 55, 26-tone RU12, 26-tone RU13, |
| | | | −64, 26-tone RU14, 222, 26-tone RU15, 26-tone RU16, −139, −28, |
| | | | 26-tone RU17, 26-tone RU18, 416] |
| | RU 3 | [12: 253] | [−490, 26-tone RU20, 26-tone RU21, 193, 64, 26-tone RU22, 26-tone RU23, |
| | | | −55, 26-tone RU24, 231, 26-tone RU25, 26-tone RU26, −130, −19, |
| | | | 26-tone RU27, 26-tone RU28, 425] |
| | RU 4 | [259: 500] | [−481, 26-tone RU29, 26-tone RU30, 204, 75, 26-tone RU31, 26-tone RU32, |
| | | | −46, 26-tone RU 33, 240, 26-tone RU34, 26-tone RU35, −121, −249, |
| | | | 26-tone RU36, 26-tone RU37, 434] |
| 484- | RU 1 | [−500: −259, | [−500, 26-tone RU1, 26-tone RU2, 175, 46, 26-tone RU3, 26-tone RU4, −75, |
| tone | | −253: −12] | 26-tone RU 5, −213, 26-tone RU6, 26-tone RU7, −149, −37, 26-tone RU8, |
| RU | | | 26-tone RU9, 407, −499, 26-tone RU10, 26-tone RU11, 184, 55, 26-tone RU12, |
| | | | 26-tone RU13, −64, 26-tone RU14, 222, 26-tone RU15, 26-tone RU16, −139, |
| | | | −28, 26-tone RU17, 26-tone RU18, 416] |
| | RU 2 | [12: 253, | [−490, 26-tone RU20, 26-tone RU21, 193, 64, 26-tone RU22, 26-tone RU23, |
| | | 259: 500] | −55, 26-tone RU24, 231, 26-tone RU25, 26-tone RU26, −130, −19, |
| | | | 26-tone RU27, 26-tone RU28, 425, −481, 26-tone RU29, 26-tone RU30, 204, 75, |
| | | | 26-tone RU31, 26-tone RU32, −46, 26-tone RU 33, 240, 26-tone RU34, |
| | | | 26-tone RU35, −121, −249, 26-tone RU36, 26-tone RU37, 434] |

TABLE 10
Construction of a logical RU within a bandwidth of 160 MHz

| Logical | Logical | Logical tone | |
|---|---|---|---|
| RU | RU | index of a | |
| type | index | logical RU | Physical tone index of a logical RU |
| 26- | RU 1 | [−1011: −986] | [−946, −872, −798, −965, −890, −815, −1000, −926, |
| tone | | | −852, −778, −943, −869, −795, −971, −896, −821, −997, |
| RU | | | −923, −849, −775, −940, −866, −792, −977, −902, −829] |
| | RU 2 | [−985: −960] | [−994, −920, −846, −772, −719, −644, −569, −736, |
| | | | −662, −588, −711, −697, −623, −549, −716, −641, −566, |
| | | | −742, −668, −594, −631, −694, −620, −546, −713, −638] |
| | RU 3 | [−957: −932] | [−674, −600, −526, −691, −617, −543, −472, −398, |
| | | | −324, −489, −415, −341, −267, −452, −377, −302, −469, |
| | | | −395, −321, −495, −421, −347, −273, −449, −374, −299] |
| | RU 4 | [−931: −906] | [−466, −391, −318, −312, −427, −353, −279, −444, |
| | | | −371, −296, −243, −169, −95, −21, −186, −112, −38, |
| | | | −223, −149, −75, −240, −166, −92, −18, −192, −118] |
| | RU 5 | [−904: −879] | [−220, −145, −72, −237, −163, −89, −15, −198, −125, |
| | | | −50, −217, −142, −69, 12, 78, 152, 226, 59, 134, 209, 24, 98, |
| | | | 172, 246, 81, 155] |
| | RU 6 | [−877: −852] | [53, 128, 203, 27, 101, 175, 249, 84, 158, 232, 47, 122, 195, 30, |
| | | | 104, 178, 252, 305, 380, 455, 288, 362, 436, 313, 327, 401] |
| | RU 7 | [−851: −826] | [475, 308, 383, 458, 282, 356, 430, 393, 330, 404, 478, 311, 386, |
| | | | 461, 276, 350, 424, 498, 333, 407, 481, 552, 626, 700, 535, 609] |
| | RU 8 | [−823: −798] | [572, 647, 722, 555, 629, 703, 529, 603, 677, 751, 575, 650, 725, |
| | | | 558, 633, 706, 712, 597, 671, 745, 580, 653, 728, 781, 855, 929] |
| | RU 9 | [−797: −772] | [1003, 838, 912, 986, 801, 875, 949, 784, 858, 932, 1006, 832, |
| | | | 906, 980, 804, 879, 952, 787, 861, 935, 1009, 826, 899, 974, 807, |
| | | | 882] |
| | RU 10 | [−764: −739] | [−937, −863, −789, −954, −881, −806, −991, −917, |
| | | | −843, −1008, −934, −860, −786, −962, −887, −812, −988, |
| | | | −914, −840, −1005, −931, −857, −783, −968, −893, −818] |
| | RU 11 | [−738: −713] | [−985, −911, −837, −771, −708, −635, −560, −727, −652, |
| | | | −579, −762, −688, −614, −540, −705, −632, −557, −733, |
| | | | −659, −585, −759, −685, −611, −537, −702, −628] |
| | RU 12 | [−710: −685] | [−665, −591, −756, −682, −608, −534, −463, −388, −315, |
| | | | −480, −406, −332, −447, −441, −368, −293, −460, −385, |
| | | | −310, −486, −412, −338, −264, −438, −364, −290] |
| | RU 13 | [−684: −659] | [−457, −382, −307, −492, −418, −344, −270, −435, −361, |
| | | | −287, −234, −160, −86, −251, −177, −103, −29, −214, |
| | | | −139, −64, −231, −157, −83, −146, −183, −109] |
| | RU 14 | [−657: −632] | [−211, −136, −61, −228, −154, −80, −66, −189, −115, |
| | | | −41, −208, −133, −58, 13, 87, 161, 235, 70, 143, 218, 33, |
| | | | 107, 181, 16, 90, 164] |
| | RU 15 | [−630: −605] | [62, 137, 212, 36, 110, 184, 19, 93, 167, 241, 56, 131, 206, |
| | | | 39, 113, 187, 253, 316, 389, 464, 297, 372, 445, 262, 336, 410] |
| | RU 16 | [−604: −579] | [484, 319, 392, 467, 291, 365, 439, 265, 339, 413, 487, 322, |
| | | | 396, 470, 285, 359, 433, 268, 342, 416, 490, 561, 636, 709, 544, |
| | | | 618] |
| | RU 17 | [−576: −551] | [583, 656, 731, 564, 639, 714, 538, 612, 686, 760, 586, 660, |
| | | | 734, 567, 642, 717, 532, 606, 680, 754, 589, 663, 737, 790, 864, |
| | | | 938] |
| | RU 18 | [−550: −525] | [773, 847, 921, 995, 810, 885, 960, 793, 867, 941, 878, 841, |
| | | | 915, 989, 813, 888, 963, 796, 870, 944, 958, 835, 909, 983, 816, |
| | | | 891] |
| | RU 19 | [not defined] | |
| | RU 20 | [−499: −474] | [−928, −854, −780, −945, −871, −797, −982, −908, −834, |
| | | | −999, −925, −851, −777, −951, −877, −803, −979, −904, |
| | | | −831, −996, −922, −848, −774, −957, −884, −809] |
| | RU 21 | [−473: −448] | [−976, −901, −828, −765, −699, −625, −551, −718, −643, |
| | | | −568, −753, −679, −605, −531, −696, −622, −548, −724, |
| | | | −649, −574, −750, −676, −602, −528, −693, −619] |
| | RU 22 | [−445: −420] | [−655, −582, −747, −673, −599, −525, −454, −379, −304, |
| | | | −471, −397, −323, −446, −432, −358, −284, −451, −376, |
| | | | −301, −477, −403, −329, −365, −429, −355, −281] |
| | RU 23 | [−419: −394] | [−448, −373, −298, −483, −409, −335, −261, −426, −352, |
| | | | −278, −225, −151, −77, −242, −168, −94, −20, −205, |
| | | | −130, −55, −222, −148, −74, −248, −174, −100] |
| | RU 24 | [−392: −367] | [−202, −127, −52, −219, −144, −71, −65, −180, −106, |
| | | | −32, −197, −124, −49, 22, 96, 170, 244, 79, 153, 227, 42, |
| | | | 116, 190, 25, 99, 173] |
| | RU 25 | [−365: −340] | [73, 147, 221, 45, 120, 193, 28, 102, 176, 250, 67, 140, 215, 48, |
| | | | 123, 196, 259, 325, 399, 473, 306, 381, 456, 271, 345, 419] |
| | RU 26 | [−339: −314] | [493, 328, 402, 476, 300, 375, 450, 274, 348, 422, 496, 331, 405, |
| | | | 479, 294, 369, 442, 277, 351, 425, 499, 570, 645, 720, 553, 627] |
| | RU 27 | [−311: −286] | [592, 666, 740, 573, 648, 723, 547, 621, 695, 658, 595, 669, 743, |
| | | | 576, 651, 726, 541, 615, 689, 763, 598, 672, 746, 799, 873, 947] |
| | RU 28 | [−285: −260] | [782, 856, 930, 1004, 819, 894, 969, 802, 876, 950, 776, 850, 924, |
| | | | 998, 822, 897, 972, 805, 880, 953, 959, 844, 918, 992, 827, 900] |
| | RU 29 | [−252: −227] | [−919, −845, −1010, −936, −862, −788, −973, −898, −823, |
| | | | −990, −916, −842, −905, −942, −868, −794, −970, −895, |
| | | | −820, −987, −913, −839, −825, −948, −874, −800] |
| | RU 30 | [−226: −201] | [−967, −892, −817, −764, −690, −616, −542, −707, −634, |
| | | | −559, −744, −670, −596, −761, −687, −613, −539, −715, |
| | | | −640, −565, −741, −667, −593, −758, −684, −610] |
| | RU 31 | [−198: −173] | [−646, −571, −738, −664, −590, −524, −443, −370, −295, |
| | | | −462, −387, −314, −497, −423, −349, −275, −440, −367, |
| | | | −292, −468, −394, −320, −494, −420, −346, −272] |
| | RU 32 | [−172: −147] | [−437, −363, −289, −474, −400, −326, −491, −417, −343, |
| | | | −269, −216, −141, −68, −233, −159, −85, −200, −194, |
| | | | −121, −46, −213, −138, −63, −239, −165, −91] |
| | RU 33 | [−145: −120] | [−191, −117, −43, −210, −135, −60, −245, −171, −97, |
| | | | −23, −188, −114, −40, 31, 105, 179, 14, 88, 162, 236, 51, |
| | | | 126, 201, 34, 108, 182] |
| | RU 34 | [−118: −93] | [82, 156, 230, 54, 129, 204, 37, 111, 185, 199, 76, 150, 224, |
| | | | 57, 132, 207, 260, 334, 408, 482, 317, 390, 465, 280, 354, 428] |
| | RU 35 | [−92: −67] | [263, 337, 411, 485, 309, 384, 459, 283, 357, 431, 266, 340, |
| | | | 414, 488, 303, 378, 453, 286, 360, 434, 500, 581, 654, 729, 562, |
| | | | 637] |
| | RU 36 | [−64: −39] | [601, 675, 749, 584, 657, 732, 556, 630, 704, 530, 604, 678, |
| | | | 752, 587, 661, 735, 550, 624, 698, 533, 607, 681, 755, 808, 883, |
| | | | 956] |
| | RU 37 | [−38: −13] | [791, 865, 939, 824, 830, 903, 978, 811, 886, 961, 785, 859, |
| | | | 933, 1007, 833, 907, 981, 814, 889, 964, 779, 853, 927, 1001, 836, |
| | | | 910] |
| | RU 38 | [13: 38] | [−910, −836, −1001, −927, −853, −779, −964, −889, −814, |
| | | | −981, −907, −833, −1007, −933, −859, −785, −961, −886, |
| | | | −811, −978, −903, −830, −824, −939, −865, −791] |
| | RU 39 | [39: 64] | [−956, −883, −808, −755, −681, −607, −533, −698, −624, |
| | | | −550, −735, −661, −587, −752, −678, −604, −530, −704, |
| | | | −630, −556, −732, −657, −584, −749, −675, −601] |
| | RU 40 | [67: 92] | [−637, −562, −729, −654, −581, −500, −434, −360, −286, |
| | | | −453, −378, −303, −488, −414, −340, −266, −431, −357, |
| | | | −283, −459, −384, −309, −485, −411, −337, −263] |
| | RU 41 | [93: 118] | [−428, −354, −280, −465, −390, −317, −482, −408, −334, |
| | | | −260, −207, −132, −57, −224, −150, −76, −199, −185, −111, |
| | | | −37, −204, −129, −54, −230, −156, −82] |
| | RU 42 | [120: 145] | [−182, −108, −34, −201, −126, −51, −236, −162, −88, |
| | | | −14, −179, −105, −31, 40, 114, 188, 23, 97, 171, 245, 60, 135, |
| | | | 210, 43, 117, 191] |
| | RU 43 | [147: 172] | [91, 165, 239, 63, 138, 213, 46, 121, 194, 200, 85, 159, 233, 68, |
| | | | 141, 216, 269, 343, 417, 491, 326, 400, 474, 289, 363, 437] |
| | RU 44 | [173: 198] | [272, 346, 420, 494, 320, 394, 468, 292, 367, 440, 275, 349, 423, |
| | | | 497, 314, 387, 462, 295, 370, 443, 524, 590, 664, 738, 571, 646] |
| | RU 45 | [201: 226] | [610, 684, 758, 593, 667, 741, 565, 640, 715, 539, 613, 687, 761, |
| | | | 596, 670, 744, 559, 634, 707, 542, 616, 690, 764, 817, 892, 967] |
| | RU 46 | [227: 252] | [800, 874, 948, 825, 839, 913, 987, 820, 895, 970, 794, 868, 942, |
| | | | 905, 842, 916, 990, 823, 898, 973, 788, 862, 936, 1010, 845, 919] |
| | RU 47 | [260: 285] | [−900, −827, −992, −918, −844, −959, −953, −880, −805, |
| | | | −972, −897, −822, −998, −924, −850, −776, −950, −876, |
| | | | −802, −969, −894, −819, −1004, −930, −856, −782] |
| | RU 48 | [286: 311] | [−947, −873, −799, −746, −672, −598, −763, −689, −615, |
| | | | −541, −726, −651, −576, −743, −669, −595, −658, −695, |
| | | | −621, −547, −723, −648, −573, −740, −666, −592] |
| | RU 49 | [314: 339] | [−627, −553, −720, −645, −570, −499, −425, −351, −277, |
| | | | −442, −369, −294, −479, −405, −331, −496, −422, −348, |
| | | | −274, −450, −375, −300, −476, −402, −328, −493] |
| | RU 50 | [340: 365] | [−419, −345, −271, −456, −381, −306, −473, −399, −325, |
| | | | −259, −196, −123, −48, −215, −140, −67, −250, −176, |
| | | | −102, −28, −193, −120, −45, −221, −147, −73] |
| | RU 51 | [367: 392] | [−173, −99, −25, −190, −116, −42, −227, −153, −79, |
| | | | −244, −170, −96, −22, 49, 124, 197, 32, 106, 180, 65, 71, |
| | | | 144, 219, 52, 127, 202] |
| | RU 52 | [394: 419] | [100, 174, 248, 74, 148, 222, 55, 130, 205, 20, 94, 168, 242, 77, |
| | | | 151, 225, 278, 352, 426, 261, 335, 409, 483, 298, 373, 448] |
| | RU 53 | [420: 445] | [281, 355, 429, 366, 329, 403, 477, 301, 376, 451, 284, 358, 432, |
| | | | 446, 323, 397, 471, 304, 379, 454, 525, 599, 673, 747, 582, 655] |
| | RU 54 | [448: 473] | [619, 693, 528, 602, 676, 750, 574, 649, 724, 548, 622, 696, 531, |
| | | | 605, 679, 753, 568, 643, 718, 551, 625, 699, 765, 828, 901, 976] |
| | RU 55 | [474: 499] | [809, 884, 957, 774, 848, 922, 996, 831, 904, 979, 803, 877, 951, |
| | | | 777, 851, 925, 999, 834, 908, 982, 797, 871, 945, 780, 854, 928] |
| | RU 56 | [not defined] | |
| | RU 57 | [525: 550] | [−891, −816, −983, −909, −835, −958, −944, −870, −796, |
| | | | −963, −888, −813, −989, −915, −841, −878, −941, −867, |
| | | | −793, −960, −885, −810, −995, −921, −847, −773] |
| | RU 58 | [551: 576] | [−938, −864, −790, −737, −663, −589, −754, −680, −606, |
| | | | −532, −717, −642, −567, −734, −660, −586, −760, −686, |
| | | | −612, −538, −714, −639, −564, −731, −656, −583] |
| | RU 59 | [579: 604] | [−618, −544, −709, −636, −561, −490, −416, −342, −268, |
| | | | −433, −359, −285, −470, −396, −322, −487, −413, −339, |
| | | | −265, −439, −366, −291, −467, −392, −319, −484] |
| | RU 60 | [605: 630] | [−410, −336, −262, −445, −372, −297, −464, −389, −316, |
| | | | −253, −187, −113, −39, −206, −131, −56, −241, −167, |
| | | | −93, −19, −184, −110, −36, −212, −137, −62] |
| | RU 61 | [632: 657] | [−164, −90, −16, −181, −107, −33, −218, −143, −70, |
| | | | −235, −161, −87, −13, 58, 133, 208, 41, 115, 189, 66, 80, |
| | | | 154, 228, 61, 136, 211] |
| | RU 62 | [659: 684] | [109, 183, 146, 83, 157, 231, 64, 139, 214, 29, 103, 177, 251, 86, |
| | | | 160, 234, 287, 361, 435, 270, 344, 418, 492, 307, 382, 457] |
| | RU 63 | [685: 710] | [290, 364, 438, 264, 338, 412, 486, 310, 385, 460, 293, 368, 441, |
| | | | 447, 332, 406, 480, 315, 388, 463, 534, 608, 682, 756, 591, 665] |
| | RU 64 | [713: 738] | [628, 702, 537, 611, 685, 759, 585, 659, 733, 557, 632, 705, 540, |
| | | | 614, 688, 762, 579, 652, 727, 560, 635, 708, 771, 837, 911, 985] |
| | RU 65 | [739: 764] | [818, 893, 968, 783, 857, 931, 1005, 840, 914, 988, 812, 887, 962, |
| | | | 786, 860, 934, 1008, 843, 917, 991, 806, 881, 954, 789, 863, 937] |
| | RU 66 | [772: 797] | [−882, −807, −974, −899, −826, −1009, −935, −861, −787, |
| | | | −952, −879, −804, −980, −906, −832, −1006, −932, −858, |
| | | | −784, −949, −875, −801, −986, −912, −838, −1003] |
| | RU 67 | [798: 823] | [−929, −855, −781, −728, −653, −580, −745, −671, −597, |
| | | | −712, −706, −633, −558, −725, −650, −575, −751, −677, |
| | | | −603, −529, −703, −629, −555, −722, −647, −572] |
| | RU 68 | [826: 851] | [−609, −535, −700, −626, −552, −481, −407, −333, −498, |
| | | | −424, −350, −276, −461, −386, −311, −478, −404, −330, |
| | | | −393, −430, −356, −282, −458, −383, −308, −475] |
| | RU 69 | [852: 877] | [−401, −327, −313, −436, −362, −288, −455, −380, −305, |
| | | | −252, −178, −104, −30, −195, −122, −47, −232, −158, |
| | | | −84, −249, −175, −101, −27, −203, −128, −53] |
| | RU 70 | [879: 904] | [−155, −81, −246, −172, −98, −24, −209, −134, −59, |
| | | | −226, −152, −78, −12, 69, 142, 217, 50, 125, 198, 15, 89, |
| | | | 163, 237, 72, 145, 220] |
| | RU 71 | [906: 931] | [118, 192, 18, 92, 166, 240, 75, 149, 223, 38, 112, 186, 21, 95, |
| | | | 169, 243, 296, 371, 444, 279, 353, 427, 312, 318, 391, 466] |
| | RU 72 | [932: 957] | [299, 374, 449, 273, 347, 421, 495, 321, 395, 469, 302, 377, 452, |
| | | | 267, 341, 415, 489, 324, 398, 472, 543, 617, 691, 526, 600, 674] |
| | RU 73 | [960: 985] | [638, 713, 546, 620, 694, 631, 594, 668, 742, 566, 641, 716, 549, |
| | | | 623, 697, 711, 588, 662, 736, 569, 644, 719, 772, 846, 920, 994] |
| | RU 74 | [986: 1011] | [829, 902, 977, 792, 866, 940, 775, 849, 923, 997, 821, 896, 971, |
| | | | 795, 869, 943, 778, 852, 926, 1000, 815, 890, 965, 798, 872, 946] |
| 52- | RU 1 | [−1011: 960] | [26-tone RU1, 26-tone RU2] |
| tone | RU 2 | [−957: −906] | [26-tone RU3, 26-tone RU4] |
| RU | RU 3 | [−877: −826] | [26-tone RU6, 26-tone RU7] |
| | RU 4 | [−823: −772] | [26-tone RU8, 26-tone RU9] |
| | RU 5 | [−764: −713] | [26-tone RU10, 26-tone RU11] |
| | RU 6 | [−710: −659] | [26-tone RU12, 26-tone RU13] |
| | RU 7 | [−630: −579] | [26-tone RU15, 26-tone RU16] |
| | RU 8 | [−576: −525] | [26-tone RU17, 26-tone RU18] |
| | RU 9 | [−499: −448] | [26-tone RU20, 26-tone RU21] |
| | RU 10 | [−445: −394] | [26-tone RU22, 26-tone RU23] |
| | RU 11 | [−365: −314] | [26-tone RU25, 26-tone RU26] |
| | RU 12 | [−311: −260] | [26-tone RU27, 26-tone RU28] |
| | RU 13 | [−252: −201] | [26-tone RU29, 26-tone RU30] |
| | RU 14 | [−198: −147] | [26-tone RU31, 26-tone RU32] |
| | RU 15 | [−118: −67] | [26-tone RU34, 26-tone RU35] |
| | RU 16 | [−64: −13] | [26-tone RU36, 26-tone RU37] |
| | RU 17 | [13: 64] | [26-tone RU38, 26-tone RU39] |
| | RU 18 | [67: 118] | [26-tone RU40, 26-tone RU41] |
| | RU 19 | [147: 198] | [26-tone RU43, 26-tone RU44] |
| | RU 20 | [201: 252] | [26-tone RU45, 26-tone RU46] |
| | RU 21 | [260: 311] | [26-tone RU47, 26-tone RU48] |
| | RU 22 | [314: 365] | [26-tone RU49, 26-tone RU50] |
| | RU 23 | [394: 445] | [26-tone RU52, 26-tone RU53] |
| | RU 24 | [448: 499] | [26-tone RU54, 26-tone RU55] |
| | RU 25 | [525: 576] | [26-tone RU57, 26-tone RU58] |
| | RU 26 | [579: 630] | [26-tone RU59, 26-tone RU60] |
| | RU 27 | [659: 710] | [26-tone RU62, 26-tone RU63] |
| | RU 28 | [713: 764] | [26-tone RU64, 26-tone RU65] |
| | RU 29 | [772: 823] | [26-tone RU66, 26-tone RU67] |
| | RU 30 | [826: 877] | [26-tone RU68, 26-tone RU69] |
| | RU 31 | [906: 957] | [26-tone RU71, 26-tone RU72] |
| | RU 32 | [960: 1011] | [26-tone RU73, 26-tone RU74] |
| 106- | RU 1 | [−1011: 906] | [26-tone RU1, 26-tone RU2, −563, −748, 26-tone RU3, |
| | | | 26-tone RU4] |
| tone | RU 2 | [−877: −772] | [26-tone RU6, 26-tone RU7, 683, 757, 26-tone RU8, |
| | | | 26-tone RU9] |
| RU | RU 3 | [−764: −659] | [26-tone RU10, 26-tone RU11, −554, −739, 26-tone RU12, |
| | | | 26-tone RU13] |
| | RU 4 | [−630: −525] | [26-tone RU15, 26-tone RU16, 692, 577, 26-tone RU17, |
| | | | 26-tone RU18] |
| | RU 5 | [−499: −394] | [26-tone RU20, 26-tone RU21, −545, −730, 26-tone RU22, |
| | | | 26-tone RU23] |
| | RU 6 | [−365: −260] | [26-tone RU25, 26-tone RU26, 701, 578, 26-tone RU27, |
| | | | 26-tone RU28] |
| | RU 7 | [−252: −147] | [26-tone RU29, 26-tone RU30, −536, −721, 26-tone RU31, |
| | | | 26-tone RU32] |
| | RU 8 | [−118: −13] | [26-tone RU34, 26-tone RU35, 710, 527, 26-tone RU36, |
| | | | 26-tone RU37] |
| | RU 9 | [13: 118] | [26-tone RU38, 26-tone RU39, −527, −710, 26-tone RU40, |
| | | | 26-tone RU41] |
| | RU 10 | [147: 252] | [26-tone RU43, 26-tone RU44, 721, 536, 26-tone RU45, |
| | | | 26-tone RU46] |
| | RU 11 | [260: 365] | [26-tone RU47, 26-tone RU48, −578, −701, 26-tone RU49, |
| | | | 26-tone RU50] |
| | RU 12 | [394: 499] | [26-tone RU52, 26-tone RU53, 730, 545, 26-tone RU54, |
| | | | 26-tone RU55] |
| | RU 13 | [525: 630] | [26-tone RU57, 26-tone RU58, −577, −692, 26-tone RU59, |
| | | | 26-tone RU60] |
| | RU 14 | [659: 764] | [26-tone RU62, 26-tone RU63, 739, 554, 26-tone RU64, |
| | | | 26-tone RU65] |
| | RU 15 | [772: 877] | [26-tone RU66, 26-tone RU67, −757, −683, 26-tone RU68, |
| | | | 26-tone RU69] |
| | RU 16 | [906: 1011] | [26-tone RU71, 26-tone RU72, 748, 563, 26-tone RU73, |
| | | | 26-tone RU74] |
| 242- | RU 1 | [−1012: 771] | [−1012, 26-tone RU1, 26-tone RU2, −563, −748, 26-tone RU3, |
| tone | | | 26-tone RU4, −44, 26-tone RU5, 229, 26-tone RU6, 26-tone RU7, 683, |
| RU | | | 757, 26-tone RU8, 26-tone RU9, 955] |
| | RU 2 | [−765: −524] | [−1011, 26-tone RU10, 26-tone RU11, −554, −739, 26-tone RU12, |
| | | | 26-tone RU13, −35, 26-tone RU14, 238, 26-tone RU15, 26-tone RU16, |
| | | | 692, 577, 26-tone RU17, 26-tone RU18, 966] |
| | RU 3 | [−500: −259] | [−1002, 26-tone RU20, 26-tone RU21, −545, −730, 26-tone RU22, |
| | | | 26-tone RU23, −26, 26-tone RU24, 247, 26-tone RU25, 26-tone RU26, |
| | | | 701, 578, 26-tone RU27, 26-tone RU28, 975] |
| | RU 4 | [−253: −12] | [−993, 26-tone RU29, 26-tone RU30, −536, −721, 26-tone RU31, |
| | | | 26-tone RU32, −17, 26-tone RU33, 119, 26-tone RU34, 26-tone RU35, |
| | | | −527, −710, 26-tone RU36, 26-tone RU37, 984] |
| | RU 5 | [12: 253] | [−984, 26-tone RU38, 26-tone RU39, −527, −710, 26-tone RU40, |
| | | | 26-tone RU41, −119, 26-tone RU42, 17, 26-tone RU43, 26-tone RU44, |
| | | | 721, 536, 26-tone RU45, 26-tone RU46, 993] |
| | RU 6 | [259: 500] | [−975, 26-tone RU47, 26-tone RU48, −578, −701, 26-tone RU49, |
| | | | 26-tone RU50, −247, 26-tone RU51, 26, 26-tone RU52, 26-tone RU53, |
| | | | 730, 545, 26-tone RU54, 26-tone RU55, 1002] |
| | RU 7 | [524: 765] | [−966, 26-tone RU57, 26-tone RU58, −577, −692, 26-tone RU59, |
| | | | 26-tone RU60, −238, 26-tone RU61, 35, 26-tone RU62, 26-tone RU63, |
| | | | 739, 554, 26-tone RU64, 26-tone RU65, 1011] |
| | RU 8 | [771: 1012] | [−955, 26-tone RU66, 26-tone RU67, −757, −683, 26-tone RU68, |
| | | | 26-tone RU69, −229, 26-tone RU70, 44, 26-tone RU71, 26-tone RU72, |
| | | | 748, 563, 26-tone RU73, 26-tone RU74, 1012] |
| 484- | RU 1 | [−1012: −771, | [−1012, 26-tone RU1, 26-tone RU2, −563, −748, 26-tone RU3, |
| tone | | −765 : −524] | 26-tone RU4, −44, 26-tone RU5, 229, 26-tone RU6, 26-tone RU7, |
| RU | | | 683, 757, 26-tone RU8, 26-tone RU9, 955, −1011, 26-tone RU10, |
| | | | 26-tone RU11, −554, −739, 26-tone RU12, 26-tone RU13, −35, |
| | | | 26-tone RU14, 238, 26-tone RU15, 26-tone RU16, 692, 577, |
| | | | 26-tone RU17, 26-tone RU18, 966] |
| | RU 2 | [−500: −259, | [−1002, 26-tone RU20, 26-tone RU21, −545, −730, 26-tone RU22, |
| | | −253: −12] | 26-tone RU23, −26, 26-tone RU24, 247, 26-tone RU25, 26-tone RU26, |
| | | | 701, 578, 26-tone RU27, 26-tone RU28, 975, −993, 26-tone RU29, |
| | | | 26-tone RU30, −536, −721, 26-tone RU31, 26-tone RU32, −17, |
| | | | 26-tone RU33, 119, 26-tone RU34, 26-tone RU35, −527, −710, |
| | | | 26-tone RU36, 26-tone RU37, 984] |
| | RU 3 | [12: 253, | [−984, 26-tone RU38, 26-tone RU39, −527, −710, 26-tone RU40, |
| | | 259: 500] | 26-tone RU41, −119, 26-tone RU42, 17, 26-tone RU43, 26-tone RU44, |
| | | | 721, 536, 26-tone RU45, 26-tone RU46, 993, −975, 26-tone RU47, |
| | | | 26-tone RU48, −578, −701, 26-tone RU49, 26-tone RU50, −247, |
| | | | 26-tone RU51, 26, 26-tone RU52, 26-tone RU53, 730, 545, 26-tone RU54, |
| | | | 26-tone RU55, 1002] |
| | RU 4 | [524: 765, | [−966, 26-tone RU57, 26-tone RU58, −577, −692, 26-tone RU59, |
| | | 771: 1012] | 26-tone RU60, −238, 26-tone RU61, 35, 26-tone RU62, 26-tone RU63, |
| | | | 739, 554, 26-tone RU64, 26-tone RU65, 1011, −955, 26-tone RU66, |
| | | | 26-tone RU67, −757, −683, 26-tone RU68, 26-tone RU69, −229, |
| | | | 26-tone RU70, 44, 26-tone RU71, 26-tone RU72, 748, 563, 26-tone RU73, |
| | | | 26-tone RU74, 1012] |
| 996- | RU 1 | [−1012: −515, | [−1012, 26-tone RU1, 26-tone RU2, −563, −748, 26-tone RU3, |
| tone | | −509: −12] | 26-tone RU4, −44, 26-tone RU5, 229, 26-tone RU6, 26-tone RU7, 683, |
| RU | | | 757, 26-tone RU8, 26-tone RU9, 955, −770, −769, −768, −767, |
| | | | −766, −1011, 26-tone RU10, 26-tone RU11, −554, −739, |
| | | | 26-tone RU12, 26-tone RU13, −35, 26-tone RU14, 238, 26-tone RU15, |
| | | | 26-tone RU16, 692, 577, 26-tone RU17, 26-tone RU18, 966, −523, −522, |
| | | | −521, −520, −519, −518, −517, −516, −515, −509, |
| | | | −508, −507, −506, −505, −504, −503, −502, −501, |
| | | | −1002, 26-tone RU20, 26-tone RU21, −545, −730, 26-tone RU22, |
| | | | 26-tone RU23, −26, 26-tone RU24, 247, 26-tone RU25, 26-tone RU26, 701, |
| | | | 578, 26-tone RU27, 26-tone RU28, 975, −258, −257, −256, −255, |
| | | | −254, −993, 26-tone RU29, 26-tone RU30, −536, −721, 26-tone RU31, |
| | | | 26-tone RU32, −17, 26-tone RU33, 119, 26-tone RU34, 26-tone RU35, −527, |
| | | | −710, 26-tone RU36, 26-tone RU37, 984] |
| | RU 2 | [12: 509, | [−984, 26-tone RU38, 26-tone RU39, −527, −710, 26-tone RU40, |
| | | 515: 1012] | 26-tone RU41, −119, 26-tone RU42, 17, 26-tone RU43, 26-tone RU44, 721, |
| | | | 536, 26-tone RU45, 26-tone RU46, 993, 254, 255, 256, 257, 258, −975, |
| | | | 26-tone RU47, 26-tone RU48, −578, −701, 26-tone RU49, 26-tone RU50, |
| | | | −247, 26-tone RU51, 26, 26-tone RU52, 26-tone RU53, 730, 545, 26-tone RU54, |
| | | | 26-tone RU55, 1002, 501, 502, 503, 504, 505, 506, 507, 508, 509, 515, 516, |
| | | | 517, 518, 519, 520, 521, 522, 523, −966, 26-tone RU57, 26-tone RU58, |
| | | | −577, −692, 26-tone RU59, 26-tone RU60, −238, 26-tone RU61, 35, |
| | | | 26-tone RU62, 26-tone RU63, 739, 554, 26-tone RU64, 26-tone RU65, 1011, |
| | | | 766, 767, 768, 769, 770, −955, 26-tone RU66, 26-tone RU67, −757, |
| | | | −683, 26-tone RU68, 26-tone RU69, −229, 26-tone RU70, 44, 26-tone RU71, |
| | | | 26-tone RU72, 748, 563, 26-tone RU73, 26-tone RU74, 1012] |

Note:
An undermarked tone index indicates a tone that does not participate in the shot-2 distributed tone mapping in the two-shot distributed tone mapping.

TABLE 11
Construction of a logical RU within a bandwidth of 320 MHz

| Logical | Logical | Logical tone | |
|---|---|---|---|
| RU | RU | index of a | |
| type | index | logical RU | Physical tone index of a logical RU |
| 26- | RU 1 | [−2035: −2010] | [−1896, −1989, −1839, −1950, −1802, −1893, −1995, −1845, |
| tone | | | −1947, −1799, −1890, −2001, −1853, −1944, −1796, −1668, |
| RU | | | −1760, −1612, −1721, −1573, −1665, −1766, −1618, −1718, |
| | | | −1570, −1662] |
| | RU 2 | [−2009: −1984] | [−1772, −1624, −1715, −1567, −1422, −1513, −1365, −1476, |
| | | | −1326, −1419, −1519, −1371, −1473, −1323, −1415, −1336, |
| | | | −1377, −1468, −1320, −1193, −1045, −1136, −1247, −1099, |
| | | | −1190, −1042] |
| | RU 3 | [−1981: −1956] | [−1096, −1187, −1039, −1149, −1241, −1093, −946, −798, |
| | | | −890, −1000, −852, −943, −795, −896, −997, −849, −940, |
| | | | −792, −902, −994, −846, −719, −569, −662, −711, −623] |
| | RU 4 | [−1955: −1930] | [−716, −566, −668, −631, −620, −713, −563, −674, −526, |
| | | | −617, −472, −324, −415, −267, −377, −469, −321, −421, |
| | | | −273, −374, −466, −318, −427, −279, −371, −243] |
| | RU 5 | [−1928: −1903] | [−186, −38, −149, −240, −92, −192, −44, −145, −237, |
| | | | −89, −198, −50, −142, 12, 152, 59, 209, 98, 246, 155, 53, 203, |
| | | | 101, 249, 158, 47] |
| | RU 6 | [−1901: −1876] | [104, 252, 380, 288, 436, 327, 475, 383, 282, 430, 330, |
| | | | 478, 386, 276, 424, 333, 48 1, 626, 535, 683, 572, 722, |
| | | | 629, 529, 677, 575] |
| | RU 7 | [−1875: −1850] | [725, 633, 712, 671, 580, 728, 855, 1003, 912, 801, 949, |
| | | | 858, 1006, 906, 804, 952, 861, 1009, 899, 807, 955, 1102, |
| | | | 1250, 1158, 1048, 1196] |
| | RU 8 | [−1847: −1822] | [1152, 1051, 1199, 1108, 1256, 1146, 1054, 1202, 1329, |
| | | | 1479, 1386, 1337, 1425, 1332, 1482, 1380, 1417, 1428, 1335, |
| | | | 1485, 1374, 1522, 1431, 1576, 1724, 1633] |
| | RU 9 | [−1821: −1796] | [1781, 1671, 1579, 1727, 1627, 1775, 1674, 1582, 1730, |
| | | | 1621, 1769, 1677, 1805, 1953, 1862, 2010, 1899, 1808, 1956, |
| | | | 1856, 2004, 1903, 1811, 1959, 1850, 1998] |
| | RU 10 | [−1788: −1763] | [−1887, −1978, −1830, −1941, −2032, −1884, −1986, −1836, |
| | | | −1938, −2029, −1881, −1992, −1842, −1935, −1795, −1659, |
| | | | −1751, −1603, −1712, −1564, −1656, −1757, −1609, −1709, |
| | | | −1561, −1652] |
| | RU 11 | [−1762: −1737] | [−1763, −1615, −1706, −1558, −1412, −1504, −1356, −1465, |
| | | | −1317, −1409, −1510, −1362, −1462, −1314, −1406, −1516, |
| | | | −1368, −1459, −1311, −1184, −1275, −1127, −1238, −1088, |
| | | | −1181, −1170] |
| | RU 12 | [−1734: −1709] | [−1085, −1178, −1090, −1139, −1232, −1082, −937, −789, |
| | | | −881, −991, −843, −934, −786, −887, −988, −840, −931, −783, |
| | | | −893, −985, −837, −708, −560, −652, −762, −614] |
| | RU 13 | [−1708: −1683] | [−705, −557, −659, −759, −611, −702, −554, −665, −756, |
| | | | −608, −463, −315, −406, −447, −368, −460, −310, −412, |
| | | | −264, −364, −457, −307, −418−270, −361, −234] |
| | RU 14 | [−1681: −1656] | [−177, −29, −139, −231, −83, −183, −35, −136, −228, −80, |
| | | | −189, −41, −133, 13, 161, 70, 218, 107, 16, 164, 62, 212, |
| | | | 110, 19, 167, 56] |
| | RU 15 | [−1654: −1629] | [113, 253, 389, 297, 445, 336, 484, 392, 291, 439, 339, |
| | | | 487, 396, 285, 433, 342, 490, 636, 544, 692, 583, 731, |
| | | | 639, 538, 686, 586] |
| | RU 16 | [−1628: −1603] | [734, 642, 532, 680, 589, 737, 864, 773, 921, 810, 960, |
| | | | 867, 878, 915, 813, 963, 870, 958, 909, 816, 966, 1111, |
| | | | 1259, 1167, 1057, 1205] |
| | RU 17 | [−1600: −1575] | [1161, 1060, 1208, 1117, 1265, 1155, 1063, 1211, 1340, |
| | | | 1488, 1396, 1286, 1434, 1343, 1491, 1389, 1289, 1437, |
| | | | 1346, 1494, 1383, 1292, 1440, 1585, 1733, 1642] |
| | RU 18 | [−1574: −1549] | [1601, 1680, 1588, 1738, 1636, 1784, 1684, 1591, 1741, |
| | | | 1630, 1778, 1687, 1814, 1962, 1871, 2019, 1909, 1817, |
| | | | 1965, 1865, 2013, 1912, 1820, 1968, 1859, 2007] |
| | RU 19 | [not defined] | |
| | RU 20 | [−1523: −1498] | [−1878, −1969, −1821, −1932, −2023, −1875, −1975, −1827, |
| | | | −1928, −2020, −1872, −1981, −1833, −1925, −1789, −1649, |
| | | | −1742, −1592, −1703, −1555, −1646, −1748, −1598, −1700, |
| | | | −1552, −1643] |
| | RU 21 | [−1497: −1472] | [−1754, −1606, −1697, −1549, −1403, −1495, −1347, −1456, |
| | | | −1308, −1400, −1501, −1353, −1453, −1305, −1397, −1507, |
| | | | −1359, −1450, −1302, −1175, −1266, −1118, −1229, −1079, |
| | | | −1172, −1272] |
| | RU 22 | [−1469: −1444] | [−1076, −1168, −1089, −1130, −1221, −1073, −928, −780, |
| | | | −871, −982, −834, −925, −777, −877, −979, −831, −922, |
| | | | −774, −884, −976, −828, −699, −551, −643, −753, −605] |
| | RU 23 | [−1443: −1418] | [−696, −548, −649, −750, −602, −693, −545, −655, −747, |
| | | | −599, −454, −304, −397, −446, −358, −451, −301, −403, |
| | | | −366, −355, −448, −298, −409, −261, −352, −225] |
| | RU 24 | [−1416: −1391] | [−168, −20, −130, −222, −74, −174, −26, −127, −219, −71, |
| | | | −180, −32, −124, 22, 170, 79, 227, 116, 25, 173, 73, 221, |
| | | | 120, 28, 176, 67] |
| | RU 25 | [−1389: −1364] | [123, 259, 399, 306, 456, 345, 493, 402, 300, 450, 348, |
| | | | 496, 405, 294, 442, 351, 499, 645, 553, 701, 592, 740, |
| | | | 648, 547, 695, 595] |
| | RU 26 | [−1363: −1338] | [743, 651, 541, 689, 598, 746, 873, 782, 930, 819, 969, |
| | | | 876, 776, 924, 822, 972, 880, 959, 918, 827, 975, 1120, |
| | | | 1268, 1177, 1066, 1214] |
| | RU 27 | [−1335: −1310] | [1171, 1069, 1217, 1126, 1274, 1164, 1072, 1220, 1349, |
| | | | 1497, 1405, 1295, 1443, 1352, 1500, 1399, 1298, 1446, |
| | | | 1355, 1503, 1393, 1301, 1449, 1594, 1744, 1651] |
| | RU 28 | [−1309: −1284] | [1602, 1690, 1597, 1747, 1645, 1682, 1693, 1600, 1750, |
| | | | 1639, 1787, 1696, 1823, 1971, 1880, 2028, 1918, 1826, |
| | | | 1974, 1874, 2022, 1921, 1829, 1977, 1868, 2016] |
| | RU 29 | [−1276: −1251] | [−1869, −1960, −1812, −1922, −2014, −1866, −1966, −1818, |
| | | | −1919, −2011, −1863, −1972, −1824, −1916, −1788, −1640, |
| | | | −1731, −1583, −1694, −1785, −1637, −1739, −1589, −1691, |
| | | | −1782, −1634] |
| | RU 30 | [−1250: −1225] | [−1745, −1595, −1688, −1548, −1394, −1486, −1338, −1447, |
| | | | −1299, −1391, −1492, −1344, −1444, −1296, −1387, −1498, |
| | | | −1350, −1441, −1293, −1165, −1257, −1109, −1218, −1070, |
| | | | −1162, −1263] |
| | RU 31 | [−1222: −1197] | [−1067, −1159, −1269, −1121, −1212, −1064, −919, −1010, |
| | | | −862, −973, −823, −916, −905, −868, −970, −820, −913, |
| | | | −825, −874, −967, −817, −690, −542, −634, −744, −596] |
| | RU 32 | [−1196: −1171] | [−687, −539, −640, −741, −593, −684, −536, −646, −738, |
| | | | −590, −443, −295, −387, −497, −349, −440, −292, −394, |
| | | | −494, −346, −437, −289, −400, −491, −343, −216] |
| | RU 33 | [−1169: −1144] | [−159, −200, −121, −213, −63, −165, −17, −117, −210, −60, |
| | | | −171, −23, −114, 31, 179, 88, 236, 126, 34, 182, 82, 230, |
| | | | 129, 37, 185, 76] |
| | RU 34 | [−1142: −1117] | [132, 260, 408, 317, 465, 354, 263, 411, 309, 459, 357, |
| | | | 266, 414, 303, 453, 360, 500, 654, 562, 710, 601, 749, |
| | | | 657, 556, 704, 604] |
| | RU 35 | [−1116: −1091] | [752, 661, 550, 698, 607, 755, 883, 791, 939, 830, 978, |
| | | | 886, 785, 933, 833, 981, 889, 779, 927, 836, 984, 1129, |
| | | | 1038, 1186, 1075, 1225] |
| | RU 36 | [−1088: −1063] | [1180, 1078, 1228, 1135, 1223, 1174, 1081, 1231, 1358, |
| | | | 1506, 1414, 1304, 1452, 1361, 1509, 1408, 1307, 1455, |
| | | | 1364, 1512, 1402, 1310, 1458, 1605, 1753, 1661] |
| | RU 37 | [−1062: −1037] | [1551, 1699, 1608, 1756, 1654, 1554, 1702, 1611, 1759, |
| | | | 1648, 1557, 1705, 1832, 1980, 1889, 1848, 1927, 1835, |
| | | | 1985, 1883, 2031, 1931, 1838, 1988, 1877, 2025] |
| | RU 38 | [−1011: −986] | [−1860, −1951, −1803, −1913, −2005, −1857, −1957, −1809, |
| | | | −1910, −2002, −1854, −1963, −1815, −1907, −1779, −1631, |
| | | | −1722, −1574, −1685, −1776, −1628, −1728, −1580, −1681, |
| | | | −1773, −1625] |
| | RU 39 | [−985: −960] | [−1734, −1586, −1678, −1524, −1384, −1477, −1327, −1438, |
| | | | −1290, −1381, −1483, −1333, −1435, −1287, −1378, −1489, |
| | | | −1341, −1432, −1284, −1156, −1248, −1100, −1209, −1061, |
| | | | −1153, −1254] |
| | RU 40 | [−957: −932] | [−1058, −1150, −1260, −1112, −1203, −1055, −910, −1001, |
| | | | −853, −964, −814, −907, −1007, −859, −961, −811, −903, |
| | | | −824, −865, −956, −808, −681, −533, −624, −735, −587] |
| | RU 41 | [−931: −906] | [−678, −530, −630, −732, −584, −675, −527, −637, −729, |
| | | | −581, −434, −286, −378, −488, −340, −431, −283, −384, |
| | | | −485, −337, −428, −280, −390, −482, −334, −207] |
| | RU 42 | [−904: −879] | [−150, −199, −111, −204, −54, −156, −119, −108, −201, |
| | | | −51, −162, −14, −105, 40, 188, 97, 245, 135, 43, 191, |
| | | | 91, 239, 138, 46, 194, 85] |
| | RU 43 | [−877: −852] | [141, 269, 417, 326, 474, 363, 272, 420, 320, 468, 367, |
| | | | 275, 423, 314, 462, 370, 524, 664, 571, 721, 610, 758, |
| | | | 667, 565, 715, 613] |
| | RU 44 | [−851: −826] | [761, 670, 559, 707, 616, 764, 892, 800, 948, 839, 987, |
| | | | 895, 794, 942, 842, 990, 898, 788, 936, 845, 993, 1138, |
| | | | 1047, 1195, 1084, 1234] |
| | RU 45 | [−823: −798] | [1189, 1087, 1237, 1145, 1224, 1183, 1092, 1240, 1367, |
| | | | 1515, 1424, 1313, 1461, 1370, 1518, 1418, 1316, 1464, |
| | | | 1373, 1521, 1411, 1319, 1467, 1614, 1762, 1670] |
| | RU 46 | [−797: −772] | [1560, 1708, 1617, 1765, 1664, 1563, 1711, 1620, 1768, |
| | | | 1658, 1566, 1714, 1841, 1991, 1898, 1849, 1937, 1844, |
| | | | 1994, 1892, 1929, 1940, 1847, 1997, 1886, 2034] |
| | RU 47 | [−764: −739] | [−1851, −1942, −1983, −1904, −1996, −1846, −1948, −1800, |
| | | | −1900, −1993, −1843, −1954, −1806, −1897, −1770, −1622, |
| | | | −1713, −1565, −1675, −1767, −1619, −1719, −1571, −1672, |
| | | | −1764, −1616] |
| | RU 48 | [−738: −713] | [−1725, −1577, −1669, −1523, −1375, −1466, −1318, −1429, |
| | | | −1520, −1372, −1474, −1324, −1426, −1517, −1369, −1480, |
| | | | −1330, −1423, −1283, −1147, −1239, −1091, −1200, −1052, |
| | | | −1144, −1245] |
| | RU 49 | [−710: −685] | [−1049, −1140, −1251, −1103, −1194, −1046, −900, −992, |
| | | | −844, −953, −805, −897, −998, −850, −950, −802, −894, |
| | | | −1004, −856, −947, −799, −672, −763, −615, −726, −576] |
| | RU 50 | [−684: −659] | [−669, −658, −621, −723, −573, −666, −578, −627, −720, |
| | | | −570, −425, −277, −369, −479, −331, −422, −274, −375, |
| | | | −476, −328, −419, −271, −381, −473, −325, −196] |
| | RU 51 | [−657: −632] | [−140, −250, −102, −193, −45, −147, −247, −99, −190, −42, |
| | | | −153, −244, −96, 49, 197, 106, 65, 144, 52, 202, 100, |
| | | | 248, 148, 55, 205, 94] |
| | RU 52 | [−630: −605] | [151, 278, 426, 335, 483, 373, 281, 429, 329, 477, 376, |
| | | | 284, 432, 323, 471, 379, 525, 673, 582, 730, 619, 528, |
| | | | 676, 574, 724, 622] |
| | RU 53 | [−604: −579] | [531, 679, 568, 718, 625, 765, 901, 809, 957, 848, 996, |
| | | | 904, 803, 951, 851, 999, 908, 797, 945, 854, 1002, 1148, |
| | | | 1056, 1204, 1095, 1243] |
| | RU 54 | [−576: −551] | [1198, 1098, 1246, 1154, 1044, 1192, 1101, 1249, 1376, |
| | | | 1285, 1433, 1322, 1472, 1379, 1390, 1427, 1325, 1475, |
| | | | 1382, 1470, 1421, 1328, 1478, 1623, 1771, 1679] |
| | RU 55 | [−550: −525] | [1569, 1717, 1626, 1774, 1673, 1572, 1720, 1629, 1777, |
| | | | 1667, 1575, 1723, 1852, 2000, 1908, 1798, 1946, 1855, |
| | | | 2003, 1901, 1801, 1949, 1858, 2006, 1895, 1804] |
| | RU 56 | [not defined] | |
| | RU 57 | [−499: −474] | [−1840, −1933, −1982, −1894, −1987, −1837, −1939, −1902, |
| | | | −1891, −1984, −1834, −1945, −1797, −1888, −1761, −1613, |
| | | | −1704, −1556, −1666, −1758, −1610, −1710, −1562, −1663, |
| | | | −1755, −1607] |
| | RU 58 | [−473: −448] | [−1716, −1568, −1660, −1514, −1366, −1457, −1309, −1420, |
| | | | −1511, −1363, −1463, −1315, −1416, −1508, −1360, −1469, |
| | | | −1321, −1413, −1277, −1137, −1230, −1080, −1191, −1043, |
| | | | −1134−1236] |
| | RU 59 | [−445: −420] | [−1040, −1131, −1242, −1094, −1185, −1037, −891, −983, |
| | | | −835, −944, −796, −888, −989, −841, −941, −793, −885, −995, |
| | | | −847, −938, −790, −663, −754, −606, −717, −567] |
| | RU 60 | [−419: −394] | [−660, −760, −612, −714, −564, −656, −577, −618, −709, |
| | | | −561, −416, −268, −359, −470, −322, −413, −265, −365, |
| | | | −467, −319, −410, −262, −372, −464, −316, −187] |
| | RU 61 | [−392: −367] | [−131, −241, −93, −184, −36, −137, −238, −90, −181, −33, |
| | | | −143, −235, −87, 58, 208, 115, 66, 154, 61, 211, 109, |
| | | | 146, 157, 64, 214, 103] |
| | RU 62 | [−365: −340] | [160, 287, 435, 344, 492, 382, 290, 438, 338, 486, 385, |
| | | | 293, 441, 332, 480, 388, 534, 682, 591, 739, 628, 537, |
| | | | 685, 585, 733, 632] |
| | RU 63 | [−339: −314] | [540, 688, 579, 727, 635, 771, 911, 818, 968, 857, 1005, |
| | | | 914, 812, 962, 860, 1008, 917, 806, 954, 863, 1011, 1157, |
| | | | 1065, 1213, 1104, 1252] |
| | RU 64 | [−311: −286] | [1207, 1107, 1255, 1163, 1053, 1201, 1110, 1258, 1385, |
| | | | 1294, 1442, 1331, 1481, 1388, 1288, 1436, 1334, 1484, |
| | | | 1392, 1471, 1430, 1339, 1487, 1632, 1780, 1689] |
| | RU 65 | [−285: −260] | [1578, 1726, 1635, 1783, 1683, 1581, 1729, 1638, 1786, |
| | | | 1676, 1584, 1732, 1861, 2009, 1917, 1807, 1955, 1864, |
| | | | 2012, 1911, 1810, 1958, 1867, 2015, 1905, 1813] |
| | RU 66 | [−252: −227] | [−1831, −1923, −2033, −1885, −1976, −1828, −1930, −2030, |
| | | | −1882, −1973, −1825, −1936, −2027, −1879, −1752, −1604, |
| | | | −1695, −1736, −1657, −1749, −1599, −1701, −1553, −1653, |
| | | | −1746, −1596] |
| | RU 67 | [−226: −201] | [−1707, −1559, −1650, −1505, −1357, −1448, −1300, −1410, |
| | | | −1502, −1354, −1454, −1306, −1407, −1499, −1351, −1460, |
| | | | −1312, −1404, −1276, −1128, −1219, −1071, −1182, −1273, |
| | | | −1125, −1227] |
| | RU 68 | [−198: −173] | [−1270, −1122, −1233, −1083, −1176, −1036, −882, −974, |
| | | | −826, −935, −787, −879, −980, −832, −932, −784, −875, |
| | | | −986, −838, −929, −781, −653, −745, −597, −706, −558] |
| | RU 69 | [−172: −147] | [−650, −751, −603, −703, −555, −647, −757, −609, −700, |
| | | | −552, −407, −498, −350, −461, −311, −404, −393, −356, |
| | | | −458, −308, −401, −313, −362, −455, −305, −178] |
| | RU 70 | [−145: −120] | [−122, −232, −84, −175, −27, −128, −229, −81, −172, −24, |
| | | | −134, −226, −78, 69, 217, 125, 15, 163, 72, 220, 118, 18, |
| | | | 166, 75, 223, 112] |
| | RU 71 | [−118: −93] | [169, 296, 444, 353, 312, 391, 299, 449, 347, 495, 395, |
| | | | 302, 452, 341, 489, 398, 543, 691, 600, 748, 638, 546, |
| | | | 694, 594, 742, 641] |
| | RU 72 | [−92: −67] | [549, 697, 588, 736, 644, 772, 920, 829, 977, 866, 775, |
| | | | 923, 821, 971, 869, 778, 926, 815, 965, 872, 1012, 1166, |
| | | | 1074, 1222, 1113, 1261] |
| | RU 73 | [−64: −39] | [1216, 1116, 1264, 1173, 1062, 1210, 1119, 1267, 1395, |
| | | | 1303, 1451, 1342, 1490, 1398, 1297, 1445, 1345, 1493, |
| | | | 1401, 1291, 1439, 1348, 1496, 1641, 1550, 1698] |
| | RU 74 | [−38: −13] | [1587, 1737, 1644, 1655, 1692, 1590, 1740, 1647, 1735, |
| | | | 1686, 1593, 1743, 1870, 2018, 1926, 1816, 1964, 1873, |
| | | | 2021, 1920, 1819, 1967, 1876, 2024, 1914, 1822] |
| | RU 75 | [13: 38] | [−1822, −1914, −2024, −1876, −1967, −1819, −1920, −2021, |
| | | | −1873, −1964, −1816, −1926, −2018, −1870, −1743, −1593, |
| | | | −1686, −1735, −1647, −1740, −1590, −1692, −1655, −1644, |
| | | | −1737, −1587] |
| | RU 76 | [39: 64] | [−1698, −1550, −1641, −1496, −1348, −1439, −1291, −1401, |
| | | | −1493, −1345, −1445, −1297, −1398, −1490, −1342, −1451, |
| | | | −1303, −1395, −1267, −1119, −1210, −1062, −1173, −1264, |
| | | | −1116, −1216] |
| | RU 77 | [67: 92] | [−1261, −1113, −1222, −1074, −1166, −1012, −872, −965, |
| | | | −815, −926, −778, −869, −971, −821, −923, −775, −866, −977, |
| | | | −829, −920, −772, −644, −736, −588, −697, −549] |
| | RU 78 | [93: 118] | [−641, −742, −594, −694, −546, −638, −748, −600, −691, |
| | | | −543, −398, −489, −341, −452, −302, −395, −495, −347, −449, |
| | | | −299, −391, −312, −353, −444, −296, −169] |
| | RU 79 | [120: 145] | [−112, −223, −75, −166, −18, −118, −220, −72, −163, −15, |
| | | | −125, −217, −69, 78, 226, 134, 24, 172, 81, 229, 128, 27, |
| | | | 175, 84, 232, 122] |
| | RU 80 | [147: 172] | [178, 305, 455, 362, 313, 401, 308, 458, 356, 393, 404, |
| | | | 311, 461, 350, 498, 407, 552, 700, 609, 757, 647, 555, |
| | | | 703, 603, 751, 650] |
| | RU 81 | [173: 198] | [558, 706, 597, 745, 653, 781, 929, 838, 986, 875, 784, |
| | | | 932, 832, 980, 879, 787, 935, 826, 974, 882, 1036, 1176, |
| | | | 1083, 1233, 1122, 1270] |
| | RU 82 | [201: 226] | [1227, 1125, 1273, 1182, 1071, 1219, 1128, 1276, 1404, |
| | | | 1312, 1460, 1351, 1499, 1407, 1306, 1454, 1354, 1502, |
| | | | 1410, 1300, 1448, 1357, 1505, 1650, 1559, 1707] |
| | RU 83 | [227: 252] | [1596, 1746, 1653, 1553, 1701, 1599, 1749, 1657, 1736, |
| | | | 1695, 1604, 1752, 1879, 2027, 1936, 1825, 1973, 1882, |
| | | | 2030, 1930, 1828, 1976, 1885, 2033, 1923, 1831] |
| | RU 84 | [260: 285] | [−1813, −1905, −2015, −1867, −1958, −1810, −1911, −2012, |
| | | | −1864, −1955, −1807, −1917, −2009, −1861, −1732, −1584, |
| | | | −1676, −1786, −1638, −1729, −1581, −1683, −1783, −1635, |
| | | | −1726, −1578] |
| | RU 85 | [286: 311] | [−1689, −1780, −1632, −1487, −1339, −1430, −1471, −1392, |
| | | | −1484, −1334, −1436, −1288, −1388, −1481, −1331, −1442, |
| | | | −1294, −1385, −1258, −1110, −1201, −1053, −1163, −1255, |
| | | | −1107, −1207] |
| | RU 86 | [314: 339] | [−1252, −1104, −1213, −1065, −1157, −1011, −863, −954, |
| | | | −806, −917, −1008, −860, −962, −812, −914, −1005, −857, |
| | | | −968, −818, −911, −771, −635, −727, −579, −688, −540] |
| | RU 87 | [340: 365] | [−632, −733, −585, −685, −537, −628, −739, −591, −682, |
| | | | −534, −388, −480, −332, −441, −293, −385, −486, −338, |
| | | | −438, −290, −382, −492, −344, −435, −287, −160] |
| | RU 88 | [367: 392] | [−103, −214, −64, −157, −146, −109, −211, −61, −154, −66, |
| | | | −115, −208, −58, 87, 235, 143, 33, 181, 90, 238, 137, |
| | | | 36, 184, 93, 241, 131] |
| | RU 89 | [394: 419] | [187, 316, 464, 372, 262, 410, 319, 467, 365, 265, 413, |
| | | | 322, 470, 359, 268, 416, 561, 709, 618, 577, 656, 564, |
| | | | 714, 612, 760, 660] |
| | RU 90 | [420: 445] | [567, 717, 606, 754, 663, 790, 938, 847, 995, 885, 793, |
| | | | 941, 841, 989, 888, 796, 944, 835, 983, 891, 1037, 1185, |
| | | | 1094, 1242, 1131, 1040] |
| | RU 91 | [448: 473] | [1236, 1134, 1043, 1191, 1080, 1230, 1137, 1277, 1413, |
| | | | 1321, 1469, 1360, 1508, 1416, 1315, 1463, 1363, 1511, |
| | | | 1420, 1309, 1457, 1366, 1514, 1660, 1568, 1716] |
| | RU 92 | [474: 499] | [1607, 1755, 1663, 1562, 1710, 1610, 1758, 1666, 1556, |
| | | | 1704, 1613, 1761, 1888, 1797, 1945, 1834, 1984, 1891, |
| | | | 1902, 1939, 1837, 1987, 1894, 1982, 1933, 1840] |
| | RU 93 | [not defined] | |
| | RU 94 | [525: 550] | [−1804, −1895, −2006, −1858, −1949, −1801, −1901, −2003, |
| | | | −1855, −1946, −1798, −1908, −2000, −1852, −1723, −1575, |
| | | | −1667, −1777, −1629, −1720, −1572, −1673, −1774, −1626, |
| | | | −1717, −1569] |
| | RU 95 | [551: 576] | [−1679, −1771, −1623, −1478, −1328, −1421, −1470, −1382, |
| | | | −1475, −1325, −1427, −1390, −1379, −1472, −1322, −1433, |
| | | | −1285, −1376, −1249, −1101, −1192, −1044, −1154, −1246, |
| | | | −1098, −1198] |
| | RU 96 | [579: 604] | [−1243, −1095, −1204, −1056, −1148, −1002, −854, −945, |
| | | | −797, −908, −999, −851, −951, −803, −904, −996, −848, |
| | | | −957, −809, −901, −765, −625, −718, −568, −679, −531] |
| | RU 97 | [605: 630] | [−622, −724, −574, −676, −528, −619, −730, −582, −673, |
| | | | −525, −379, −471, −323, −432, −284, −376, −477, −329, |
| | | | −429, −281, −373, −483, −335, −426, −278, −151] |
| | RU 98 | [632: 657] | [−94, −205, −55, −148, −248, −100, −202, −52, −144, −65, |
| | | | −106, −197, −49, 96, 244, 153, 42, 190, 99, 247, 147, 45, |
| | | | 193, 102, 250, 140] |
| | RU 99 | [659: 684] | [196, 325, 473, 381, 271, 419, 328, 476, 375, 274, 422, |
| | | | 331, 479, 369, 277, 425, 570, 720, 627, 578, 666, 573, |
| | | | 723, 621, 658, 669] |
| | RU 100 | [685: 710] | [576, 726, 615, 763, 672, 799, 947, 856, 1004, 894, 802, |
| | | | 950, 850, 998, 897, 805, 953, 844, 992, 900, 1046, 1194, |
| | | | 1103, 1251, 1140, 1049] |
| | RU 101 | [713: 738] | [1245, 1144, 1052, 1200, 1091, 1239, 1147, 1283, 1423, |
| | | | 1330, 1480, 1369, 1517, 1426, 1324, 1474, 1372, 1520, |
| | | | 1429, 1318, 1466, 1375, 1523, 1669, 1577, 1725] |
| | RU 102 | [739: 764] | [1616, 1764, 1672, 1571, 1719, 1619, 1767, 1675, 1565, |
| | | | 1713, 1622, 1770, 1897, 1806, 1954, 1843, 1993, 1900, |
| | | | 1800, 1948, 1846, 1996, 1904, 1983, 1942, 1851] |
| | RU 103 | [772: 797] | [−2034, −1886, −1997, −1847, −1940, −1929, −1892, −1994, |
| | | | −1844, −1937, −1849, −1898, −1991, −1841, −1714, −1566, |
| | | | −1658, −1768, −1620, −1711, −1563, −1664, −1765, −1617, |
| | | | −1708, −1560] |
| | RU 104 | [798: 823] | [−1670, −1762, −1614, −1467, −1319, −1411, −1521, −1373, |
| | | | −1464, −1316, −1418, −1518, −1370, −1461, −1313, −1424, |
| | | | −1515, −1367, −1240, −1092, −1183, −1224, −1145, −1237, |
| | | | −1087, −1189] |
| | RU 105 | [826: 851] | [−1234, −1084, −1195, −1047, −1138, −993, −845, −936, |
| | | | −788, −898, −990, −842, −942, −794, −895, −987, −839, |
| | | | −948, −800, −892, −764, −616, −707, −559, −670, −761] |
| | RU 106 | [852: 877] | [−613, −715, −565, −667, −758, −610, −721, −571, −664, |
| | | | −524, −370, −462, −314, −423, −275, −367, −468, −320, |
| | | | −420, −272, −363, −474, −326, −417, −269, −141] |
| | RU 107 | [879: 904] | [−85, −194, −46, −138, −239, −91, −191, −43, −135, −245, |
| | | | −97, −188, −40, 105, 14, 162, 51, 201, 108, 119, 156, 54, |
| | | | 204, 111, 199, 150] |
| | RU 108 | [906: 931] | [207, 334, 482, 390, 280, 428, 337, 485, 384, 283, 431, |
| | | | 340, 488, 378, 286, 434, 581, 729, 637, 527, 675, 584, |
| | | | 732, 630, 530, 678] |
| | RU 109 | [932: 957] | [587, 735, 624, 533, 681, 808, 956, 865, 824, 903, 811, |
| | | | 961, 859, 1007, 907, 814, 964, 853, 1001, 910, 1055, 1203, |
| | | | 1112, 1260, 1150, 1058] |
| | RU 110 | [960: 985] | [1254, 1153, 1061, 1209, 1100, 1248, 1156, 1284, 1432, |
| | | | 1341, 1489, 1378, 1287, 1435, 1333, 1483, 1381, 1290, 1438, |
| | | | 1327, 1477, 1384, 1524, 1678, 1586, 1734] |
| | RU 111 | [986: 1011] | [1625, 1773, 1681, 1580, 1728, 1628, 1776, 1685, 1574, |
| | | | 1722, 1631, 1779, 1907, 1815, 1963, 1854, 2002, 1910, 1809, |
| | | | 1957, 1857, 2005, 1913, 1803, 1951, 1860] |
| | RU 112 | [1037: 1062] | [−2025, −1877, −1988, −1838, −1931, −2031, −1883, −1985, |
| | | | −1835, −1927, −1848, −1889, −1980, −1832, −1705, −1557, |
| | | | −1648, −1759, −1611, −1702, −1554, −1654, −1756, −1608, |
| | | | −1699, −1551] |
| | RU 113 | [1063: 1088] | [−1661, −1753, −1605, −1458, −1310, −1402, −1512, −1364, |
| | | | −1455, −1307, −1408, −1509, −1361, −1452, −1304, −1414, |
| | | | −1506, −1358, −1231, −1081, −1174, −1223, −1135, −1228, |
| | | | −1078, −1180] |
| | RU 114 | [1091: 1116] | [−1225, −1075, −1186, −1038, −1129, −984, −836, −927, −779, |
| | | | −889, −981, −833, −933, −785, −886, −978, −830, −939, −791, |
| | | | −883, −755, −607, −698, −550, −661, −752] |
| | RU 115 | [1117: 1142] | [−604, −704, −556, −657, −749, −601, −710, −562, −654, −500, |
| | | | −360, −453, −303, −414, −266, −357, −459, −309, −411, −263, |
| | | | −354, −465, −317, −408, −260, −132] |
| | RU 116 | [1144: 1169] | [−76, −185, −37, −129, −230, −82, −182, −34, −126, −236, |
| | | | −88, −179, −31, 114, 23, 171, 60, 210, 117, 17, 165, 63, |
| | | | 213, 121, 200, 159] |
| | RU 117 | [1171: 1196] | [216, 343, 491, 400, 289, 437, 346, 494, 394, 292, 440, 349, |
| | | | 497, 387, 295, 443, 590, 738, 646, 536, 684, 593, 741, 640, |
| | | | 539, 687] |
| | RU 118 | [1197: 1222] | [596, 744, 634, 542, 690, 817, 967, 874, 825, 913, 820, 970, |
| | | | 868, 905, 916, 823, 973, 862, 1010, 919, 1064, 1212, 1121, |
| | | | 1269, 1159, 1067] |
| | RU 119 | [1225: 1250] | [1263, 1162, 1070, 1218, 1109, 1257, 1165, 1293, 1441, 1350, |
| | | | 1498, 1387, 1296, 1444, 1344, 1492, 1391, 1299, 1447, 1338, |
| | | | 1486, 1394, 1548, 1688, 1595, 1745] |
| | RU 120 | [1251: 1276] | [1634, 1782, 1691, 1589, 1739, 1637, 1785, 1694, 1583, 1731, |
| | | | 1640, 1788, 1916, 1824, 1972, 1863, 2011, 1919, 1818, 1966, |
| | | | 1866, 2014, 1922, 1812, 1960, 1869] |
| | RU 121 | [1284: 1309] | [−2016, −1868, −1977, −1829, −1921, −2022, −1874, −1974, −1826, |
| | | | −1918, −2028, −1880, −1971, −1823, −1696, −1787, −1639, −1750, |
| | | | −1600, −1693, −1682, −1645, −1747, −1597, −1690, −1602] |
| | RU 122 | [1310: 1335] | [−1651, −1744, −1594, −1449, −1301, −1393, −1503, −1355, −1446, |
| | | | −1298, −1399, −1500, −1352, −1443, −1295, −1405, −1497, −1349, |
| | | | −1220, −1072, −1164, −1274, −1126, −1217, −1069, −1171] |
| | RU 123 | [1338: 1363] | [−1214, −1066, −1177, −1268, −1120, −975, −827, −918, −959, |
| | | | −880, −972, −822, −924, −776, −876, −969, −819, −930, −782, |
| | | | −873, −746, −598, −689, −541, −651, −743] |
| | RU 124 | [1364: 1389] | [−595, −695, −547, −648, −740, −592, −701, −553, −645, −499, |
| | | | −351, −442, −294, −405, −496, −348, −450, −300, −402, −493, |
| | | | −345, −456, −306, −399, −259, −123] |
| | RU 125 | [1391: 1416] | [−67, −176, −28, −120, −221, −73, −173, −25, −116, −227, −79, |
| | | | −170, −22, 124, 32, 180, 71, 219, 127, 26, 174, 74, 222, 130, |
| | | | 20, 168] |
| | RU 126 | [1418: 1443] | [225, 352, 261, 409, 298, 448, 355, 366, 403, 301, 451, 358, |
| | | | 446, 397, 304, 454, 599, 747, 655, 545, 693, 602, 750, 649, 548, |
| | | | 696] |
| | RU 127 | [1444: 1469] | [605, 753, 643, 551, 699, 828, 976, 884, 774, 922, 831, 979, |
| | | | 877, 777, 925, 834, 982, 871, 780, 928, 1073, 1221, 1130, 1089, |
| | | | 1168, 1076] |
| | RU 128 | [1472: 1497] | [1272, 1172, 1079, 1229, 1118, 1266, 1175, 1302, 1450, 1359, |
| | | | 1507, 1397, 1305, 1453, 1353, 1501, 1400, 1308, 1456, 1347, |
| | | | 1495, 1403, 1549, 1697, 1606, 1754] |
| | RU 129 | [1498: 1523] | [1643, 1552, 1700, 1598, 1748, 1646, 1555, 1703, 1592, 1742, |
| | | | 1649, 1789, 1925, 1833, 1981, 1872, 2020, 1928, 1827, 1975, |
| | | | 1875, 2023, 1932, 1821, 1969, 1878] |
| | RU 130 | [not defined] | |
| | RU 131 | [1549: 1574] | [−2007, −1859, −1968, −1820, −1912, −2013, −1865, −1965, −1817, |
| | | | −1909, −2019, −1871, −1962, −1814, −1687, −1778, −1630, −1741, |
| | | | −1591, −1684, −1784, −1636, −1738, −1588, −1680, −1601] |
| | RU 132 | [1575: 1600] | [−1642, −1733, −1585, −1440, −1292, −1383, −1494, −1346, −1437, |
| | | | −1289, −1389, −1491, −1343, −1434, −1286, −1396, −1488, −1340, |
| | | | −1211, −1063, −1155, −1265, −1117, −1208, −1060, −1161] |
| | RU 133 | [1603: 1628] | [−1205, −1057, −1167, −1259, −1111, −966, −816, −909, −958, −870, |
| | | | −963, −813, −915, −878, −867, −960, −810, −921, −773, −864, −737, |
| | | | −589, −680, −532, −642, −734] |
| | RU 134 | [1629: 1654] | [−586, −686, −538, −639, −731, −583, −692, −544, −636, −490, −342, |
| | | | −433, −285, −396, −487, −339, −439, −291, −392, −484, −336, −445, |
| | | | −297, −389, −253, −113] |
| | RU 135 | [1656: 1681] | [−56, −167, −19, −110, −212, −62, −164, −16, −107, −218, −70, −161, |
| | | | −13, 133, 41, 189, 80, 228, 136, 35, 183, 83, 231, 139, 29, 177] |
| | RU 136 | [1683: 1708] | [234, 361, 270, 418, 307, 457, 364, 264, 412, 310, 460, 368, 447, |
| | | | 406, 315, 463, 608, 756, 665, 554, 702, 611, 759, 659, 557, 705] |
| | RU 137 | [1709: 1734] | [614, 762, 652, 560, 708, 837, 985, 893, 783, 931, 840, 988, 887, |
| | | | 786, 934, 843, 991, 881, 789, 937, 1082, 1232, 1139, 1090, 1178, |
| | | | 1085] |
| | RU 138 | [1737: 1762] | [1170, 1181, 1088, 1238, 1127, 1275, 1184, 1311, 1459, 1368, 1516, |
| | | | 1406, 1314, 1462, 1362, 1510, 1409, 1317, 1465, 1356, 1504, 1412, |
| | | | 1558, 1706, 1615, 1763] |
| | RU 139 | [1763: 1788] | [1652, 1561, 1709, 1609, 1757, 1656, 1564, 1712, 1603, 1751, 1659, |
| | | | 1795, 1935, 1842, 1992, 1881, 2029, 1938, 1836, 1986, 1884, 2032, |
| | | | 1941, 1830, 1978, 1887] |
| | RU 140 | [1796: 1821] | [−1998, −1850, −1959, −1811, −1903, −2004, −1856, −1956, −1808, |
| | | | −1899, −2010, −1862, −1953, −1805, −1677, −1769, −1621, −1730, |
| | | | −1582, −1674, −1775, −1627, −1727, −1579, −1671, −1781] |
| | RU 141 | [1822: 1847] | [−1633, −1724, −1576, −1431, −1522, −1374, −1485, −1335, −1428, |
| | | | −1417, −1380, −1482, −1332, −1425, −1337, −1386, −1479, −1329, |
| | | | −1202, −1054, −1146, −1256, −1108, −1199, −1051, −1152] |
| | RU 142 | [1850: 1875] | [−1196, −1048, −1158, −1250, −1102, −955, −807, −899, −1009, −861, |
| | | | −952, −804, −906, −1006, −858, −949, −801, −912, −1003, −855, −728, |
| | | | −580, −671, −712, −633, −725] |
| | RU 143 | [1876: 1901] | [−575, −677, −529, −629, −722, −572, −683, −535, −626, −481, −333, |
| | | | −424, −276, −386, −478, −330, −430, −282, −383, −475, −327, −436, |
| | | | −288, −380, −252, −104] |
| | RU 144 | [1903: 1928] | [−47, −158, −249, −101, −203, −53, −155, −246, −98, −209, −59, |
| | | | −152, −12, 142, 50, 198, 89, 237, 145, 44, 192, 92, 240, 149, 38, |
| | | | 186] |
| | RU 145 | [1930: 1955] | [243, 371, 279, 427, 318, 466, 374, 273, 421, 321, 469, 377, 267, |
| | | | 415, 324, 472, 617, 526, 674, 563, 713, 620, 631, 668, 566, 716] |
| | RU 146 | [1956: 1981] | [623, 711, 662, 569, 719, 846, 994, 902, 792, 940, 849, 997, 896, |
| | | | 795, 943, 852, 1000, 890, 798, 946, 1093, 1241, 1149, 1039, 1187, |
| | | | 1096] |
| | RU 147 | [1984: 2009] | [1042, 1190, 1099, 1247, 1136, 1045, 1193, 1320, 1468, 1377, 1336, |
| | | | 1415, 1323, 1473, 1371, 1519, 1419, 1326, 1476, 1365, 1513, 1422, |
| | | | 1567, 1715, 1624, 1772] |
| | RU 148 | [2010: 2035] | [1662, 1570, 1718, 1618, 1766, 1665, 1573, 1721, 1612, 1760, 1668, |
| | | | 1796, 1944, 1853, 2001, 1890, 1799, 1947, 1845, 1995, 1893, 1802, |
| | | | 1950, 1839, 1989, 1896] |
| 52- | RU 1 | [−2035: −1984] | [26-tone RU1, 26-tone RU2] |
| tone | RU 2 | [−1981: −1930] | [26-tone RU3, 26-tone RU4] |
| RU | RU 3 | [−1901: −1850] | [26-tone RU6, 26-tone RU7] |
| | RU 4 | [−1847: −1796] | [26-tone RU8, 26-tone RU9] |
| | RU 5 | [−1788: −1737] | [26-tone RU10, 26-tone RU11] |
| | RU 6 | [−1734: −1683] | [26-tone RU12, 26-tone RU13] |
| | RU 7 | [−1654: −1603] | [26-tone RU15, 26-tone RU16] |
| | RU 8 | [−1600: −1549] | [26-tone RU17, 26-tone RU18] |
| | RU 9 | [−1523: −1472] | [26-tone RU20, 26-tone RU21] |
| | RU 10 | [−1469: −1418] | [26-tone RU22, 26-tone RU23] |
| | RU 11 | [−1389: −1338] | [26-tone RU25, 26-tone RU26] |
| | RU 12 | [−1335: −1284] | [26-tone RU27, 26-tone RU28] |
| | RU 13 | [−1276: −1225] | [26-tone RU29, 26-tone RU30] |
| | RU 14 | [−1222: −1171] | [26-tone RU31, 26-tone RU32] |
| | RU 15 | [−1142: −1091] | [26-tone RU34, 26-tone RU35] |
| | RU 16 | [−1088: −1037] | [26-tone RU36, 26-tone RU37] |
| | RU 17 | [−1011: −960] | [26-tone RU38, 26-tone RU39] |
| | RU 18 | [−957: −906] | [26-tone RU40, 26-tone RU41] |
| | RU 19 | [−877: −826] | [26-tone RU43, 26-tone RU44] |
| | RU 20 | [−823: −772] | [26-tone RU45, 26-tone RU46] |
| | RU 21 | [−764: −713] | [26-tone RU47, 26-tone RU48] |
| | RU 22 | [−710: −659] | [26-tone RU49, 26-tone RU50] |
| | RU 23 | [−630: −579] | [26-tone RU52, 26-tone RU53] |
| | RU 24 | [−576: −525] | [26-tone RU54, 26-tone RU55] |
| | RU 25 | [−499: −448] | [26-tone RU57, 26-tone RU58] |
| | RU 26 | [−445: −394] | [26-tone RU59, 26-tone RU60] |
| | RU 27 | [−365: −314] | [26-tone RU62, 26-tone RU63] |
| | RU 28 | [−311: −260] | [26-tone RU64, 26-tone RU65] |
| | RU 29 | [−252: −201] | [26-tone RU66, 26-tone RU67] |
| | RU 30 | [−198: −147] | [26-tone RU68, 26-tone RU69] |
| | RU 31 | [−118: −67] | [26-tone RU71, 26-tone RU72] |
| | RU 32 | [−64: −13] | [26-tone RU73, 26-tone RU74] |
| | RU 33 | [13: 64] | [26-tone RU75, 26-tone RU76] |
| | RU 34 | [67: 118] | [26-tone RU77, 26-tone RU78] |
| | RU 35 | [147: 198] | [26-tone RU80, 26-tone RU81] |
| | RU 36 | [201: 252] | [26-tone RU82, 26-tone RU83] |
| | RU 37 | [260: 311] | [26-tone RU84, 26-tone RU85] |
| | RU 38 | [314: 365] | [26-tone RU86, 26-tone RU87] |
| | RU 39 | [394: 445] | [26-tone RU89, 26-tone RU90] |
| | RU 40 | [448: 499] | [26-tone RU91, 26-tone RU92] |
| | RU 41 | [525: 576] | [26-tone RU94, 26-tone RU95] |
| | RU 42 | [579: 630] | [26-tone RU96, 26-tone RU97] |
| | RU 43 | [659: 710] | [26-tone RU99, 26-tone RU100] |
| | RU 44 | [713: 764] | [26-tone RU101, 26-tone RU102] |
| | RU 45 | [772: 823] | [26-tone RU103, 26-tone RU104] |
| | RU 46 | [826: 877] | [26-tone RU105, 26-tone RU106] |
| | RU 47 | [906: 957] | [26-tone RU108, 26-tone RU109] |
| | RU 48 | [960: 1011] | [26-tone RU110, 26-tone RU111] |
| | RU 49 | [1037: 1088] | [26-tone RU112, 26-tone RU113] |
| | RU 50 | [1091: 1142] | [26-tone RU114, 26-tone RU115] |
| | RU 51 | [1171: 1222] | [26-tone RU117, 26-tone RU118] |
| | RU 52 | [1225: 1276] | [26-tone RU119, 26-tone RU120] |
| | RU 53 | [1284: 1335] | [26-tone RU121, 26-tone RU122] |
| | RU 54 | [1338: 1389] | [26-tone RU123, 26-tone RU124] |
| | RU 55 | [1418: 1469] | [26-tone RU126, 26-tone RU127] |
| | RU 56 | [1472: 1523] | [26-tone RU128, 26-tone RU129] |
| | RU 57 | [1549: 1600] | [26-tone RU131, 26-tone RU132] |
| | RU 58 | [1603: 1654] | [26-tone RU133, 26-tone RU134] |
| | RU 59 | [1683: 1734] | [26-tone RU136, 26-tone RU137] |
| | RU 60 | [1737: 1788] | [26-tone RU138, 26-tone RU139] |
| | RU 61 | [1796: 1847] | [26-tone RU140, 26-tone RU141] |
| | RU 62 | [1850: 1901] | [26-tone RU142, 26-tone RU143] |
| | RU 63 | [1930: 1981] | [26-tone RU145, 26-tone RU146] |
| | RU 64 | [1984: 2035] | [26-tone RU147, 26-tone RU148] |
| 106- | RU 1 | [−2035: −1930] | [26-tone RU1, 26-tone RU2, −1142, −1244, 26-tone RU3, |
| tone | | | 26-tone RU4] |
| RU | RU 2 | [−1901: −1796] | [26-tone RU6, 26-tone RU7, 1105, 1253, 26-tone RU8, 26-tone RU9] |
| | RU 3 | [−1788: −1683] | [26-tone RU10, 26-tone RU11, −1133, −1235, 26-tone RU12, |
| | | | 26-tone RU13] |
| | RU 4 | [−1654: −1549] | [26-tone RU15, 26-tone RU16, 1114, 1262, 26-tone RU17, |
| | | | 26-tone RU18] |
| | RU 5 | [−1523: −1418] | [26-tone RU20, 26-tone RU21, −1124, −1226, 26-tone RU22, |
| | | | 26-tone RU23] |
| | RU 6 | [−1389: −1284] | [26-tone RU25, 26-tone RU26, 1123, 1271, 26-tone RU27, |
| | | | 26-tone RU28] |
| | RU 7 | [−1276: −1171] | [26-tone RU29, 26-tone RU30, −1115, −1215, 26-tone RU31, |
| | | | 26-tone RU32] |
| | RU 8 | [−1142: −1037] | [26-tone RU34, 26-tone RU35, 1132, 1143, 26-tone RU36, |
| | | | 26-tone RU37] |
| | RU 9 | [−1011: −906] | [26-tone RU38, 26-tone RU39, −1106, −1206, 26-tone RU40, |
| | | | 26-tone RU41] |
| | RU 10 | [−877: −772] | [26-tone RU43, 26-tone RU44, 1141, 1041, 26-tone RU45, |
| | | | 26-tone RU46] |
| | RU 11 | [−764: −659] | [26-tone RU47, 26-tone RU48, −1097, −1197, 26-tone RU49, |
| | | | 26-tone RU50] |
| | RU 12 | [−630: −525] | [26-tone RU52, 26-tone RU53, 1151, 1050, 26-tone RU54, |
| | | | 26-tone RU55] |
| | RU 13 | [−499: −394] | [26-tone RU57, 26-tone RU58, −1086, −1188, 26-tone RU59, |
| | | | 26-tone RU60] |
| | RU 14 | [−365: −260] | [26-tone RU62, 26-tone RU63, 1160, 1059, 26-tone RU64, |
| | | | 26-tone RU65] |
| | RU 15 | [−252: −147] | [26-tone RU66, 26-tone RU67, −1077, −1179, 26-tone RU68, |
| | | | 26-tone RU69] |
| | RU 16 | [−118: −13] | [26-tone RU71, 26-tone RU72, 1169, 1068, 26-tone RU73, |
| | | | 26-tone RU74] |
| | RU 17 | [13: 118] | [26-tone RU75, 26-tone RU76, −1068, −1169, 26-tone RU77, |
| | | | 26-tone RU78] |
| | RU 18 | [147: 252] | [26-tone RU80, 26-tone RU81, 1179, 1077, 26-tone RU82, |
| | | | 26-tone RU83] |
| | RU 19 | [260: 365] | [26-tone RU84, 26-tone RU85, −1059, −1160, 26-tone RU86, |
| | | | 26-tone RU87] |
| | RU 20 | [394: 499] | [26-tone RU89, 26-tone RU90, 1188, 1086, 26-tone RU91, |
| | | | 26-tone RU92] |
| | RU 21 | [525: 630] | [26-tone RU94, 26-tone RU95, −1050, −1151, 26-tone RU96, |
| | | | 26-tone RU97] |
| | RU 22 | [659: 764] | [26-tone RU99, 26-tone RU100, 1197, 1097, 26-tone RU101, |
| | | | 26-tone RU102] |
| | RU 23 | [772: 877] | [26-tone RU103, 26-tone RU104, −1041, −1141, 26-tone RU105, |
| | | | 26-tone RU106] |
| | RU 24 | [906: 1011] | [26-tone RU108, 26-tone RU109, 1206, 1106, 26-tone RU110, |
| | | | 26-tone RU111] |
| | RU 25 | [1037: 1142] | [26-tone RU112, 26-tone RU113, −1390, −1132, 26-tone RU114, |
| | | | 26-tone RU115] |
| | RU 26 | [1171: 1276] | [26-tone RU117, 26-tone RU118, 1215, 1115, 26-tone RU119, |
| | | | 26-tone RU120] |
| | RU 27 | [1284: 1389] | [26-tone RU121, 26-tone RU122, −1271, −1123, 26-tone RU123, |
| | | | 26-tone RU124] |
| | RU 28 | [1418: 1523] | [26-tone RU126, 26-tone RU127, 1226, 1124, 26-tone RU128, |
| | | | 26-tone RU129] |
| | RU 29 | [1549: 1654] | [26-tone RU131, 26-tone RU132, −1262, −1114, 26-tone RU133, |
| | | | 26-tone RU134] |
| | RU 30 | [1683: 1788] | [26-tone RU136, 26-tone RU137, 1235, 1133, 26-tone RU138, |
| | | | 26-tone RU139] |
| | RU 31 | [1796: 1901] | [26-tone RU140, 26-tone RU141, −1253, −1105 , 26-tone RU142, |
| | | | 26-tone RU143] |
| | RU 32 | [1930: 2035] | [26-tone RU145, 26-tone RU146, 1244, 1142, 26-tone RU147, |
| | | | 26-tone RU148] |
| 242- | RU 1 | [−2036: −1795] | [−2036, 26-tone RU1, 26-tone RU2, −1142, −1244, 26-tone RU3, |
| tone | | | 26-tone RU4, −95, 26-tone RU5, 195, 26-tone RU6, 26-tone RU7, |
| RU | | | 1105, 1253, 26-tone RU8, 26-tone RU9, 1906] |
| | RU 2 | [−1789: −1548] | [−2035, 26-tone RU10, 26-tone RU11, −1133, −1235, 26-tone RU12, |
| | | | 26-tone RU13, −86, 26-tone RU14, 206, 26-tone RU15, 26-tone RU16, |
| | | | 1114, 1262, 26-tone RU17, 26-tone RU18, 1915] |
| | RU 3 | [−1524: −1283] | [−2026, 26-tone RU20, 26-tone RU21, −1124, −1226, 26-tone RU22, |
| | | | 26-tone RU23, −77, 26-tone RU24, 215, 26-tone RU25, 26-tone RU26, |
| | | | 1123, 1271, 26-tone RU27, 26-tone RU28, 1924] |
| | RU 4 | [−1277: −1036] | [−2017, 26-tone RU29, 26-tone RU30, −1115, −1215, 26-tone RU31, |
| | | | 26-tone RU32, −68, 26-tone RU33, 224, 26-tone RU34, 26-tone RU35, |
| | | | 1132, 1143, 26-tone RU36, 26-tone RU37, 1934] |
| | RU 5 | [−1012: −771] | [−2008, 26-tone RU38, 26-tone RU39, −1106, −1206, 26-tone RU40, |
| | | | 26-tone RU41, −57, 26-tone RU42, 233, 26-tone RU43, 26-tone RU44, |
| | | | 1141, 1041, 26-tone RU45, 26-tone RU46, 1943] |
| | RU 6 | [−765: −524] | [−1999, 26-tone RU47, 26-tone RU48, −1097, −1197, 26-tone RU49, |
| | | | 26-tone RU50, −48, 26-tone RU51, 242, 26-tone RU52, 26-tone RU53, |
| | | | 1151, 1050, 26-tone RU54, 26-tone RU55, 1952] |
| | RU 7 | [−500: −259] | [−1990, 26-tone RU57, 26-tone RU58, −1086, −1188, 26-tone RU59, |
| | | | 26-tone RU60, −39, 26-tone RU61, 251, 26-tone RU62, 26-tone RU63, |
| | | | 1160, 1059, 26-tone RU64, 26-tone RU65, 1961] |
| | RU 8 | [−253: −12] | [−1979, 26-tone RU66, 26-tone RU67, −1077, −1179, 26-tone RU68, |
| | | | 26-tone RU69, −30, 26-tone RU70, 21, 26-tone RU71, 26-tone RU72, |
| | | | 1169, 1068, 26-tone RU73, 26-tone RU74, 1970] |
| | RU 9 | [12: 253] | [−1970, 26-tone RU75, 26-tone RU76, −1068, −1169, 26-tone RU77, |
| | | | 26-tone RU78, −21, 26-tone RU79, 30, 26-tone RU80, 26-tone RU81, |
| | | | 1179, 1077, 26-tone RU82, 26-tone RU83, 1979] |
| | RU 10 | [259: 500] | [−1961, 26-tone RU84, 26-tone RU85, −1059, −1160, 26-tone RU86, |
| | | | 26-tone RU87, −251, 26-tone RU88, 39, 26-tone RU89, 26-tone RU90, |
| | | | 1188, 1086, 26-tone RU91, 26-tone RU92, 1990] |
| | RU 11 | [524: 765] | [−1952, 631, 26-tone RU94, 26-tone RU95, −1050, −1151, 26-tone RU96, |
| | | | 26-tone RU97, −242, 26-tone RU98, 48, 26-tone RU99, 26-tone RU100, |
| | | | 1197, 1097, 26-tone RU101, 26-tone RU102, 1999] |
| | RU 12 | [771: 1012] | [−1943, 26-tone RU103, 26-tone RU104, −1041, −1141, 26-tone RU105, |
| | | | 26-tone RU106, −233, 26-tone RU107, 57, 26-tone RU108, 26-tone RU109, |
| | | | 1206, 1106, 26-tone RU110, 26-tone RU111, 2008] |
| | RU 13 | [1036: 1277] | [−1934, 26-tone RU112, 26-tone RU113, −1390, −1132, 26-tone RU114, |
| | | | 26-tone RU115, −224, 26-tone RU116, 68, 26-tone RU117, 26-tone RU118, |
| | | | 1215, 1115, 26-tone RU119, 26-tone RU120, 2017] |
| | RU 14 | [1283: 1524] | [−1924, 26-tone RU121, 26-tone RU122, −1271, −1123, 26-tone RU123, |
| | | | 26-tone RU124, −215, 26-tone RU125, 77, 26-tone RU126, 26-tone RU127, |
| | | | 1226, 1124, 26-tone RU128, 26-tone RU129, 2026] |
| | RU 15 | [1548: 1789] | [−1915, 26-tone RU131, 26-tone RU132, −1262, −1114, 26-tone RU133, |
| | | | 26-tone RU134, −206, 26-tone RU135, 86, 26-tone RU136, 26-tone RU137, |
| | | | 1235, 1133, 26-tone RU138, 26-tone RU139, 2035] |
| | RU 16 | [1795: 2036] | [−1906, 26-tone RU140, 26-tone RU141, −1253, −1105, 26-tone RU142, |
| | | | 26-tone RU143, −195, 26-tone RU144, 95, 26-tone RU145, 26-tone RU146, |
| | | | 1244, 1142, 26-tone RU147, 26-tone RU148, 2036] |
| 484- | RU 1 | [−2036: −1795, | [−2036, 26-tone RU1, 26-tone RU2, −1142, −1244, 26-tone RU3, 26-tone |
| tone | | −1789: −1548] | RU4, −95, 26-tone RU5, 195, 26-tone RU6, 26-tone RU7, 1105, 1253, |
| RU | | | 26-tone RU8, 26-tone RU9, 1906, −2035, 26-tone RU10, 26-tone RU11, |
| | | | −1133, −1235, 26-tone RU12, 26-tone RU13, −86, 26-tone RU14, 206, |
| | | | 26-tone RU15, 26-tone RU16, 1114, 1262, 26-tone RU17, 26-tone RU18, |
| | | | 1915] |
| | RU 2 | [−1524: −1283, | [−2026, 26-tone RU20, 26-tone RU21, −1124, −1226, 26-tone RU22, |
| | | −1277: −1036] | 26-tone RU23, −77, 26-tone RU24, 215, 26-tone RU25, 26-tone RU26, |
| | | | 1123, 1271, 26-tone RU27, 26-tone RU28, 1924, −2017, 26-tone RU29, |
| | | | 26-tone RU30, −1115, −1215, 26-tone RU31, 26-tone RU32, −68, |
| | | | 26-tone RU33, 224, 26-tone RU34, 26-tone RU35, 1132, 1143, |
| | | | 26-tone RU36, 26-tone RU37, 1934] |
| | RU 3 | [−1012: −771, | [−2008, 26-tone RU38, 26-tone RU39, −1106, −1206, 26-tone RU40, |
| | | −765 :−524] | 26-tone RU41, −57, 26-tone RU42, 233, 26-tone RU43, 26-tone RU44, |
| | | | 1141, 1041, 26-tone RU45, 26-tone RU46, 1943, −1999, 26-tone RU47, |
| | | | 26-tone RU48, −1097, −1197, 26-tone RU49, 26-tone RU50, −48, |
| | | | 26-tone RU51, 242, 26-tone RU52, 26-tone RU53, 1151, 1050, |
| | | | 26-tone RU54, 26-tone RU55, 1952] |
| | RU 4 | [−500 :−259, | [−1990, 26-tone RU57, 26-tone RU58, −1086, −1188, 26-tone RU59, |
| | | −253: −12] | 26-tone RU60, −39, 26-tone RU61, 251, 26-tone RU62, 26-tone RU63, |
| | | | 1160, 1059, 26-tone RU64, 26-tone RU65, 1961, −1979, 26-tone RU66, |
| | | | 26-tone RU67, −1077, −1179, 26-tone RU68, 26-tone RU69, −30, |
| | | | 26-tone RU70, 21, 26-tone RU71, 26-tone RU72, 1169, 1068, |
| | | | 26-tone RU73, 26-tone RU74, 1970] |
| | RU 5 | [12: 253, | [−1970, 26-tone RU75, 26-tone RU76, −1068, −1169, 26-tone RU77, |
| | | 259: 500] | 26-tone RU78, −21, 26-tone RU79, 30, 26-tone RU80, 26-tone RU81, |
| | | | 1179, 1077, 26-tone RU82, 26-tone RU83, 1979, −1961, 26-tone RU84, |
| | | | 26-tone RU85, −1059, −1160, 26-tone RU86, 26-tone RU87, −251, |
| | | | 26-tone RU88, 39, 26-tone RU89, 26-tone RU90, 1188, 1086, |
| | | | 26-tone RU91, 26-tone RU92, 1990] |
| | RU 6 | [524: 765, | [−1952, 631, 26-tone RU94, 26-tone RU95, −1050, −1151, 26-tone RU96, |
| | | 771: 1012] | 26-tone RU97, −242, 26-tone RU98, 48, 26-tone RU99, 26-tone RU100, |
| | | | 1197, 1097, 26-tone RU101, 26-tone RU102, 1999, −1943, 26-tone RU103, |
| | | | 26-tone RU104, −1041, −1141, 26-tone RU105, 26-tone RU106, −233, |
| | | | 26-tone RU107, 57, 26-tone RU108, 26-tone RU109, 1206, 1106, |
| | | | 26-tone RU110, 26-tone RU111, 2008] |
| | RU 7 | [1036: 1277, | [−1934, 26-tone RU112, 26-tone RU113, −1390, −1132, 26-tone RU114, |
| | | 1283: 1524] | 26-tone RU115, −224, 26-tone RU116, 68, 26-tone RU117, 26-tone RU118, |
| | | | 1215, 1115, 26-tone RU119, 26-tone RU120, 2017, −1924, 26-tone RU121, |
| | | | 26-tone RU122, −1271, −1123, 26-tone RU123, 26-tone RU124, −215, |
| | | | 26-tone RU125, 77, 26-tone RU126, 26-tone RU127, 1226, 1124, |
| | | | 26-tone RU128, 26-tone RU129, 2026] |
| | RU 8 | [1548: 1789, | [−1915, 26-tone RU131, 26-tone RU132, −1262, −1114, 26-tone RU133, |
| | | 1795: 2036] | 26-tone RU134, −206, 26-tone RU135, 86, 26-tone RU136, 26-tone RU137, |
| | | | 1235, 1133, 26-tone RU138, 26-tone RU139, 2035, −1906, 26-tone RU140, |
| | | | 26-tone RU141, −1253, −1105, 26-tone RU142, 26-tone RU143, −195, |
| | | | 26-tone RU144, 95, 26-tone RU145, 26-tone RU146, 1244, 1142, |
| | | | 26-tone RU147, 26-tone RU148, 2036] |
| 996- | RU 1 | [−2036 :−1539, | [−2036, 26-tone RU1, 26-tone RU2, −1142, −1244, 26-tone RU3, |
| tone | | −1533: −1036] | 26-tone RU4, −95, 26-tone RU5, 195, 26-tone RU6, 26-tone RU7, 1105, |
| RU | | | 1253, 26-tone RU8, 26-tone RU9, 1906, −1794, −1793, −1792, −1791, |
| | | | −1790, −2035, 26-tone RU10, 26-tone RU11, −1133, −1235, 26-tone RU12, |
| | | | 26-tone RU13, −86, 26-tone RU14, 206, 26-tone RU15, 26-tone RU16, |
| | | | 1114, 1262, 26-tone RU17, 26-tone RU18, 1915, −1547, −1546, −1545, |
| | | | −1544, −1543, −1542, −1541, −1540, −1539, −1533, −1532, −1531, |
| | | | −1530, −1529, −1528, −1527, −1526, −1525, −2026, 26-tone RU20, |
| | | | 26-tone RU21, −1124, −1226, 26-tone RU22, 26-tone RU23, −77, |
| | | | 26-tone RU24, 215, 26-tone RU25, 26-tone RU26, 1123, 1271, |
| | | | 26-tone RU27, 26-tone RU28, 1924, −1282, −1281, −1280, −1279, −1278, |
| | | | −2017, 26-tone RU29, 26-tone RU30, −1115, −1215, 26-tone RU31, |
| | | | 26-tone RU32, −68, 26-tone RU33, 224, 26-tone RU34, 26-tone RU35, |
| | | | 1132, 1143, 26-tone RU36, 26-tone RU37, 1934] |
| | RU 2 | [−1012: −515, | [−2008, 26-tone RU38, 26-tone RU39, −1106, −1206, 26-tone RU40, |
| | | −509: −12] | 26-tone RU41, −57, 26-tone RU42, 233, 26-tone RU43, 26-tone RU44, |
| | | | 1141, 1041, 26-tone RU45, 26-tone RU46, 1943, −770, −769, −768, −767, |
| | | | −766, −1999, 26-tone RU47, 26-tone RU48, −1097, −1197, 26-tone RU49, |
| | | | 26-tone RU50, −48, 26-tone RU51, 242, 26-tone RU52, 26-tone RU53, 1151, |
| | | | 1050, 26-tone RU54, 26-tone RU55, 1952, −523, −522, −521, −520, −519, |
| | | | −518, −517, −516, −515, −509, −508, −507, −506, −505, −504, −503, −502, |
| | | | −501, −1990, 26-tone RU57, 26-tone RU58, −1086, −1188, 26-tone RU59, |
| | | | 26-tone RU60, −39, 26-tone RU61, 251, 26-tone RU62, 26-tone RU63, 1160, |
| | | | 1059, 26-tone RU64, 26-tone RU65, 1961, −258, −257, −256, −255, −254, |
| | | | −1979, 26-tone RU66, 26-tone RU67, −1077, −1179, 26-tone RU68, 26-tone RU69, |
| | | | −30, 26-tone RU70, 21, 26-tone RU71, 26-tone RU72, 1169, 1068, 26-tone RU73, |
| | | | 26-tone RU74, 1970] |
| | RU 3 | [12: 509, | [−1970, 26-tone RU75, 26-tone RU76, −1068, −1169, 26-tone RU77, |
| | | 515: 1012] | 26-tone RU78, −21, 26-tone RU79, 30, 26-tone RU80, 26-tone RU81, 1179, |
| | | | 1077, 26-tone RU82, 26-tone RU83, 1979, 254, 255, 256, 257, 258, −1961, |
| | | | 26-tone RU84, 26-tone RU85, −1059, −1160, 26-tone RU86, 26-tone RU87, |
| | | | −251, 26-tone RU88, 39, 26-tone RU89, 26-tone RU90, 1188, 1086, |
| | | | 26-tone RU91, 26-tone RU92, 1990, 501, 502, 503, 504, 505, 506, 507, 508, |
| | | | 509, 515, 516, 517, 518, 519, 520, 521, 522, 523, −1952, 631, 26-tone RU94, |
| | | | 26-tone RU95, −1050, −1151, 26-tone RU96, 26-tone RU97, −242, |
| | | | 26-tone RU98, 48, 26-tone RU99, 26-tone RU100, 1197, 1097, 26-tone RU101, |
| | | | 26-tone RU102, 1999, 766, 767, 768, 769, 770, −1943, 26-tone RU103, |
| | | | 26-tone RU104, −1041, −1141, 26-tone RU105, 26-tone RU106, −233, |
| | | | 26-tone RU107, 57, 26-tone RU108, 26-tone RU109, 1206, 1106, 26-tone RU110, |
| | | | 26-tone RU111, 2008] |
| | RU 4 | [1036: 1533, | [−1934, 26-tone RU112, 26-tone RU113, −1390, −1132, 26-tone RU114, |
| | | 1539: 2036] | 26-tone RU115, −224, 26-tone RU116, 68, 26-tone RU117, 26-tone RU118, |
| | | | 1215, 1115, 26-tone RU119, 26-tone RU120, 2017, 1278, 1279, 1280, |
| | | | 1281, 1282, −1924, 26-tone RU121, 26-tone RU122, −1271, −1123, |
| | | | 26-tone RU123, 26-tone RU124, −215, 26-tone RU125, 77, 26-tone RU126, |
| | | | 26-tone RU127, 1226, 1124, 26-tone RU128, 26-tone RU129, 2026, 1525, 1526, |
| | | | 1527, 1528, 1529, 1530, 1531, 1532, 1533, 1539, 1540, 1541, 1542, 1543, |
| | | | 1544, 1545, 1546, 1547, −1915, 26-tone RU131, 26-tone RU132, −1262, |
| | | | −1114, 26-tone RU133, 26-tone RU134, −206, 26-tone RU135, 86, |
| | | | 26-tone RU136, 26-tone RU137, 1235, 1133, 26-tone RU138, 26-tone RU139, |
| | | | 2035, 1790, 1791, 1792, 1793, 1794, −1906, 26-tone RU140, |
| | | | 26-tone RU141, −1253, −1105, 26-tone RU142, 26-tone RU143, −195, |
| | | | 26-tone RU144, 95, 26-tone RU145, 26-tone RU146, 1244, 1142, |
| | | | 26-tone RU147, 26-tone RU148, 2036] |
| 2 × 996- | RU 1 | [−2036: −1539, | [−2036, 26-tone RU1, 26-tone RU2, −1142, −1244, 26-tone RU3, |
| tone | | −1533: −1036, | 26-tone RU4, −95, 26-tone RU5, 195, 26-tone RU6, 26-tone RU7, 1105, |
| RU | | −1012: −515, | 1253, 26-tone RU8, 26-tone RU9, 1906, −1794, −1793, −1792, −1791, |
| | | −509: −12] | −1790, −2035, 26-tone RU10, 26-tone RU11, −1133, −1235, |
| | | | 26-tone RU12, 26-tone RU13, −86, 26-tone RU14, 206, 26-tone RU15, |
| | | | 26-tone RU16, 1114, 1262, 26-tone RU17, 26-tone RU18, 1915, −1547, |
| | | | −1546, −1545, −1544, −1543, −1542, −1541, −1540, −1539, −1533, |
| | | | −1532, −1531, −1530, −1529, −1528, −1527, −1526, −1525, −2026, |
| | | | 26-tone RU20, 26-tone RU21, −1124, −1226, 26-tone RU22, 26-tone RU23, |
| | | | −77, 26-tone RU24, 215, 26-tone RU25, 26-tone RU26, 1123, 1271, |
| | | | 26-tone RU27, 26-tone RU28, 1924, −1282, −1281, −1280, −1279, −1278, |
| | | | −2017, 26-tone RU29, 26-tone RU30, −1115, −1215, 26-tone RU31, |
| | | | 26-tone RU32, −68, 26-tone RU33, 224, 26-tone RU34, 26-tone RU35, |
| | | | 1132, 1143, 26-tone RU36, 26-tone RU37, 1934, −2008, 26-tone RU38, |
| | | | 26-tone RU39, −1106, −1206, 26-tone RU40, 26-tone RU41, −57, |
| | | | 26-tone RU42, 233, 26-tone RU43, 26-tone RU44, 1141, 1041, 26-tone RU45, |
| | | | 26-tone RU46, 1943, −770, −769, −768, −767, −766, −1999, 26-tone RU47, |
| | | | 26-tone RU48, −1097, −1197, 26-tone RU49, 26-tone RU50, −48, |
| | | | 26-tone RU51, 242, 26-tone RU52, 26-tone RU53, 1151, 1050, 26-tone RU54, |
| | | | 26-tone RU55, 1952, −523, −522, −521, −520, −519, −518, −517, −516, |
| | | | −515, −509, −508, −507, −506, −505, −504, −503, −502, −501, −1990, |
| | | | 26-tone RU57, 26-tone RU58, −1086, −1188, 26-tone RU59, 26-tone RU60, |
| | | | −39, 26-tone RU61, 251, 26-tone RU62, 26-tone RU63, 1160, 1059, |
| | | | 26-tone RU64, 26-tone RU65, 1961, −258, −257, −256, −255, −254, |
| | | | −1979, 26-tone RU66, 26-tone RU67, −1077, −1179, 26-tone RU68, |
| | | | 26-tone RU69, −30, 26-tone RU70, 21, 26-tone RU71, 26-tone RU72, |
| | | | 1169, 1068, 26-tone RU73, 26-tone RU74, 1970] |
| | RU 2 | [12: 509, | [−1970, 26-tone RU75, 26-tone RU76, −1068, −1169, 26-tone RU77, |
| | | 515: 1012, | 26-tone RU78, −21, 26-tone RU79, 30, 26-tone RU80, 26-tone RU81, |
| | | 1036: 1533, | 1179, 1077, 26-tone RU82, 26-tone RU83, 1979, 254, 255, 256, 257, |
| | | 1539: 2036] | 258, −1961, 26-tone RU84, 26-tone RU85, −1059, −1160, 26-tone RU86, |
| | | | 26-tone RU87, −251, 26-tone RU88, 39, 26-tone RU89, 26-tone RU90, |
| | | | 1188, 1086, 26-tone RU91, 26-tone RU92, 1990, 501, 502, 503, 504, |
| | | | 505, 506, 507, 508, 509, 515, 516, 517, 518, 519, 520, 521, 522, |
| | | | 523, −1952, 631, 26-tone RU94, 26-tone RU95, −1050, −1151, |
| | | | 26-tone RU96, 26-tone RU97, −242, 26-tone RU98, 48, 26-tone RU99, |
| | | | 26-tone RU100, 1197, 1097, 26-tone RU101, 26-tone RU102, 1999, |
| | | | 766, 767, 768, 769, 770, −1943, 26-tone RU103, 26-tone RU104, |
| | | | −1041, −1141, 26-tone RU105, 26-tone RU106, −233, 26-tone RU107, |
| | | | 57, 26-tone RU108, 26-tone RU109, 1206, 1106, 26-tone RU110, |
| | | | 26-tone RU111, 2008, −1934, 26-tone RU112, 26-tone RU113, −1390, |
| | | | −1132, 26-tone RU114, 26-tone RU115, −224, 26-tone RU116, 68, |
| | | | 26-tone RU117, 26-tone RU118, 1215, 1115, 26-tone RU119, |
| | | | 26-tone RU120, 2017, 1278, 1279, 1280, 1281, 1282, −1924, |
| | | | 26-tone RU121, 26-tone RU122, −1271, −1123, 26-tone RU123, |
| | | | 26-tone RU124, −215, 26-tone RU125, 77, 26-tone RU126, |
| | | | 26-tone RU127, 1226, 1124, 26-tone RU128, 26-tone RU129, 2026, |
| | | | 1525, 1526, 1527, 1528, 1529, 1530, 1531, 1532, 1533, 1539, |
| | | | 1540, 1541, 1542, 1543, 1544, 1545, 1546, 1547, −1915, 26-tone RU131, |
| | | | 26-tone RU132, −1262, −1114, 26-tone RU133, 26-tone RU134, −206, |
| | | | 26-tone RU135, 86, 26-tone RU136, 26-tone RU137, 1235, 1133, |
| | | | 26-tone RU138, 26-tone RU139, 2035, 1790, 1791, 1792, 1793, 1794, |
| | | | −1906, 26-tone RU140, 26-tone RU141, −1253, −1105, 26-tone RU142, |
| | | | 26-tone RU143, −195, 26-tone RU144, 95, 26-tone RU145, 26-tone RU146, |
| | | | 1244, 1142, 26-tone RU147, 26-tone RU148, 2036] |

Note:
An undermarked tone index indicates a tone that does not participate in the shot-2 distributed tone mapping in the two-shot distributed tone mapping.

### 5.3 Construction of a Logical MRU

For the construction of the logical MRU, the logical MRU is constructed by using the logical RU in the one-shot distributed tone mapping, or the logical MRU is constructed by using the logical RU in the two-shot distributed tone mapping.
Example 15: Construction of different types of logical MRUs by using a logical tone obtained by 26-tone RU-based distributed tone mapping within bandwidths of 20 MHz and 40 MHz is separately shown.

In Example 15, the construction of a logical MRU within bandwidths of 20 MHz and 40 MHz is separately shown. A logical RU that participates in construction may be a logical RU in the one-shot distributed tone mapping, or may be a logical RU in the two-shot distributed tone mapping.

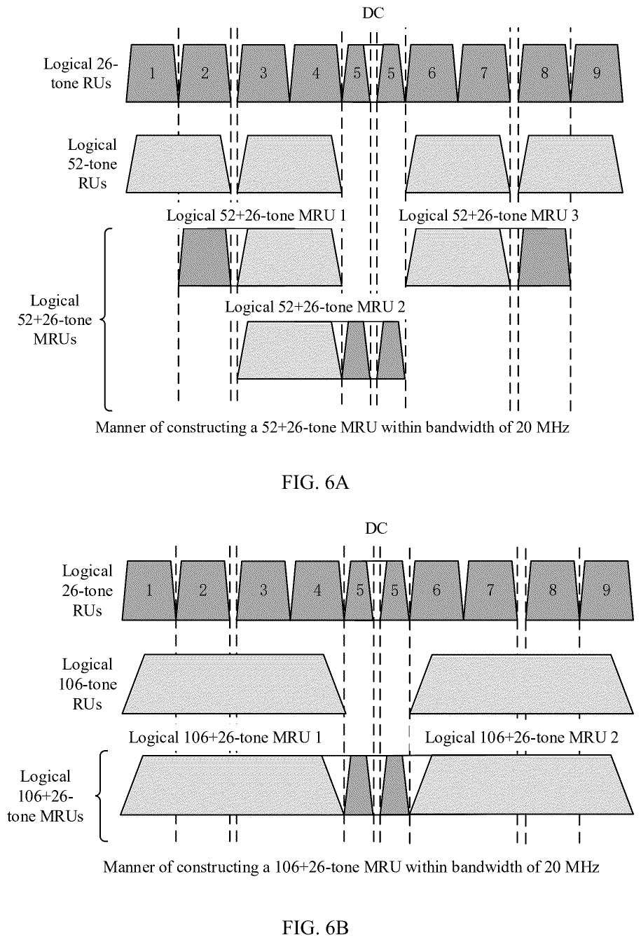

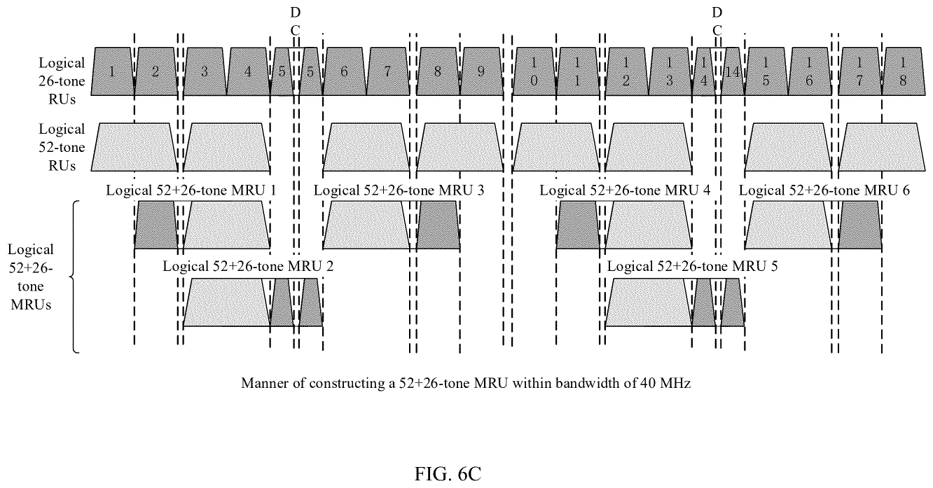

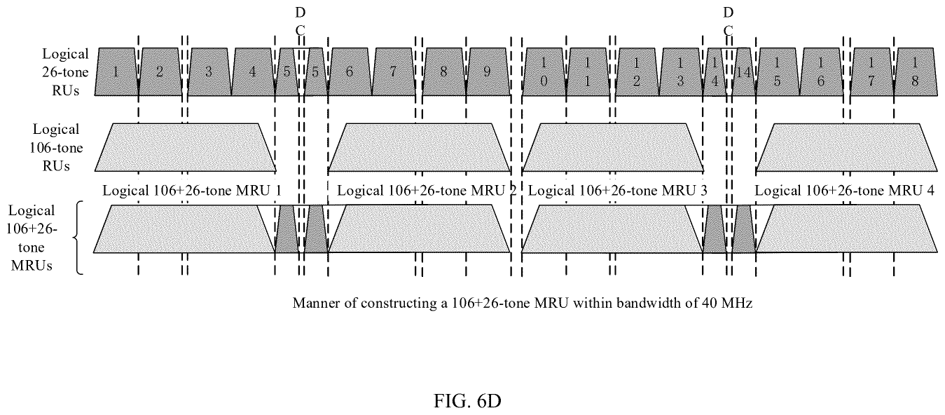

For example, as shown in FIG. 6A, during the 20-MHz OFDMA PPDU transmission, three types of logical 52+26-tone MRUs are allowed. A logical 52+26-tone MRU 1 consists of a logical 26-tone RU 2 and a logical 52-tone RU 2; a logical 52+26-tone MRU 2 consists of a logical 26-tone RU 5 and a logical 52-tone RU 2; and a logical 52+26-tone MRU 3 consists of a logical 26-tone RU 8 and a logical 52-tone RU 3.

For another example, as shown in FIG. 6B, during the 20-MHz OFDMA PPDU transmission, two types of logical 106+26-tone MRUs are allowed. A logical 106+26-tone MRU 1 consists of a logical 26-tone RU 5 and a logical 106-tone RU 1; and a logical 106+26-tone MRU 2 consists of a logical 26-tone RU 5 and a logical 106-tone RU 2.

For another example, as shown in FIG. 6C, during the 40-MHz OFDMA PPDU transmission, six types of logical 52+26-tone MRUs are allowed. A logical 52+26-tone MRU 1 consists of a logical 26-tone RU 2 and a logical 52-tone RU 2; a logical 52+26-tone MRU 2 consists of a logical 26-tone RU 5 and a logical 52-tone RU 2; a logical 52+26-tone MRU 3 consists of a logical 26-tone RU 8 and a logical 52-tone RU 3; a logical 52+26-tone MRU 4 consists of a logical 26-tone RU 11 and a logical 52-tone RU 6; a logical 52+26-tone MRU 5 consists of a logical 26-tone RU 14 and a logical 52-tone RU 6; and a logical 52+26-tone MRU 6 consists of a logical 26-tone RU 17 and a logical 52-tone RU 7.

For another example, as shown in FIG. 6D, during the 40-MHz OFDMA PPDU transmission, four types of logical 106+26-tone MRUs are allowed. A logical 106+26-tone MRU 1 consists of a logical 26-tone RU 5 and a logical 106-tone RU 1; a logical 106+26-tone MRU 2 consists of a logical 26-tone RU 5 and a logical 106-tone RU 2; a logical 106+26-tone MRU 3 consists of a logical 26-tone RU 14 and a logical 106-tone RU 3; and a logical 106+26-tone MRU 4 consists of a logical 26-tone RU 14 and a logical 106-tone RU 4.

In a related technology, during the construction of a physical MRU, to reduce interference to a neighboring punctured 20-MHz channel, an edge RU is not selected to construct the MRU. For example, in a manner of constructing a physical 52+26-tone MRU within the 20-MHz bandwidth, a 26-tone RU 1 and a 26-tone RU 9 near a bandwidth edge do not participate in the construction of an MRU.

However, after the distributed tone mapping, a non-edge logical tone may be mapped to an edge physical tone of the bandwidth, so that tones that form a logical MRU may be located on an edge of the bandwidth, and therefore, interference may be caused to a neighboring punctured 20-MHz channel.

In the embodiments of the present disclosure, there are the following two exemplary options for the logical RU allocation mode.
Option 1: In the logical RU allocation mode, a logical RU and/or a logical MRU are allocated, and a logical MRU is constructed by using the logical RU in a manner of constructing a physical MRU.
Option 2: In the logical RU allocation mode, only a logical RU can be allocated, that is, a logical MRU is not defined; and in a physical RU allocation mode, a physical RU or a physical MRU may be allocated.

In the embodiments of the present disclosure, in consideration of a case of a non-punctured channel and a case of a punctured channel, the “four-step mapping approach” is proposed, which improves a specific implementation procedure and a use scenario of the distributed tone mapping, and is better compatible with a next-generation WiFi communication standard.

In the “four-step mapping approach”, for a mapping process from a first tone index to a second tone index and a mapping process from a third tone index to a fourth tone index, in the embodiments of the present disclosure, not only formula calculation may be used to perform mapping, but also a table lookup manner may be used to perform mapping. Memory overheads are increased each time the table lookup method needs to be executed.

For the construction of the logical RU, in the embodiments of the present disclosure, physical tone indexes of logical RUs are sequentially selected to construct an RU, for example, Table 12. Alternatively, physical tone indexes of logical RUs are unsequentially selected to construct an RU, for example, as shown in Table 12.

TABLE 12
Construction of a logical RU within a bandwidth of
20 MHz in the embodiments of the present disclosure

| Logical | Logical | Logical tone | |
|---|---|---|---|
| RU | RU | index of a | |
| type | index | logical RU | Physical tone index of a logical RU |
| 26- | RU 1 | [−121: −96] | [−121, −112, −103, 94, −85, −76, −66, −57, −48, −39, |
| tone | | | −30, −21, −12, 4, 13, 22, 31, 40, 49, 58, 67, 77, 86, 95, 104, 113] |
| RU | RU 2 | [−95: −70] | [−120, −111, −102, −93, −84, −75, −65, −56, −47, −38, |
| | | | −29, −20, −11, 5, 14, 23, 32, 41, 50, 59, 68, 78, 87, 96, 105, 114] |
| | RU 3 | [−68: −43] | [−119, −110, −101, −92, −83, −74, −64, −55, −46, −37, |
| | | | −28, −19, −10, 6, 15, 24, 33, 42, 51, 60, 70, 79, 88, 97, 106, 115] |
| | RU 4 | [−42: −17] | [−118, −109, −100, −91, −82, −73, −63, −54, −45, −36, |
| | | | −27, −18, −9, 7, 16, 25, 34, 43, 52, 61, 71, 80, 89, 98, 107, 116] |

TABLE 13
Solution extension

| Logical | Logical | Logical tone | |
|---|---|---|---|
| RU | RU | index of a | |
| type | index | logical RU | Physical tone index of a logical RU |
| 26- | RU 1 | [−121: −96] | [−120, −111, −102, −93, −84, −75, −65, −56, −47, −38, |
| tone | | | −29, −20, −11, 5, 14, 23, 32, 41, 50, 59, 68, 78, 87, 96, 105, 114] |
| RU | RU 2 | [−95: −70] | [−118, −109, −100, −91, −82, −73, −63, −54, −45, −36, |
| | | | −27, −18, −9, 7, 16, 25, 34, 43, 52, 61, 71, 80, 89, 98, 107, 116] |
| | RU 3 | [−68: −43] | [−121, −112, −103, 94, −85, −76, −66, −57, −48, −39, |
| | | | −30, −21, −12, 4, 13, 22, 31, 40, 49, 58, 67, 77, 86, 95, 104, 113] |
| | RU 4 | [−42: −17] | [−119, −110, −101, −92, −83, −74, −64, −55, −46, −37, |
| | | | −28, −19, −10, 6, 15, 24, 33, 42, 51, 60, 70, 79, 88, 97, 106, 115] |

FIG. 7 is a schematic diagram of a structure of a communication device 700 according to some embodiments of the present disclosure. The communication device 700 includes a processor 710. The processor 710 may invoke and run a computer program in a memory to enable the communication device 700 to implement the methods in the embodiments of the present disclosure.

In some embodiments, the communication device 700 further includes a memory 720. The processor 710 invokes and runs a computer program in the memory 720 to enable the communication device 700 to implement the methods in the embodiments of the present disclosure.

The memory 720 is a separate component independent of the processor 710 or is integrated in the processor 710.

In some embodiments, the communication device 700 further includes a transceiver 730. The processor 710 controls the transceiver 730 to communicate with other devices, specifically, to send information or data to other devices or receive information or data sent by other devices.

The transceiver 730 includes a transmitter and a receiver. The transceiver 730 further includes one or more antennas.

In some embodiments, the communication device 700 is any communication device in the embodiments of the present disclosure. The communication device 700 implements a corresponding process implemented by the communication device in the method 200 in the embodiments of the present disclosure. For brevity, details are not described herein again.

FIG. 8 is a schematic diagram of a structure of a chip 800 according to some embodiments of the present disclosure. The chip 800 includes a processor 810. The processor 810 invokes and runs a computer program in a memory to implement the methods in the embodiments of the present disclosure.

In some embodiments, the chip 800 further includes a memory 820. The processor 810 invokes and runs a computer program in the memory 820 to implement the methods performed by the communication device in the embodiments of the present disclosure.

The memory 820 is a separate component independent of the processor 810 or is integrated in the processor 810.

In some embodiments, the chip 800 further includes an input interface 830. The processor 810 controls the input interface 830 to communicate with other devices or chips, specifically, to obtain information or data sent by other devices or chips.

In some embodiments, the chip 800 further includes an output interface 840. The processor 810 controls the output interface 840 to communicate with other devices or chips, specifically, to output information or data to other devices or chips.

In some embodiments, the chip is applicable to the communication device in the embodiments of the present disclosure. The chip implements a corresponding process implemented by the communication device in each method in the embodiments of the present disclosure. For brevity, details are not described herein again.

Chips applied to different communication devices are the same chip or different chips.

It should be understood that the chip in the embodiments of the present disclosure is also referred to as a system-shot chip, a system chip, a chip system, an on-chip system, or the like.

The processor mentioned above is a general-purpose processor, a digital signal processor (DSP), a field-programmable gate array (FPGA), an application specific integrated circuit (ASIC) or another programmable logic device, a transistor logic device, a discrete hardware components, or the like. The general-purpose processor mentioned above is a microprocessor, any conventional processor, or the like.

The memory mentioned above is a transitory memory or a non-transitory memory, or includes both a transitory memory and a non-transitory memory. The non-transitory memory is a read-only memory (ROM), a programmable read-only memory (PROM), an erasable programmable read-only memory (EPROM), an electrically erasable programmable read-only memory (EEPROM), or a flash memory. The transitory memory is a random access memory (RAM).

It should be understood that the foregoing description of the memory is exemplary but not limiting description. For example, the memory in the embodiments of the present disclosure is alternatively a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), a direct rambus random access memory (DR RAM), or the like. In other words, the memory in the embodiments of the present disclosure is intended to include, but not be limited to, these and any other suitable types of memory.

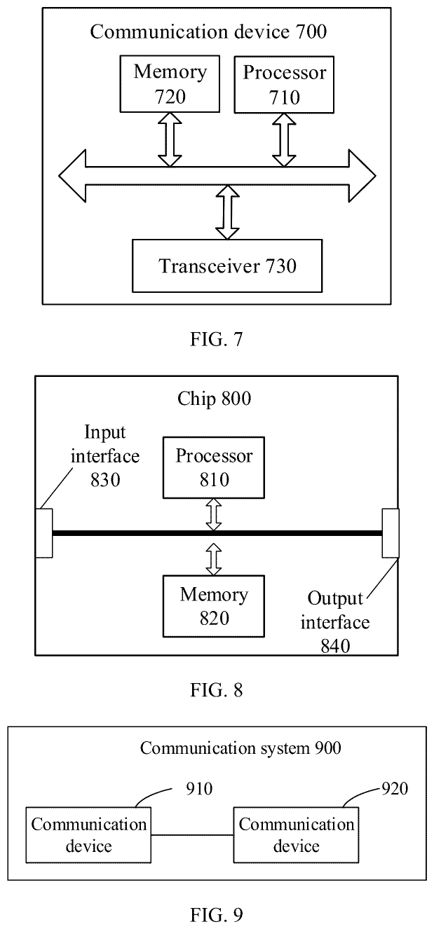

FIG. 9 is a schematic block diagram of a communication system 900 according to some embodiments of the present disclosure. The communication system 900 includes a communication device 910.

The communication device 910 is configured to perform distributed tone mapping on a first RU.

In some embodiments, the communication device 910 is further configured to construct a second RU by using tone indexes obtained by the distributed tone mapping.

In some embodiments, the communication device 910 is further configured to allocate resource units to a communication device 920.

In some embodiments, the communication system 900 further includes the communication device 920, configured to obtain the resource units allocated by the communication device 910 to the communication device 920.

In some embodiments, the communication device 910 is an AP, and the communication device 920 is a STA.

The communication device 910 is configured to implement a corresponding function implemented by the communication device in the foregoing method 200. For brevity, details are not repeated herein.

Some or all of the functions in the foregoing embodiments are implemented by software, hardware, firmware, or any combination thereof. When software is used for implementation, the implementation is performed in a form of a computer program product in whole or in part. The computer program product includes one or more computer instructions. When the computer program instructions are loaded and executed on a computer, some or all of the processes or functions according to the embodiments of the present disclosure are implemented. The computer is a general-purpose computer, a dedicated computer, a computer network, or another programmable apparatus. The computer instructions may be stored in a computer-readable storage medium or are transmitted from a computer-readable storage medium to another computer-readable storage medium. For example, the computer instructions are transmitted from a website, computer, server, or data center to another website, computer, server, or data center in a wired (for example, a coaxial cable, an optical fiber, or a digital subscriber line (DSL)) or wireless (for example, infrared, radio, and microwave) manner. The computer-readable storage medium is any usable medium accessible by a computer, or a data storage device, such as a server or a data center, integrating one or more usable media. The usable medium is a magnetic medium (such as a floppy disk, a hard disk, or a magnetic tape), an optical medium (such as a DVD), a semiconductor medium (such as a solid state disk (SSD)), or the like.

It should be understood that in various embodiments of the present disclosure, sequence numbers of the foregoing processes do not imply the order of execution. The order of performing the processes should be determined based on their functions and internal logic, and should not constitute any limitation to the implementation process of the embodiments of the present disclosure.

Those skilled in the art can clearly understand that for convenience and brevity of description, reference is made to corresponding processes in the foregoing method embodiments for specific working processes of the foregoing system, apparatus, and units. Details are not described herein again.

Described above are merely exemplary embodiments of the present disclosure and are not intended to limit the present disclosure. Any modifications, equivalent replacements, improvements, and the like, made within the principle of the present disclosure should fall within the protection scope of the present disclosure. Therefore, the protection scope of the present disclosure shall be subject to the protection scope of the claims.

What is claimed is:

1. A communication method, comprising:
performing distributed tone mapping on a first resource unit (RU).

2. The method according to claim 1, further comprising:
constructing a second RU by using tone indexes obtained by the distributed tone mapping.

3. The method according to claim 2, wherein performing the distributed tone mapping on the first RU comprises:
mapping first tone indexes of the first RU to second tone indexes in a first pattern;
mapping the second tone indexes to third tone indexes in a second pattern;
mapping the third tone indexes to fourth tone indexes in a third pattern; and
mapping the fourth tone indexes to fifth tone indexes in a fourth pattern.

4. The method according to claim 3, wherein the second pattern comprises a uniform mapping pattern.

5. The method according to claim 4, wherein the uniform mapping pattern comprises: performing mapping at intervals of tone indexes whose quantity is a mapping distance.

6. The method according to claim 5, wherein the mapping distance is related to a tone mapping bandwidth.

7. The method according to claim 6, wherein the mapping distance is determined based on a total quantity of tones within the tone mapping bandwidth that constitute the first RU and a size of the first RU.

8. The method according to claim 3, wherein the distributed tone mapping comprises one-shot distributed tone mapping.

9. The method according to claim 8, wherein the one-shot distributed tone mapping is configured to map a physical tone within a subchannel where a logical RU allocation mode is located to a logical tone within an OFDMA PPDU bandwidth.

10. The method according to claim 9, wherein first tone is the physical tone within the subchannel where the logical RU allocation mode is located, second tone is a first intermediate tone, third tone is a second intermediate tone, fourth tone is a physical tone obtained by the distributed tone mapping, and fifth tone is the logical tone within the OFDMA PPDU bandwidth.

11. The method according to claim 8, wherein the first RU comprises an RU 26.

12. The method according to claim 8, wherein the second RU comprises a logical RU, and constructing the second RU by using the tone indexes obtained by the distributed tone mapping comprises:
constructing a logical RU within a tone mapping bandwidth by using a physical tone index of the first RU and a logical tone index obtained by the distributed tone mapping, and determining at least one of a type, an index, a logical tone index, and a physical tone index of the logical RU within the tone mapping bandwidth.

13. The method according to claim 12, wherein the physical tone index of the logical RU is the first tone index used in the one-shot distributed tone mapping, and the logical tone index of the logical RU is the fifth tone index obtained by the one-shot distributed tone mapping.

14. The method according to claim 13, wherein a relationship between the type of the logical RU and the tone mapping bandwidth comprises at least one of:
the tone mapping bandwidth is 20 MHz, and the type of the logical RU comprises at least one of a 26-tone RU, a 52-tone RU, or a 106-tone RU;
the tone mapping bandwidth is 40 MHz, and the type of the logical RU comprises at least one of a 26-tone RU, a 52-tone RU, a 106-tone RU, or a 242-tone RU;
the tone mapping bandwidth is 80 MHz, and the type of the logical RU comprises at least one of a 26-tone RU, a 52-tone RU, a 106-tone RU, a 242-tone RU, or a 484-tone RU; or
the tone mapping bandwidth is 160 MHz, and the type of the logical RU comprises at least one of a 26-tone RU, a 52-tone RU, a 106-tone RU, a 242-tone RU, a 484-tone RU, a 996-tone RU, or a 2×996-tone RU.

15. The method according to claim 12, wherein the second RU comprises a logical multiple resource unit (MRU), and constructing the second RU by using the tone indexes obtained by the distributed tone mapping comprises:
constructing the logical MRU based on a logical RU in the one-shot distributed tone mapping or a logical RU in a two-shot distributed tone mapping.

16. The method according to claim 15, further comprising: allocating resource units in at least one of following patterns:
allocating at least one of the logical RU or the logical MRU in a logical RU allocation mode, wherein the logical MRU is constructed by using the logical RU in a manner of constructing a physical MRU; or
allocating the logical RU in a logical RU allocation mode, and allocating a physical RU and a physical MRU in a physical RU allocation mode.

17. The method according to claim 1, wherein the first RU comprises at least one of a physical RU or a physical MRU.

18. The method according to claim 1, further comprising:
performing channel estimation by using a four-fold extremely high throughput long training field (4×EHT LTF).

19. A communication device, comprising:
a processor; and
a memory storing one or more computer programs, which, when executed by the processor, cause the communication device to:
perform distributed tone mapping on a first resource unit (RU).

20. A chip, comprising:
a processor; and
a memory storing one or more computer programs, which, when executed by the processor, cause a device in which the chip is installed to:
perform distributed tone mapping on a first resource unit (RU).
